(19) United States
(12) Patent Application Publication
(10) Pub. No.: US 2026/0219368 A1
(43) Pub. Date: Jul. 30, 2026

(54) Rotating Lidar Systems and Methods

(71) Applicant: Innoviz Technologies Ltd., Rosh HaAyin (IL)

(72) Inventors: Nimrod Ari, Kochav Yair (IL); Nir Goren, Herut (IL); Yonatan Korner, Modi'in-Maccabim-Re'ut (IL)

(21) Appl. No.: 19/145,205

(22) PCT Filed: Nov. 16, 2023
(86) PCT No.: PCT/IB2023/000810

§ 371 Date: Jul. 2, 2025

Related U.S. Application Data
(60) Provisional application No. 63/478,168, filed on Jan. 2, 2023.
(60) Provisional application No. 63/478,194, filed on Jan. 3, 2023.
(60) Provisional application No. 63/478,193, filed on Jan. 3, 2023.
(60) Provisional application No. 63/594,034, filed on Oct. 30, 2023.

(51) Int. Cl. G01S 7/481; G01S 17/931

(52) U.S. Cl. CPC G01S 7/4817; G01S 7/4814; G01S 17/931

(57) ABSTRACT

Rotating LIDAR systems and methods are disclosed. In one implementation, a rotatable LIDAR system comprises a rotor having a central rotational axis and a plurality of optical component mounting locations about a peripheral region of the rotor, wherein components mounted at the plurality of optical component mounting locations are configured to rotate around the central rotational axis; a scanning light deflector mounted at one of the plurality of optical component mounting locations, the scanning light deflector being configured to vertically scan a field of view as the rotor rotates; a light detector mounted at one of the plurality of optical component mounting locations and configured to receive, while the rotor rotates, reflections of light from objects in the field of view; and a plurality of optical elements mounted at others of the plurality of optical component mounting locations, the scanning light deflector and the plurality of optical elements defining at least one optical pathway having at least one directional change between the scanning light deflector and the light detector.

### CROSS-REFERENCES TO RELATED APPLICATIONS

The present application claims priority to U.S. Provisional Application No. 63/478,168, filed on Jan. 2, 2023; U.S. Provisional Application No. 63/478,193, filed on Jan. 3, 2023; U.S. Provisional Application No. 63/478,194, filed on Jan. 3, 2023; and U.S. Provisional Application No. 63/594,034, filed on Oct. 30, 2023. All of the foregoing applications are incorporated herein by reference in their entirety.

### TECHNICAL FIELD

The present disclosure relates generally to technology for scanning a surrounding environment and, for example, to systems and methods that use LIDAR technology to detect objects in the surrounding environment.

### BACKGROUND

With the advent of driver assist systems and autonomous vehicles, automobiles need to be equipped with systems capable of reliably sensing and interpreting their surroundings, including identifying obstacles, hazards, objects, and other physical parameters that might impact navigation of the vehicle. To this end, a number of differing technologies have been suggested including radar, LIDAR, camera-based systems, operating alone or in a redundant manner.

One consideration with driver assistance systems and autonomous vehicles is an ability of the system to determine surroundings across different conditions. A light detection and ranging system (LIDAR a/k/a LADAR) is an example of technology that operates by illuminating objects with light and measuring the reflected pulses with a sensor. Based on measured times of flight at different spatial locations, in a field of view (FOV), such as FOV pixels, a point cloud of range data may be generated where each FOV pixel is associated with a particular range measurement value corresponding to a distance between the LIDAR system and objects or portions of objects in the LIDAR FOV. A laser is one example of a light source that can be used in a LIDAR system. An electro-optical system such as a LIDAR system may include a light deflector for projecting light emitted by a light source into the environment of the electro-optical system. The light deflector may be controlled to pivot around at least one axis for projecting the light into a desired location in the field of view of the electro-optical system.

Different design considerations may come into plan for a rotatable LIDAR system that is configured to rotate 360 degrees. These considerations may relate to certain components and how the components are configured relative to one another, the design of the mirror in the LIDAR system, the size and configuration of optical paths in the LIDAR system, the size of components and the size of the overall LIDAR system, and more. The systems and methods disclosed herein are directed towards addressing these considerations to achieve a rotatable LIDAR system that provides high standards of performance while having a sufficiently small form factor.

### SUMMARY

In an embodiment, a contactless rotating LIDAR communications system is disclosed. The LIDAR communications system may include a rotor and a motor configured to rotate the rotor. The LIDAR communications system may also include a light source mounted on the rotor and configured to output a light beam, and a movable light deflector mounted on the rotor in a path of the light beam. The light deflector may be configured to vertically scan a field of view with the light beam as the rotor rotates. The LIDAR communications system may further include a light detector mounted on the rotor and configured to receive, while the rotor rotates and the light deflector moves, reflections of light from the field of view. The LIDAR communications system may also include a first communications winding on the rotor, the first communications winding being configured to transmit, in a bandwidth of between 1 MHz and 2 GHz, signals associated with the received reflections. The LIDAR communications system may include a stator opposing the rotor and having a second communications winding thereon for receiving the transmitted signals from the first communications winding in the bandwidth of between 1 MHz and 2 GHz. The second communications winding may be spaced from the first communications winding by a gap of between 50 and 120 microns, and wherein the first communications winding and the second communications winding overlap each other on opposite sides of the gap.

In an embodiment, a contactless rotating LIDAR communications method is disclosed. The contactless rotating LIDAR communications method may include controlling a motor configured to rotate a rotor; outputting a light beam using a light source mounted on the rotor; vertically scanning a field of view with the light beam as the rotor rotates using a movable light deflector mounted on the rotor in a path of the light beam; receiving, while the rotor rotates and the light deflector moves, reflections of light from the field of view using a light detector mounted on the rotor; transmitting, in a bandwidth of between 1 MHz and 2 GHz, signals associated with the received reflections using a first communications winding on the rotor; and receiving the transmitted signals from the first communications winding in the bandwidth of between 1 MHz and 2 GHz using a second communications winding located in a stator opposing the rotor, wherein the second communications winding is spaced from the first communications winding by a gap of between 50 and 120 microns, and wherein the first communications winding and the second communications winding overlap each other on opposite sides of the gap.

In an embodiment, a contactless rotating LIDAR communications system is disclosed. The contactless rotating LIDAR communications system may include at least one processor configured to: control a motor configured to rotate a rotor; output a light beam using a light source mounted on the rotor; vertically scanning a field of view with the light beam as the rotor rotates using a movable light deflector mounted on the rotor in a path of the light beam; receive, while the rotor rotates and the light deflector moves, reflections of light from the field of view using a light detector mounted on the rotor; transmit, in a bandwidth of between 1 MHz and 2 GHz, signals associated with the received reflections using a first communications winding on the rotor; receive the transmitted signals from the first communications winding in the bandwidth of between 1 MHz and 2 GHz using a second communications winding located in a stator opposing the rotor; wherein the second communications winding is spaced from the first communications winding by a gap of between 50 and 120 microns, and wherein the first communications winding and the second communications winding overlap each other on opposite sides of the gap.

In an embodiment, a rotatable LIDAR system is disclosed. The rotatable LIDAR system may include a rotor having an axis of rotation; a motor configured to rotate the rotor about the axis of rotation; a light source mounted on the rotor and configured to emit a light beam towards a field of view; a movable light deflector mounted on the rotor and having a deflector longitudinal axis perpendicular to the axis of rotation of the rotor, the deflector longitudinal axis being slanted relative to a radial direction extending through a center of the movable light deflector, the movable light deflector being configured to direct the emitted light beam from the light source towards the field of view; and a light detector mounted on the rotor and configured to receive a reflected light beam reflected from an object in the field of view.

In an embodiment, a rotatable LIDAR system is disclosed. The system may include a rotor having a central rotational axis and a plurality of optical component mounting locations about a peripheral region of the rotor, wherein components mounted at the plurality of optical component mounting locations are configured to rotate around the central rotational axis; a scanning light deflector mounted at one of the plurality of optical component mounting locations, the scanning light deflector being configured to vertically scan a field of view as the rotor rotates; a light detector mounted at one of the plurality of optical component mounting locations and configured to receive, while the rotor rotates, reflections of light from objects in the field of view; and a plurality of optical elements mounted at others of the plurality of optical component mounting locations, the scanning light deflector and the plurality of optical elements defining at least one optical pathway having at least one directional change between the scanning light deflector and the light detector.

In an embodiment, a rotatable LIDAR system is disclosed. The system may include a rotatable rotor having optics thereon for supporting a reflection light path and a transmission light path, wherein the optics include: a light deflector; a scanning mirror; and a deflecting optical element, wherein the deflecting optical element includes: a first optical element portion having a first surface, a second surface, and a third surface angularly extending between the first surface and the second surface, wherein the first surface and the second surface are light transmissive, and wherein the third surface is light reflective; and a second optical element portion having a fourth surface, a fifth surface, and a sixth surface angularly extending between the fourth surface and the fifth surface, wherein the fourth surface and the fifth surface are light transmissive, and wherein the sixth surface is light reflective; wherein the first optical element portion and the second optical element portion are configured to cooperate such that: a first light beam travelling along the transmission light path passes through the fourth surface, becomes deflected by the sixth surface through the fifth surface and the second surface to the third surface, and becomes deflected by the third surface through the first surface, and a second light beam travelling along the reflection light path passes through the first surface and becomes deflected by the third surface through the second surface.

The foregoing general description and the following detailed description are exemplary and explanatory only and are not restrictive of the claims.

### BRIEF DESCRIPTION OF DRAWINGS

FIG. 1A is a diagram illustrating an exemplary LIDAR system, consistent with some embodiments of the present disclosure.

FIG. 1B is an image showing an exemplary output of single scanning cycle of a LIDAR system mounted on a vehicle, consistent with some embodiments of the present disclosure.

FIG. 1C is another image showing a representation of a point cloud model determined from output of a LIDAR system, consistent with some embodiments of the present disclosure embodiments.

FIG. 2A is a diagram illustrating different configurations of projecting units, consistent with some embodiments of the present disclosure.

FIGS. 2B, 2C, 2D, 2E, and 2F are diagrams illustrating an example of a monolithic laser array, consistent with some embodiments of the present disclosure.

FIG. 3A provides a diagrammatic illustration of a scanning unit configuration, consistent with some embodiments of the present disclosure.

FIGS. 3B and 3C are diagrams illustrating exemplary multibeam LIDAR systems consistent with some embodiments of the present disclosure.

FIGS. 4A, 4B, 4C, and 4D are diagrams illustrating different configurations of sensing units (or monolithic detectors), consistent with some embodiments of the present disclosure.

FIG. 5A includes four example diagrams illustrating emission patterns in a single frame-time for a single portion of the field of view, consistent with some embodiments of the present disclosure.

FIG. 5B includes three example diagrams illustrating emission scheme in a single frame-time for the whole field of view, consistent with some embodiments of the present disclosure.

FIG. 6 is a diagram illustrating the actual light emission projected towards and reflections received during a single frame-time for the whole field of view, consistent with some embodiments of the present disclosure.

FIG. 7 is a diagrammatic illustration of an exemplary conceptual rotatable LIDAR system, consistent with some embodiments of the present disclosure.

FIG. 8 is a diagrammatic illustration of an example implementation of a rotatable LIDAR system, consistent with some embodiments of the present disclosure.

FIG. 9 is a diagrammatic illustration of an exemplary optical path for the transmission of projected light in the rotatable LIDAR system of FIG. 8, consistent with some embodiments of the present disclosure.

FIG. 10 is a diagrammatic representation of an exemplary optical path for the receipt of reflected light in the rotatable LIDAR system of FIG. 8, consistent with some embodiments of the present disclosure.

FIG. 11 is diagrammatic representation of an exemplary conceptual contactless rotating LIDAR communications system, consistent with some embodiments of the present disclosure.

FIGS. 12A and 12B are diagrammatic top view illustrations of an exemplary communications ring with and without a communications winding, consistent with some embodiments of the present disclosure.

FIG. 13 is a diagrammatic illustration of an example implementation of a contactless rotating LIDAR communications system, consistent with some embodiments of the present disclosure.

FIG. 14 is a diagrammatic illustration of two exemplary communications windings included in the contactless rotating LIDAR communications system of FIG. 13, consistent with some embodiments of the present disclosure.

FIG. 15 is a diagrammatic illustration of an example flex PCB, consistent with some embodiments of the present disclosure.

FIG. 16 includes diagrammatic cross-sectional illustrations of an example flex PCB, consistent with some embodiments of the present disclosure.

FIG. 17 is a flowchart of an exemplary process for a contactless rotating LIDAR communications method, consistent with some embodiments of the present disclosure.

FIG. 18 illustrates a perspective view of an exemplary rotor, consistent with some embodiments of the present disclosure.

FIG. 19A illustrates a top plan view of an exemplary LIDAR system including an exemplary movable light deflector, consistent with some embodiments of the present disclosure.

FIG. 19B illustrates another top plan view of the exemplary LIDAR system of FIG. 19A, including an exemplary movable light deflector, consistent with some embodiments of the present disclosure.

FIG. 20 illustrates a perspective view of an exemplary movable light deflector, consistent with some embodiments of the present disclosure.

FIG. 21A illustrates another perspective view of the exemplary movable light deflector of FIG. 20, consistent with some embodiments of the present disclosure.

FIG. 21B illustrates another perspective view of the exemplary movable light deflector of FIG. 20, consistent with some embodiments of the present disclosure.

FIG. 22 is a diagrammatic illustration of an arrangement of mounting locations relative to a rotor, consistent with some embodiments of the present disclosure.

FIG. 23 is a diagrammatic illustration of an example implementation of a rotatable LIDAR system, consistent with some embodiments of the present disclosure.

FIG. 24 is a diagrammatic illustration of exemplary optical paths for light in the rotatable LIDAR system of FIG. 23, consistent with some embodiments of the present disclosure.

FIG. 25 is a diagrammatic illustration of an example implementation of a rotatable LIDAR system including a common deflecting element for inbound and outbound light consistent with some embodiments of the present disclosure.

FIG. 26A is a two-dimensional cross-sectional view of the common deflecting element consistent with some embodiments of the present disclosure.

FIG. 26B is another two-dimensional cross-sectional view of the common deflecting element, consistent with some embodiments of the present disclosure.

FIG. 26C is a two-dimensional cross-sectional view of an exemplary implementation of the common deflecting element consistent with some embodiments of the present disclosure.

FIG. 26D is a two-dimensional cross-sectional view of another exemplary implementation of the common deflecting element, consistent with some embodiments of the present disclosure.

FIG. 26E is a two-dimensional cross-sectional view of yet another exemplary implementation of the common deflecting element consistent with some embodiments of the present disclosure.

FIG. 26F is a two-dimensional cross-sectional view of yet another exemplary implementation of the common deflecting element consistent with some embodiments of the present disclosure.

FIG. 26G is a two-dimensional cross-sectional view of yet another exemplary implementation of the common deflecting element consistent with some embodiments of the present disclosure.

FIG. 26H is a perspective view of an exemplary implementation of the common deflecting element, consistent with some embodiments of the present disclosure.

FIG. 26I is another perspective view of the exemplary implementation of the common deflecting element illustrated in FIG. 26H, consistent with some embodiments of the present disclosure.

FIG. 27A is a diagrammatic illustration of an example implementation of a rotatable LIDAR system featuring a common deflecting element for inbound and outbound light and a curved window, consistent with some embodiments of the present disclosure.

FIG. 27B is a diagrammatic illustration of the rotatable LIDAR system illustrated in FIG. 27A, further illustrating two light rays travelling along a transmission light path and undergoing distortion due to the presence of the curved window, consistent with some embodiments of the present disclosure.

FIG. 27C is a simplified diagrammatic illustration of the rotatable LIDAR system illustrated in FIG. 27A, further illustrating two light rays travelling along a transmission light path and a common deflecting element including a curved surface to thereby cancel the distortion effect due to the presence of the curved window, consistent with some embodiments of the present disclosure.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

Moreover, various terms used in the specification and claims may be defined or summarized differently when discussed in connection with differing disclosed embodiments. It is to be understood that the definitions, summaries, and explanations of terminology in each instance apply to all instances, even when not repeated, unless the transitive definition, explanation or summary would result in inoperability of an embodiment.

Throughout, this disclosure mentions “disclosed embodiments,” which refer to examples of inventive ideas, concepts, and/or manifestations described herein. Many related and unrelated embodiments are described throughout this disclosure. The fact that some “disclosed embodiments” are described as exhibiting a feature or characteristic does not mean that other disclosed embodiments necessarily share that feature or characteristic.

This disclosure employs open-ended permissive language, indicating for example, that some embodiments “may” employ, involve, or include specific features. The use of the term “may” and other open-ended terminology is intended to indicate that although not every embodiment may employ the specific disclosed feature, at least one embodiment employs the specific disclosed feature.

Disclosed embodiments may involve an optical system. As used herein, the term “optical system” broadly includes any system that is used for the generation, detection and/or manipulation of light. By way of example only, an optical system may include one or more optical components for generating, detecting and/or manipulating light. For example, light sources, lenses, mirrors, prisms, beam splitters, collimators, polarizing optics, optical modulators, optical switches, optical amplifiers, optical detectors, optical sensors, fiber optics, semiconductor optic components, while each not necessarily required, may each be part of an optical system. In addition to the one or more optical components, an optical system may also include other non-optical components such as electrical components, mechanical components, chemical reaction components, and semiconductor components. The non-optical components may cooperate with optical components of the optical system. For example, the optical system may include at least one processor for analyzing detected light.

Consistent with the present disclosure, the optical system may be a LIDAR system. As used herein, the term “LIDAR system” broadly includes any system which can determine values of parameters indicative of a distance between a pair of tangible objects based on reflected light. In one embodiment, the LIDAR system may determine a distance between a pair of tangible objects based on reflections of light emitted by the LIDAR system. As used herein, the term “determine distances” broadly includes generating outputs which are indicative of distances between pairs of tangible objects. The determined distance may represent the physical dimension between a pair of tangible objects. By way of example only, the determined distance may include a line of flight distance between the LIDAR system and another tangible object in a field of view of the LIDAR system. In another embodiment, the LIDAR system may determine the relative velocity between a pair of tangible objects based on reflections of light emitted by the LIDAR system. Examples of outputs indicative of the distance between a pair of tangible objects include: a number of standard length units between the tangible objects (e.g., number of meters, number of inches, number of kilometers, number of millimeters), a number of arbitrary length units (e.g., number of LIDAR system lengths), a ratio between the distance to another length (e.g., a ratio to a length of an object detected in a field of view of the LIDAR system), an amount of time (e.g., given as standard unit, arbitrary units or ratio, for example, the time it takes light to travel between the tangible objects), one or more locations (e.g., specified using an agreed coordinate system, specified in relation to a known location), and more.

The LIDAR system may determine the distance between a pair of tangible objects (e.g., the LIDAR system and one or more objects in the LIDAR FOV) based on reflected light. In one embodiment, the LIDAR system may process detection results of a sensor which creates temporal information indicative of a period of time between the emission of a light signal and the time of its detection by the sensor. The period of time is occasionally referred to as “time of flight” of the light signal. In one example, the light signal may be a short pulse, whose rise and/or fall time may be detected in reception. Using known information about the speed of light in the relevant medium (usually air), the information regarding the time of flight of the light signal can be processed to provide the distance the light signal traveled between emission and detection. In another embodiment, the LIDAR system may determine the distance based on frequency phase-shift (or multiple frequency phase-shift). Specifically, the LIDAR system may process information indicative of one or more modulation phase shifts (e.g., by solving some simultaneous equations to give a final measure) of the light signal. For example, the emitted optical signal may be modulated with one or more constant frequencies. The at least one phase shift of the modulation between the emitted signal and the detected reflection may be indicative of the distance the light traveled between emission and detection. The modulation may be applied to a continuous wave light signal, to a quasi-continuous wave light signal, or to another type of emitted light signal. It is noted that additional information may be used by the LIDAR system for determining the distance, e.g., location information (e.g., relative positions) between the projection location, the detection location of the signal (especially if distanced from one another), and more.

In some embodiments, the LIDAR system may be used for detecting a plurality of objects in an environment of the LIDAR system. The term “detecting an object in an environment of the LIDAR system” broadly includes generating information which is indicative of an object that reflected light toward a detector associated with the LIDAR system. If more than one object is detected by the LIDAR system, the generated information pertaining to different objects may be interconnected, for example a car is driving on a road, a bird is sitting on the tree, a man touches a bicycle, a van moves towards a building. The dimensions of the environment in which the LIDAR system detects objects may vary with respect to implementation. For example, the LIDAR system may be used for detecting a plurality of objects in an environment of a vehicle on which the LIDAR system is installed, up to a horizontal distance of 100 m (or 200 m, 300 m, etc.), and up to a vertical distance of 10 m (or 25 m, 50 m, etc.). In another example, the LIDAR system may be used for detecting a plurality of objects in an environment of a vehicle or within a predefined horizontal range (e.g., 25°, 50°, 100°, 180°, etc.), and up to a predefined vertical elevation (e.g., ±10°, ±20°, +40°-20°, ±90° or 0°-90°).

As used herein, the term “detecting an object” may broadly refer to determining an existence of the object (e.g., an object may exist in a certain direction with respect to the LIDAR system and/or to another reference location, or an object may exist in a certain spatial volume). Additionally or alternatively, the term “detecting an object” may refer to determining a distance between the object and another location (e.g., a location of the LIDAR system, a location on earth, or a location of another object). Additionally or alternatively, the term “detecting an object” may refer to identifying the object (e.g., classifying a type of object such as car, plant, tree, road; recognizing a specific object (e.g., the Washington Monument); determining a license plate number; determining a composition of an object (e.g., solid, liquid, transparent, semitransparent); determining a kinematic parameter of an object (e.g., whether it is moving, its velocity, its movement direction, expansion of the object). Additionally or alternatively, the term “detecting an object” may refer to generating a point cloud map in which every point of one or more points of the point cloud map correspond to a location in the object or a location on a face thereof. In one embodiment, the data resolution associated with the point cloud map representation of the field of view may be associated with 0.1°×0.1° or 0.3°×0.3° of the field of view.

Consistent with the present disclosure, the term “object” broadly includes a finite composition of matter that may reflect light from at least a portion thereof. For example, an object may be at least partially solid (e.g., cars, trees); at least partially liquid (e.g., puddles on the road, rain); at least partly gaseous (e.g., fumes, clouds); made from a multitude of distinct particles (e.g., sand storm, fog, spray); and may be of one or more scales of magnitude, such as ~1 millimeter (mm), ~5 mm, ~10 mm, ~50 mm, ~100 mm, ~500 mm, ~1 meter (m), ~5 m, ~10 m, ~50 m, ~100 m, and so on. Smaller or larger objects, as well as any size in between those examples, may also be detected. It is noted that for various reasons, the LIDAR system may detect only part of the object. For example, in some cases, light may be reflected from only some sides of the object (e.g., only the side opposing the LIDAR system will be detected); in other cases, light may be projected on only part of the object (e.g., laser beam projected onto a road or a building); in other cases, the object may be partly blocked by another object between the LIDAR system and the detected object; in other cases, the LIDAR's sensor may only detects light reflected from a portion of the object, e.g., because ambient light or other interferences interfere with detection of some portions of the object.

Consistent with the present disclosure, a LIDAR system may be configured to detect objects by scanning the environment of LIDAR system. The term “scanning the environment of LIDAR system” broadly includes illuminating the field of view or a portion of the field of view of the LIDAR system. In one example, scanning the environment of LIDAR system may be achieved by moving or pivoting a light deflector to deflect light in differing directions toward different parts of the field of view. In another example, scanning the environment of LIDAR system may be achieved by changing a positioning (i.e., location and/or orientation) of a sensor with respect to the field of view. In another example, scanning the environment of LIDAR system may be achieved by changing a positioning (i.e., location and/or orientation) of a light source with respect to the field of view. In yet another example, scanning the environment of LIDAR system may be achieved by changing the positions of at least one light source and of at least one sensor to move rigidly with respect to the field of view (i.e., the relative distance and orientation of the at least one sensor and of the at least one light source remains).

As used herein the term “field of view of the LIDAR system” may broadly include an extent of the observable environment of LIDAR system in which objects may be detected. It is noted that the field of view (FOV) of the LIDAR system may be affected by various conditions such as but not limited to: an orientation of the LIDAR system (e.g., is the direction of an optical axis of the LIDAR system); a position of the LIDAR system with respect to the environment (e.g., distance above ground and adjacent topography and obstacles); operational parameters of the LIDAR system (e.g., emission power, computational settings, defined angles of operation), etc. The field of view of LIDAR system may be defined, for example, by a solid angle (e.g., defined using φ, θ angles, in which φ and θ are angles defined in perpendicular planes, e.g., with respect to symmetry axes of the LIDAR system and/or its FOV). In one example, the field of view may also be defined within a certain range (e.g., up to 200 m).

Similarly, the term “instantaneous field of view” may broadly include an extent of the observable environment in which objects may be detected by the LIDAR system at any given moment. For example, for a scanning LIDAR system, the instantaneous field of view is narrower than the entire FOV of the LIDAR system, and it can be moved within the FOV of the LIDAR system in order to enable detection in other parts of the FOV of the LIDAR system. The movement of the instantaneous field of view within the FOV of the LIDAR system may be achieved by moving a light deflector of the LIDAR system (or external to the LIDAR system), so as to deflect beams of light to and/or from the LIDAR system in differing directions. In one embodiment, LIDAR system may be configured to scan a scene in the environment in which the LIDAR system is operating. As used herein the term “scene” may broadly include some or all of the objects within the field of view of the LIDAR system, in their relative positions and in their current states, within an operational duration of the LIDAR system. For example, the scene may include ground elements (e.g., earth, roads, grass, sidewalks, road surface marking), sky, manufactured objects (e.g., vehicles, buildings, signs), vegetation, people, animals, light projecting elements (e.g., flashlights, sun, other LIDAR systems), and so on.

Disclosed embodiments may involve obtaining information for use in generating reconstructed three-dimensional models. Examples of types of reconstructed three-dimensional models which may be used include point cloud models, and Polygon Mesh (e.g., a triangle mesh). The terms “point cloud” and “point cloud model” are widely known in the art, and should be construed to include a set of data points located spatially in some coordinate system (i.e., having an identifiable location in a space described by a respective coordinate system). The term “point cloud point” refer to a point in space (which may be dimensionless, or a miniature cellular space, e.g., 1 cm3), and whose location may be described by the point cloud model using a set of coordinates (e.g., (X, Y, Z), (r, φ, θ)). By way of example only, the point cloud model may store additional information for some or all of its points (e.g., color information for points generated from camera images). Likewise, any other type of reconstructed three-dimensional model may store additional information for some or all of its objects. Similarly, the terms “polygon mesh” and “triangle mesh” are widely known in the art, and are to be construed to include, among other things, a set of vertices, edges and faces that define the shape of one or more 3D objects (such as a polyhedral object). The faces may include one or more of the following: triangles (triangle mesh), quadrilaterals, or other simple convex polygons, since this may simplify rendering. The faces may also include more general concave polygons, or polygons with holes. Polygon meshes may be represented using differing techniques, such as: Vertex-vertex meshes, Face-vertex meshes, Winged-edge meshes and Render dynamic meshes. Different portions of the polygon mesh (e.g., vertex, face, edge) are located spatially in some coordinate system (i.e., having an identifiable location in a space described by the respective coordinate system), either directly and/or relative to one another. The generation of the reconstructed three-dimensional model may be implemented using any standard, dedicated and/or novel photogrammetry technique, many of which are known in the art. It is noted that other types of models of the environment may be generated by the LIDAR system.

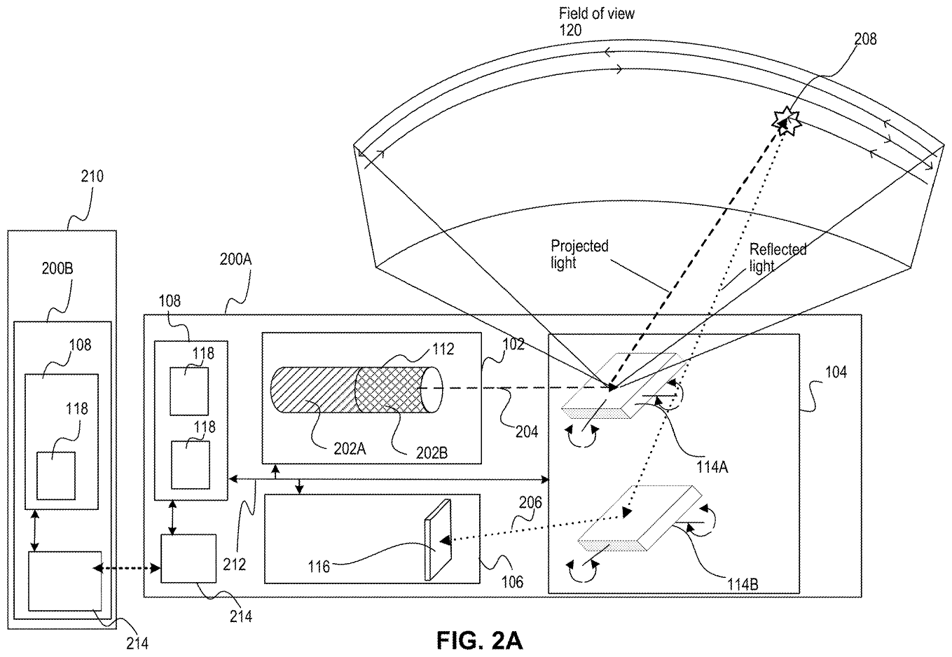

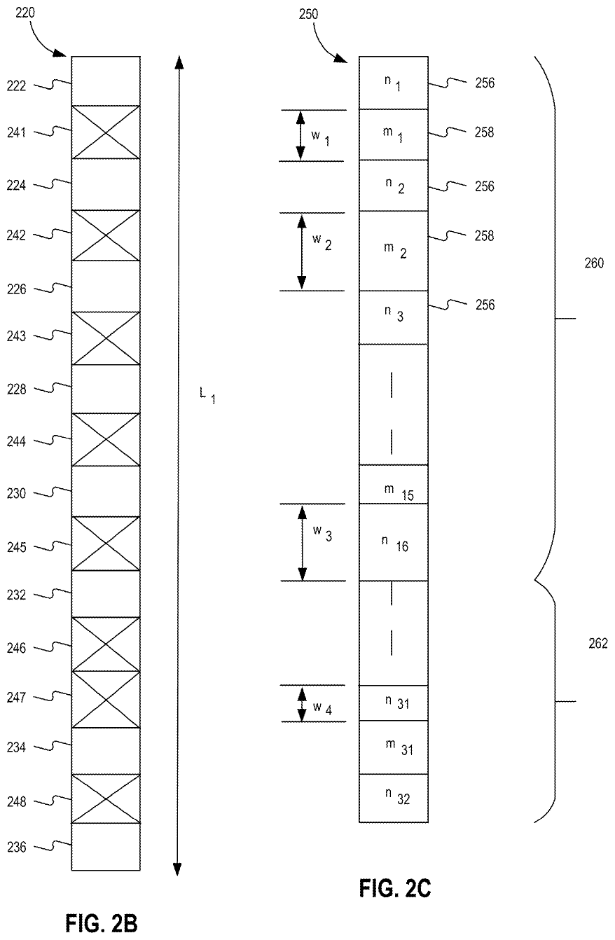

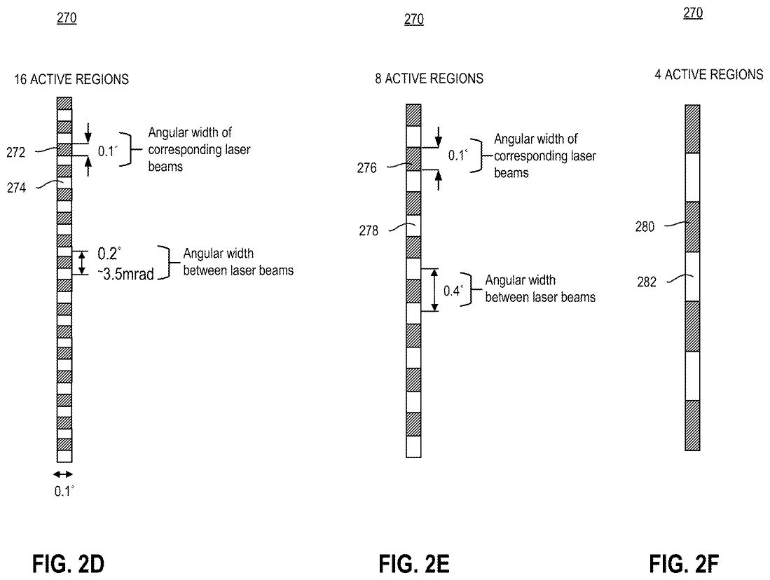

Consistent with disclosed embodiments, the LIDAR system may include at least one projecting unit with a light source configured to project light. As used herein the term “light source” broadly refers to any device configured to emit light. In one embodiment, the light source may be a laser such as a solid-state laser, laser diode, a high-power laser, or an alternative light source such as, a light emitting diode (LED)-based light source. In addition, light source 112 as illustrated throughout the figures, may emit light in differing formats, such as light pulses, continuous wave (CW), quasi-CW, and so on. For example, one type of light source that may be used is a vertical-cavity surface-emitting laser (VCSEL). Another type of light source that may be used is an external cavity diode laser (ECDL) or an edge-emitting laser. In some examples, the light source may include an array of lasers. In another example, the light source may include a single, monolithic laser array including a plurality of laser emitters. In some examples, the light source may include a laser diode configured to emit light at a wavelength between about 650 nm and 1150 nm. Alternatively, the light source may include a laser diode configured to emit light at a wavelength between about 800 nm and about 1000 nm, between about 850 nm and about 950 nm, or between about 1300 nm and about 1600 nm. Unless indicated otherwise, the term “about” with regards to a numeric value is defined as a variance of up to 5% with respect to the stated value. Additional details on the projecting unit and the at least one light source are described below with reference to FIG. 2A.

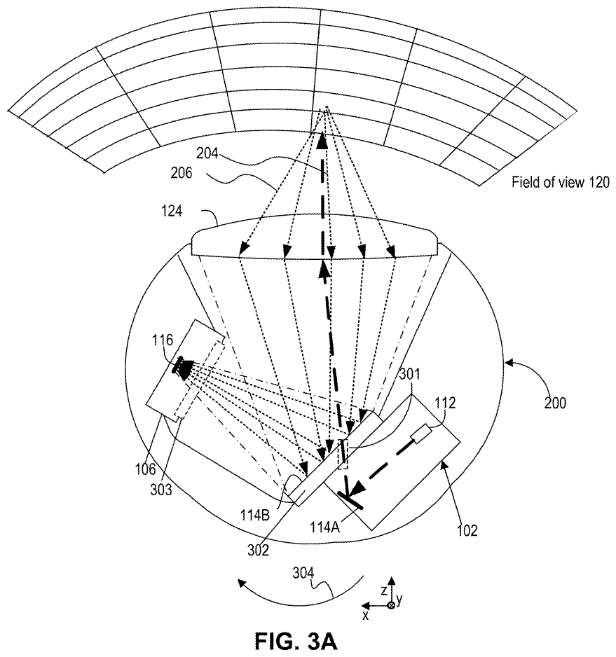

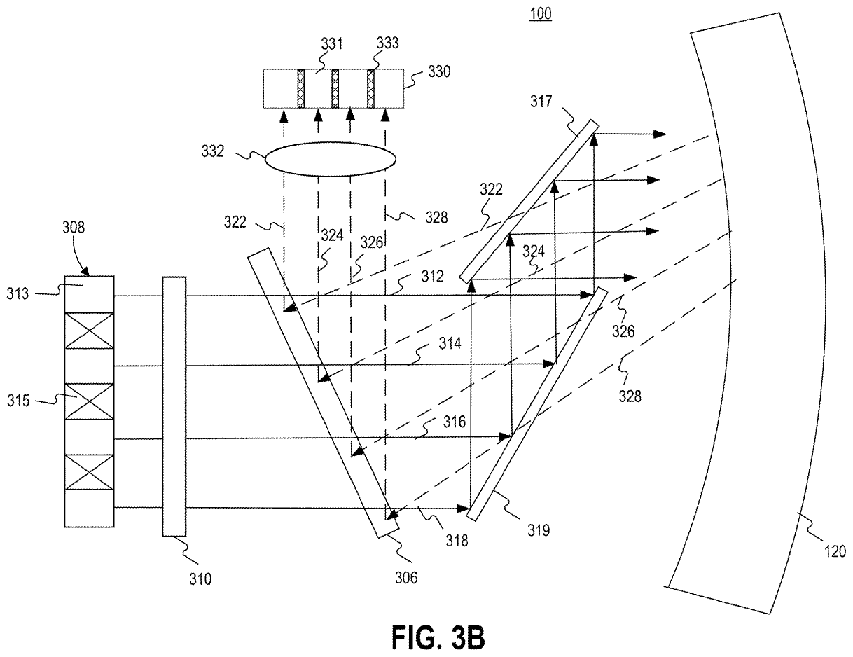

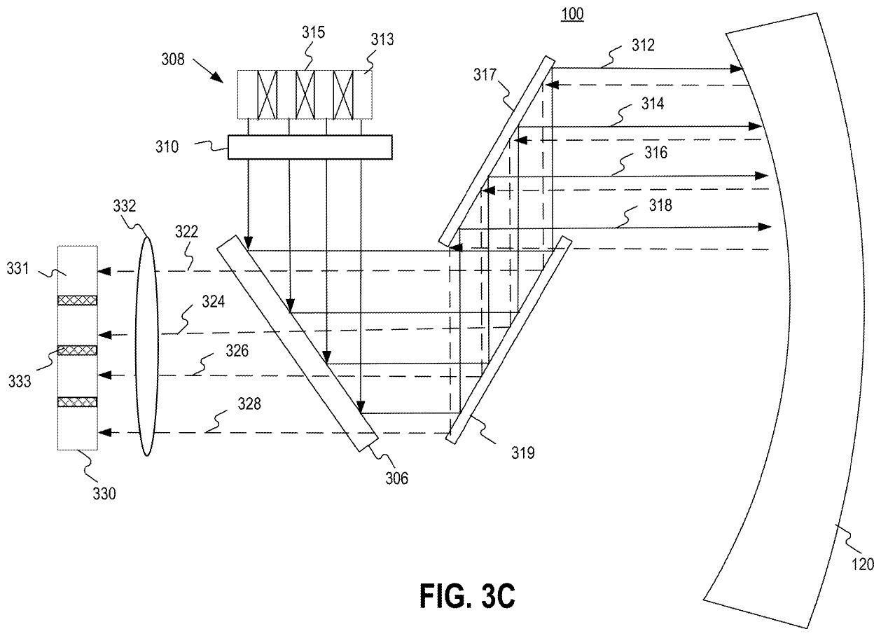

Consistent with disclosed embodiments, the LIDAR system may include at least one scanning unit with at least one light deflector configured to deflect light from the light source in order to scan the field of view. The term “light deflector” broadly includes any mechanism or module which is configured to make light deviate from its original path; for example, a mirror, a prism, controllable lens, a mechanical mirror, mechanical scanning polygons, active diffraction (e.g., controllable LCD), Risley prisms, non-mechanical-electro-optical beam steering (such as made by Vscent), polarization grating (such as offered by Boulder Non-Linear Systems), optical phased array (OPA), and more. In one embodiment, a light deflector may include a plurality of optical components, such as at least one reflecting element (e.g., a mirror), at least one refracting element (e.g., a prism, a lens), and so on. In one example, the light deflector may be movable, to cause light deviate to differing degrees (e.g., discrete degrees, or over a continuous span of degrees). The light deflector may optionally be controllable in different ways (e.g., deflect to a degree a, change deflection angle by Δα, move a component of the light deflector by M millimeters, change speed in which the deflection angle changes). In addition, the light deflector may optionally be operable to change an angle of deflection within a single plane (e.g., θ coordinate). The light deflector may optionally be operable to change an angle of deflection within two non-parallel planes (e.g., θ and φ coordinates). Alternatively or additionally, the light deflector may optionally be operable to change an angle of deflection between predetermined settings (e.g., along a predefined scanning route) or otherwise. With respect the use of light deflectors in LIDAR systems, it is noted that a light deflector may be used in the outbound direction (also referred to as transmission direction, or TX) to deflect light from the light source to at least a part of the field of view. However, a light deflector may also be used in the inbound direction (also referred to as reception direction, or RX) to deflect light from at least a part of the field of view to one or more light sensors. Additional details on the scanning unit and the at least one light deflector are described below with reference to FIGS. 3A-3C.

Disclosed embodiments may involve pivoting the light deflector in order to scan the field of view. As used herein the term “pivoting” broadly includes rotating of an object (especially a solid object) about one or more axis of rotation, while substantially maintaining a center of rotation fixed. In one embodiment, the pivoting of the light deflector may include rotation of the light deflector about a fixed axis (e.g., a shaft), but this is not necessarily so. In some cases, the fixed axis may be a substantially vertically oriented scanning axis, and pivoting of the deflector includes rotation of the deflector about the vertical scanning axis to project laser light to the LIDAR FOV, e.g., along one or more horizontally oriented scan lines. In some cases, the light deflector may be spun or rotated a full 360 degrees such that the horizontal scan lines extend over and establish a full 360-degree LIDAR FOV.

Disclosed embodiments may involve receiving reflections associated with a portion of the field of view corresponding to a single instantaneous position of the light deflector. As used herein, the term “instantaneous position of the light deflector” (also referred to as “state of the light deflector”) broadly refers to the location or position in space where at least one controlled component of the light deflector is situated at an instantaneous point in time, or over a short span of time. In one embodiment, the instantaneous position of light deflector may be gauged with respect to a frame of reference. The frame of reference may pertain to at least one fixed point in the LIDAR system. Or, for example, the frame of reference may pertain to at least one fixed point in the scene. In some embodiments, the instantaneous position of the light deflector may include some movement of one or more components of the light deflector (e.g., mirror, prism), usually to a limited degree with respect to the maximal degree of change during a scanning of the field of view. For example, a scanning of the entire the field of view of the LIDAR system may include changing deflection of light over a span of 30°, and the instantaneous position of the at least one light deflector may include angular shifts of the light deflector within 0.05°. In other embodiments, the term “instantaneous position of the light deflector” may refer to the positions of the light deflector during acquisition of light which is processed to provide data for a single point of a point cloud (or another type of 3D model) generated by the LIDAR system. In some embodiments, an instantaneous position of the light deflector may correspond with a fixed position or orientation in which the deflector pauses for a short time during illumination of a particular sub-region of the LIDAR field of view. In other cases, an instantaneous position of the light deflector may correspond with a certain position/orientation along a scanned range of positions/orientations of the light deflector that the light deflector passes through as part of a continuous or semi-continuous scan of the LIDAR field of view. In some embodiments, the light deflector may be moved such that during a scanning cycle of the LIDAR FOV the light deflector is located at a plurality of different instantaneous positions. In other words, during the period of time in which a scanning cycle occurs, the deflector may be moved through a series of different instantaneous positions/orientations, and the deflector may reach each different instantaneous position/orientation at a different time during the scanning cycle.

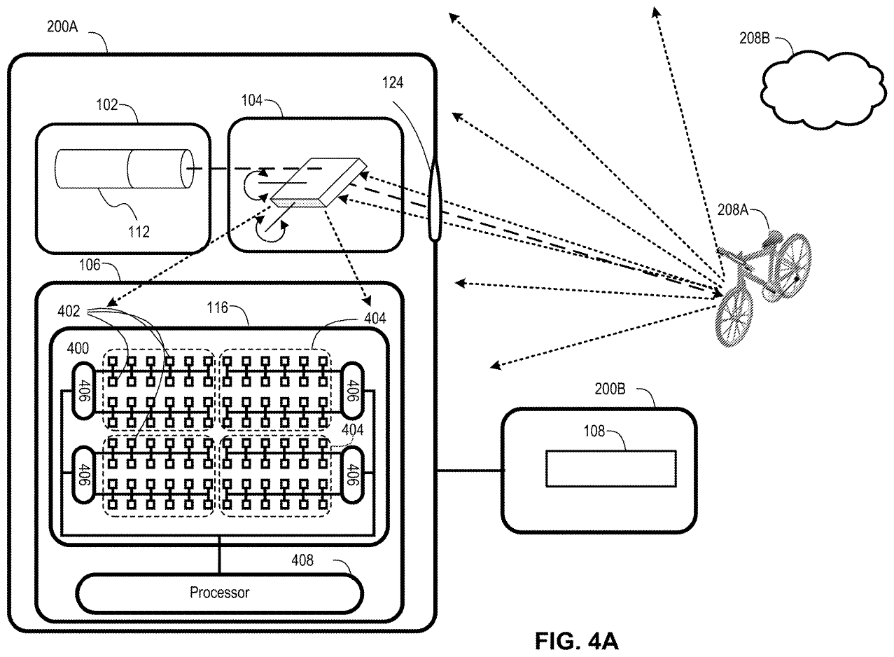

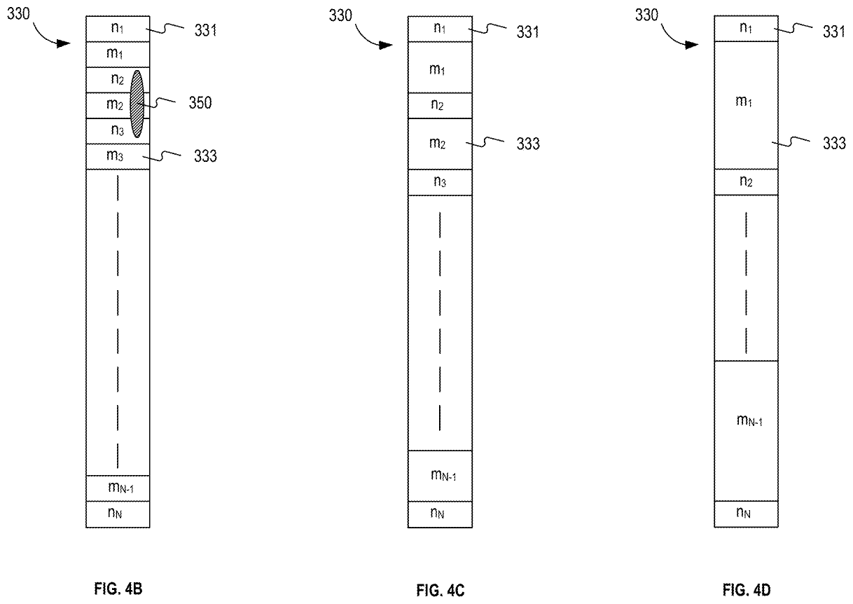

Consistent with disclosed embodiments, the LIDAR system may include at least one sensing unit with at least one sensor configured to detect reflections from objects in the field of view. The term “sensor” broadly includes any device, element, or system capable of measuring properties (e.g., power, frequency, phase, pulse timing, pulse duration) of electromagnetic waves and to generate an output relating to the measured properties. In some embodiments, the at least one sensor may include a plurality of detectors constructed from a plurality of detecting elements. The at least one sensor may include light sensors of one or more types. It is noted that the at least one sensor may include multiple sensors of the same type which may differ in other characteristics (e.g., sensitivity, size). Other types of sensors may also be used. Combinations of several types of sensors can be used for different reasons, such as improving detection over a span of ranges (especially in close range); improving the dynamic range of the sensor; improving the temporal response of the sensor; and improving detection in varying environmental conditions (e.g., atmospheric temperature, rain, etc.). In one embodiment, the at least one sensor includes a SiPM (Silicon photomultipliers) which is a solid-state single-photon-sensitive device built from an array of avalanche photodiode (APD), single photon avalanche diode (SPAD), serving as detection elements on a common silicon substrate. In one example, a typical distance between SPADs may be between about 10 μm and about 50 μm, wherein each SPAD may have a recovery time of between about 20 ns and about 100 ns. Similar photomultipliers from other, non-silicon materials may also be used. Although a SiPM device works in digital/switching mode, the SiPM is an analog device because all the microcells may be read in parallel, making it possible to generate signals within a dynamic range from a single photon to hundreds and thousands of photons detected by the different SPADs. It is noted that outputs from different types of sensors (e.g., SPAD, APD, SiPM, PIN diode, Photodetector) may be combined together to a single output which may be processed by a processor of the LIDAR system. Additional details on the sensing unit and the at least one sensor are described below with reference to FIGS. 4A-4D.

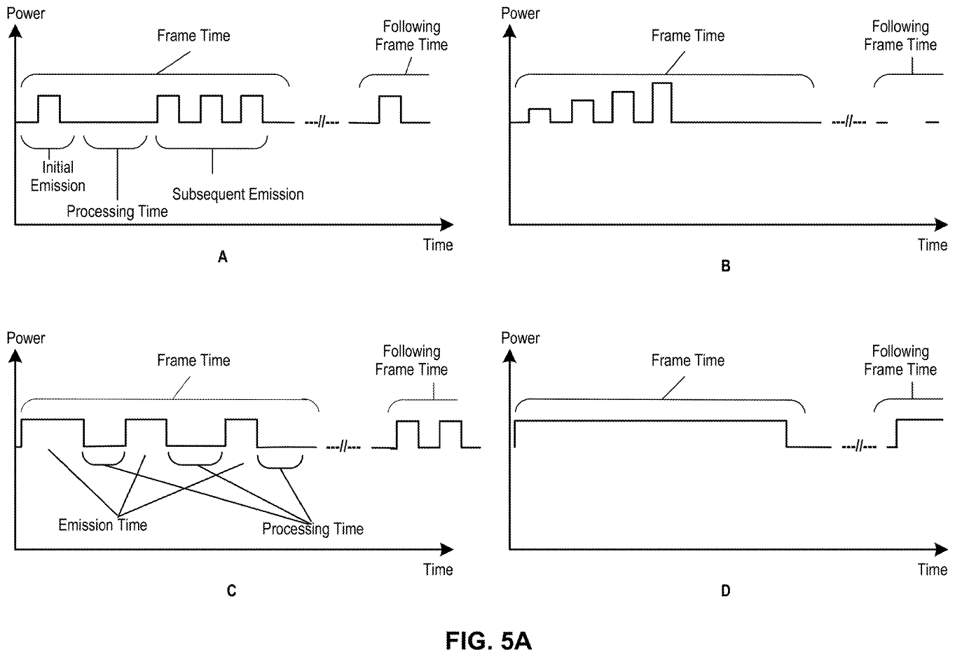

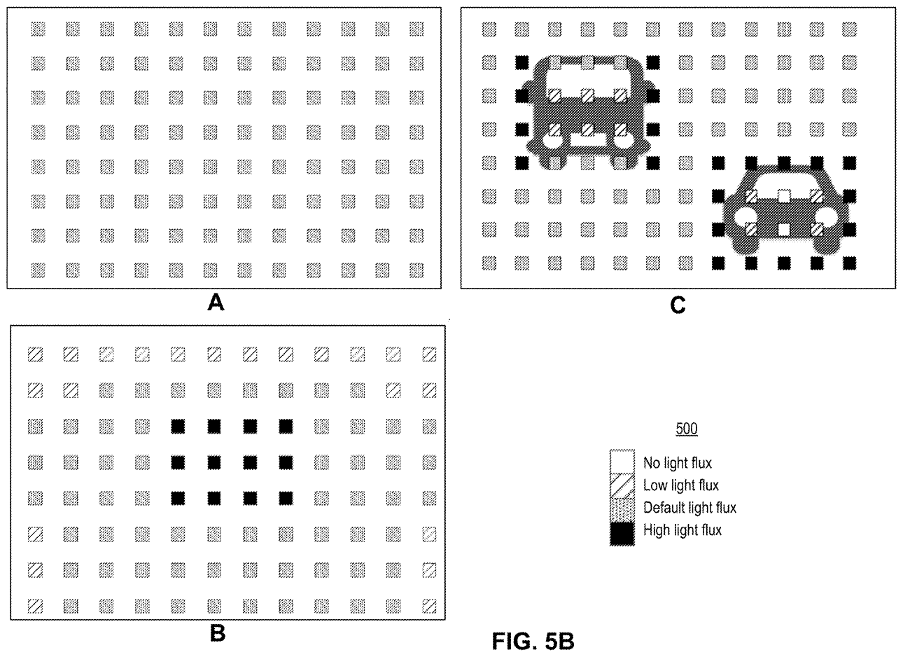

Consistent with disclosed embodiments, the LIDAR system may include or communicate with at least one processor configured to execute differing functions. The at least one processor may constitute any physical device or group of devices having electric circuitry that performs a logic operation on an input or inputs. For example, the at least one processor may include one or more integrated circuits (IC), including application-specific integrated circuit (ASIC), microchips, microcontrollers, microprocessors, all or part of a central processing unit (CPU), graphics processing unit (GPU), digital signal processor (DSP), field-programmable gate array (FPGA), server, virtual server, or other circuits suitable for executing instructions or performing logic operations. The instructions executed by at least one processor may, for example, be pre-loaded into a memory integrated with or embedded into the controller or may be stored in a separate memory. The memory may include a Random Access Memory (RAM), a Read-Only Memory (ROM), a hard disk, an optical disk, a magnetic medium, a flash memory, other permanent, fixed, or volatile memory, or any other mechanism capable of storing instructions. In some embodiments, the memory is configured to store information representative data about objects in the environment of the LIDAR system. In some embodiments, the at least one processor may include more than one processor. Each processor may have a similar construction or the processors may be of differing constructions that are electrically connected or disconnected from each other. For example, the processors may be separate circuits or integrated in a single circuit. When more than one processor is used, the processors may be configured to operate independently or collaboratively, and may be co-located or located remotely from each other. The processors may be coupled electrically, magnetically, optically, acoustically, mechanically or by other means that permit them to interact. Additional details on the processing unit and the at least one processor are described below with reference to FIGS. 5A-5C.

### System Overview

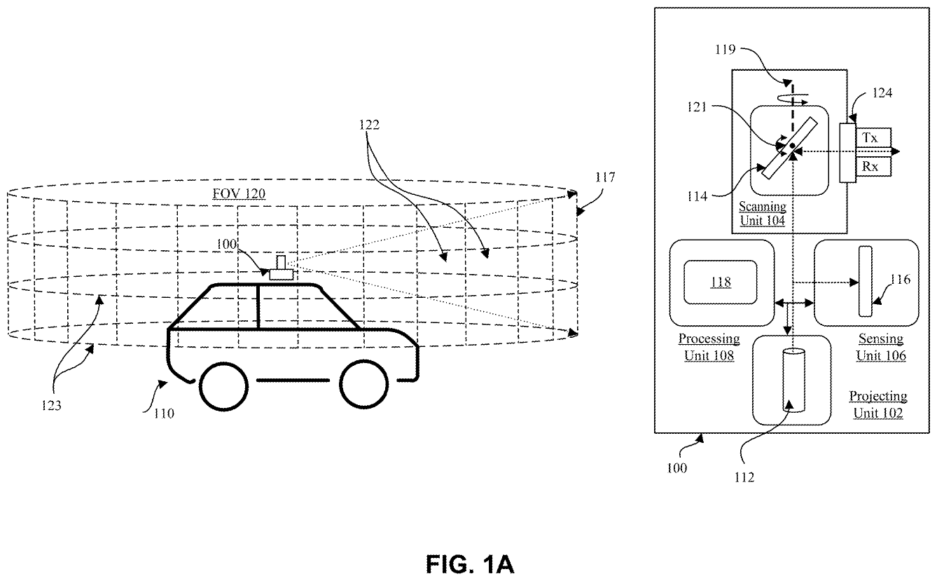

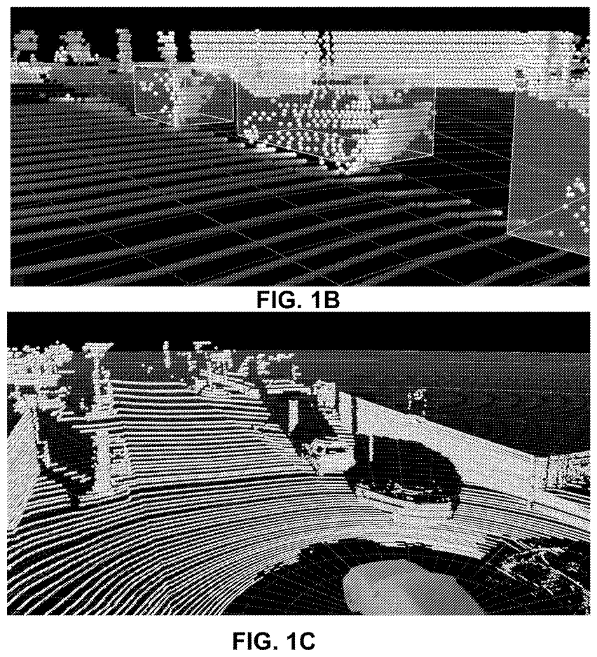

FIG. 1A illustrates a LIDAR system 100 including a projecting unit 102, a scanning unit 104, a sensing unit 106, and a processing unit 108. LIDAR system 100 may be mountable on a vehicle 110. Consistent with embodiments of the present disclosure, projecting unit 102 may include at least one light source 112, scanning unit 104 may include at least one light deflector 114, sensing unit 106 may include at least one sensor 116, and processing unit 108 may include at least one processor 118. In one embodiment, processor 118 may be configured (programmed) to coordinate operation of light source 112 with the movement of deflector 114 in order to scan a field of view 120. During a scanning cycle, each instantaneous position of at least one light deflector 114 may be associated with a particular portion 122 of field of view (FOV) 120. In addition, LIDAR system 100 may include at least one optional optical window 124 for directing light projected towards field of view 120 and/or receiving light reflected from objects in field of view 120. Optional optical window 124 may serve different purposes, such as collimation of the projected light and focusing of the reflected light. In one embodiment, optional optical window 124 may be an opening, a flat window, a lens, or any other type of optical window.

In the example LIDAR system represented by FIG. 1A, deflector 114 is configured to rotate about a scanning axis 119, which may be oriented generally in a vertical direction relative to vehicle 110. In some cases, deflector 114 can rotate or spin about axis 119 such that FOV 120 extends over a full 360 degrees relative to vehicle 110. In some examples, FOV 120 may extend less than 360 degrees relative to vehicle 110.

In some cases, deflector 114 may also be configured to rotate about a tilt axis 121. Rotation about tilt axis 121 may cause a light beam from light source 112 to be projected toward FOV 120 at different tilt angles. As a result, FOV 120 may extend over a predetermined vertical scan range related to the tilt angle range offered by deflector 114. In some cases, a vertical scan range 117 of LIDAR system 100 may be +/−5 degrees, +/−10 degrees, +/−20 degrees relative to the LIDAR system. Other scan ranges are also possible based on the configuration of the deflector 114. In some cases, after each rotation of the deflector about scan axis 119, deflector 114 may be tilted about tilt axis 121 by a predetermined incremental amount, such that each rotation of the deflector 114 may be associated with a different horizontally oriented scan line (e.g., scan lines 123) relative to FOV 120.

Consistent with the present disclosure, LIDAR system 100 may be used in autonomous or semi-autonomous road-vehicles (for example, cars, buses, vans, trucks, and any other terrestrial vehicle). Autonomous road-vehicles with LIDAR system 100 may scan their environment and drive to a destination vehicle without human input. Similarly, LIDAR system 100 may also be used in autonomous/semi-autonomous aerial-vehicles (for example, UAV, drones, quadcopters, and any other airborne vehicle or device); or in an autonomous or semi-autonomous water vessel (e.g., boat, ship, submarine, or any other watercraft). Autonomous aerial-vehicles and watercraft with LIDAR system 100 may scan their environment and navigate to a destination autonomously or using a remote human operator. According to one embodiment, vehicle 110 (either a road-vehicle, aerial-vehicle, or watercraft) may use LIDAR system 100 to aid in detecting and scanning the environment in which vehicle 110 is operating.

It should be noted that LIDAR system 100 or any of its components may be used together with any of the example embodiments and methods disclosed herein. Further, while some aspects of LIDAR system 100 are described relative to an exemplary vehicle-based LIDAR platform, LIDAR system 100, any of its components, or any of the processes described herein may be applicable to LIDAR systems of other platform types.

In some embodiments, LIDAR system 100 may include one or more scanning units 104 to scan the environment around vehicle 110. LIDAR system 100 may be attached or mounted to any part of vehicle 110. Sensing unit 106 may receive reflections from the surroundings of vehicle 110, and transfer reflections signals indicative of light reflected from objects in field of view 120 to processing unit 108. Consistent with the present disclosure, scanning units 104 may be mounted to or incorporated into any suitable location or position relative to vehicle 110 (e.g., on a roof, undercarriage, side panels, hood, trunk, etc.). In some cases, LIDAR system 100 may capture a complete surround view of the environment of vehicle 110. Thus, LIDAR system 100 may have a 360-degree horizontal field of view 120. In one example, as shown in FIG. 1A, LIDAR system 100 may include a single scanning unit 104 mounted on a roof vehicle 110. Alternatively, LIDAR system 100 may include multiple scanning units (e.g., two, three, four, or more scanning units 104) each with a field of few such that in the aggregate the horizontal field of view is covered by a 360-degree scan around vehicle 110. One skilled in the art will appreciate that LIDAR system 100 may include any number of scanning units 104 arranged in any manner, each with up to a 360-degree field of view, depending on the number of units employed. Moreover, a 360-degree horizontal field of view may be also obtained by mounting multiple LIDAR systems 100 on vehicle 110, each with a single scanning unit 104. It is nevertheless noted that the one or more LIDAR systems 100 do not have to provide a complete 360° field of view, and that narrower fields of view may be useful in some situations.

FIG. 1B is an image showing an exemplary point cloud output from a portion of a single scanning cycle of LIDAR system 100 mounted on vehicle 110 consistent with disclosed embodiments. Every gray dot in the image corresponds a certain spatial location in the environment around vehicle 110 from which a reflection of light generated by light source 112 was detected by sensing unit 106. In addition to location, each gray dot may also be associated with different types of information, for example, range (based on time-of-flight calculations), intensity (e.g., how much light returns back from that location), reflectivity, proximity to other dots, etc. In one embodiment, LIDAR system 100 may generate a plurality of point-cloud data entries from detected reflections of multiple scanning cycles of the field of view to enable, for example, determining a point cloud model of the environment around vehicle 110.

FIG. 1C is an image showing a representation of another portion of a point cloud model determined from the output of LIDAR system 100. Consistent with disclosed embodiments, by processing the generated point-cloud data entries of the environment around vehicle 110, a surround-view image may be produced from the point cloud model. In one embodiment, the point cloud model may be provided to a feature extraction module, which processes the point cloud information to identify a plurality of features. Each feature may include data about different aspects of the point cloud and/or of objects in the environment around vehicle 110 (e.g., cars, trees, people, and roads). Features may have the same resolution of the point cloud model (i.e. having the same number of data points, optionally arranged into similar sized 2D arrays), or may have different resolutions. The features may be stored in any kind of data structure (e.g., raster, vector, 2D array, 1D array). In addition, virtual features, such as a representation of vehicle 110, border lines, or bounding boxes separating regions or objects in the image (e.g., as depicted in FIG. 1B), and icons representing one or more identified objects, may be overlaid on the representation of the point cloud model to form the final surround-view image. For example, a symbol of vehicle 110 may be overlaid at a center of the surround-view image.

### The Projecting Unit

FIG. 2A illustrates an example of a bi-static configuration of LIDAR system 100 in which projecting unit 102 includes a single light source 112. The term “bi-static configuration” broadly refers to LIDAR systems configurations in which the projected light exiting the LIDAR system and the reflected light entering the LIDAR system pass through substantially different optical paths. In some embodiments, a bi-static configuration of LIDAR system 100 may include a separation of the optical paths by using completely different optical components, by using parallel but not fully separated optical components, or by using the same optical components for only part of the of the optical paths (optical components may include, for example, windows, lenses, mirrors, beam splitters, etc.). In the example depicted in FIG. 2A, the bi-static configuration includes a configuration where the outbound light and the inbound light pass through a single optical window 124 but scanning unit 104 includes two light deflectors, a first light deflector 114A for outbound light and a second light deflector 114B for inbound light (the inbound light in LIDAR system includes emitted light reflected from objects in the scene, and may also include ambient light arriving from other sources).

In this embodiment, the components of LIDAR system 100 may be contained within a single housing, or may be divided among a plurality of housings (e.g., 200A and 200B). As shown, projecting unit 102 may include a single light source 112 that includes a laser diode 202A (or one or more laser diodes coupled together) configured to emit light (projected light 204). In one non-limiting example, the light projected by light source 112 may be at a wavelength between about 800 nm and 950 nm, have an average power between about 50 mW and about 500 mW, have a peak power between about 50 W and about 200 W, and a pulse width of between about 2 ns and about 100 ns. In addition, light source 112 may optionally be associated with optical assembly 202B used for manipulation of the light emitted by laser diode 202A (e.g., for collimation, focusing, etc.). It is noted that other types of light sources 112 may be used, and that the disclosure is not restricted to laser diodes. In addition, light source 112 may emit its light in different formats, such as light pulses, frequency modulated, continuous wave (CW), quasi-CW, or any other form corresponding to the particular light source employed. The projection format and other parameters may be changed by the light source from time to time based on different factors, such as instructions from processing unit 108. The projected light is projected towards an outbound deflector 114A that functions as a steering element for directing the projected light in field of view 120. In this example, scanning unit 104 also include a pivotable return deflector 114B that direct photons (reflected light 206) reflected back from an object 208 within field of view 120 toward sensor 116. The reflected light is detected by sensor 116 and information about the object (e.g., the distance to object 212) is determined by processing unit 108. While FIG. 2A represents scanning along horizontal scan lines in alternating directions, in the case of the scanning system of FIG. 1A, the scanning of all horizontal scan lines will generally proceed in a common direction (e.g., as dictated by the rotational direction of deflector 114 about scan axis 119).

In the example of FIG. 2A, LIDAR system 100 is connected to a host 210. Consistent with the present disclosure, the term “host” refers to any computing environment that may interface with LIDAR system 100, it may be a vehicle system (e.g., part of vehicle 110), a testing system, a security system, a surveillance system, a traffic control system, an urban modelling system, or any system that monitors its surroundings. Such computing environment may include at least one processor and/or may be connected LIDAR system 100 via the cloud. In some embodiments, host 210 may also include interfaces to external devices such as camera and sensors configured to measure different characteristics of host 210 (e.g., acceleration, steering wheel deflection, reverse drive, etc.). Consistent with the present disclosure, LIDAR system 100 may be fixed to a stationary object associated with host 210 (e.g., a building, a tripod) or to a portable system associated with host 210 (e.g., a portable computer, a movie camera). Consistent with the present disclosure, LIDAR system 100 may be connected to host 210, to provide outputs of LIDAR system 100 (e.g., a 3D model, a reflectivity image) to host 210. Specifically, host 210 may use LIDAR system 100 to aid in detecting and scanning the environment of host 210 or any other environment. In addition, host 210 may integrate, synchronize, or otherwise use together the outputs of LIDAR system 100 with outputs of other sensing systems (e.g., cameras, microphones, radar systems). In one example, LIDAR system 100 may be used by a security system.

LIDAR system 100 may also include a bus 212 (or other communication mechanisms) that interconnect subsystems and components for transferring information within LIDAR system 100. Optionally, bus 212 (or another communication mechanism) may be used for interconnecting LIDAR system 100 with host 210. In the example of FIG. 2A, processing unit 108 includes two processors 118 to regulate the operation of projecting unit 102, scanning unit 104, and sensing unit 106 in a coordinated manner based, at least partially, on information received from internal feedback of LIDAR system 100. In other words, processing unit 108 may be configured to dynamically operate LIDAR system 100 in a closed loop. A closed loop system is characterized by having feedback from at least one of the elements and updating one or more parameters based on the received feedback. Moreover, a closed loop system may receive feedback and update its own operation, at least partially, based on that feedback. A dynamic system or element is one that may be updated during operation.

According to some embodiments, scanning the environment around LIDAR system 100 may include illuminating field of view 120 with light pulses. The light pulses may have parameters such as: pulse duration, pulse angular dispersion, wavelength, instantaneous power, photon density at different distances from light source 112, average power, pulse power intensity, pulse width, pulse repetition rate, pulse sequence, pulse duty cycle, wavelength, phase, polarization, and more. Scanning the environment around LIDAR system 100 may also include detecting and characterizing various aspects of the reflected light. Characteristics of the reflected light may include, for example: time-of-flight (i.e., time from emission until detection), instantaneous power (e.g., power signature), average power across entire return pulse, and photon distribution/signal over return pulse period. By comparing characteristics of a light pulse with characteristics of corresponding reflections, a distance and possibly a physical characteristic, such as reflected intensity of object 212 may be estimated. By repeating this process across multiple adjacent portions 122, in a predefined pattern (e.g., raster, Lissajous or other patterns) an entire scan of field of view 120 may be achieved. In some situations, LIDAR system 100 may direct light to only some of the portions 122 in field of view 120 at every scanning cycle. These portions may be adjacent to each other, but not necessarily so.

In another embodiment, LIDAR system 100 may include network interface 214 for communicating with host 210 (e.g., a vehicle controller). The communication between LIDAR system 100 and host 210 is represented by a dashed arrow. In one embodiment, network interface 214 may include an integrated service digital network (ISDN) card, cable modem, satellite modem, or a modem to provide a data communication connection to a corresponding type of telephone line. As another example, network interface 214 may include a local area network (LAN) card to provide a data communication connection to a compatible LAN. In another embodiment, network interface 214 may include an Ethernet port connected to radio frequency receivers and transmitters and/or optical (e.g., infrared) receivers and transmitters. The specific design and implementation of network interface 214 depends on the communications network(s) over which LIDAR system 100 and host 210 are intended to operate. For example, network interface 214 may be used, for example, to provide outputs of LIDAR system 100 to the external system, such as a 3D model, operational parameters of LIDAR system 100, and so on. In other embodiment, the communication unit may be used, for example, to receive instructions from the external system, to receive information regarding the inspected environment, to receive information from another sensor, etc.

In some embodiments, the light source may include a single, monolithic laser array including a plurality of laser emitters. By way of example, light source 112 may include a plurality of laser emitters fabricated on a single silicon wafer. Thus, laser emission unit may be in the form of a monolithic laser array. The term monolithic laser array refers to an array of laser light sources fabricated on a single (e.g., monolithic) silicon wafer. Because the laser light sources are fabricated on a single silicon wafer, the laser light sources on the monolithic laser array may be well aligned with each other. FIG. 2B illustrates an example of a monolithic laser array 220 including a plurality of laser emitters (e.g., 222, 224, 226, etc.). In some embodiments, the monolithic laser array comprises a one-dimensional laser array. By way of example, as illustrated in FIG. 2B, laser array 220 may be a one-dimensional laser array including active regions 222, 224, 226, etc. (e.g., laser emitters), arranged in a single column. It is contemplated, however, that in some embodiments, laser array 220 may be a two-dimensional laser array, including active regions separated from each other and arranged in a two-dimensional matrix. In some embodiments, the plurality of laser emitters may be edge emitters. For example, one or more of laser emitters 222, 224, 226, etc., in laser array 220 may include edge emitter lasers. It is contemplated, however, that one or more of laser emitters 222, 224, 226, etc., may include other types of laser emitters (e.g., vertical-cavity surface-emitting laser (VCSEL)). In some embodiments, each of the plurality of laser beams may be a pulsed laser beam with a wavelength between 860 nm and 950 nm. For example, as discussed above one or more of laser emitters 222, 224, 226, etc., may be a pulsed laser emitter configured to emit a pulsed laser having a wavelength of between 860 nm-950 nm. It is also contemplated that in some embodiments, the one or more laser emitters 222, 224, 226, etc., may be configured to emit laser light having a wavelength of between 1300 nm-1600 nm.

In some embodiments, the monolithic laser array may include a plurality of active regions corresponding to the plurality of laser emitters and a plurality of inactive regions, wherein the plurality of laser emitters are spaced apart from one another by one or more of the plurality of inactive regions. A monolithic laser array may include a plurality of active regions (e.g., laser light emitting regions or laser emitters) separated from each other by inactive regions (e.g., non-laser emitting inactive regions). As illustrated in FIG. 2B, for example, laser array 220 may include a plurality of (e.g., 8) laser light emitting regions or laser emitters 222, 224, 226, 228, 230, 232, 234, and 236. Laser array 220 may also include a plurality of inactive regions (e.g., non-laser emitting regions) 241-248. It is contemplated that adjacent active regions may be separated by one or more inactive regions. For example, as illustrated in FIG. 2B, active regions 224 and 226 may be separated by inactive region 242. Likewise, active regions 230 and 232 may be separated by inactive region 246. It is contemplated that more than one inactive region may be disposed between the active regions. For example, as illustrated in FIG. 2B, active regions 232 and 234 may be separated by inactive regions 246, 247. Each active region may correspond to a channel. Thus, for example, FIG. 2B illustrates a laser array 220 having 8 channels. It is contemplated that laser array 220 may have any number of channels.

In some embodiments, the monolithic laser array may include 4 active laser channels. In some embodiments, the monolithic laser array may include 8 active laser channels. In some embodiments, the monolithic laser array may include 16 active laser channels. In some embodiments, the monolithic laser array may include 32 active laser channels. For example, a laser array may include 16 laser sources arranged in a 1-D array, each laser source having a wavelength of about 905 nm. The light emitted from the laser sources may travel through various optical components associated with the optical path, including, e.g., lenses, collimators, etc. FIG. 2C illustrates an exemplary monolithic laser array 250 that may include 16 or 32 active regions 256. For example, as illustrated in FIG. 2C, monolithic laser array 250 may include active laser emitting regions 256 (e.g., n₁-n₃₂) with adjacent pair of active laser emitting regions 956 spaced apart by one or more non-laser emitting inactive regions 258 (e.g., m₁-m₃₁). The example of a FIG. 2C includes 16 laser channels (or 16 laser light sources in the array). Other numbers of laser sources may be used. For example, some embodiments may include 4, 8, 32, 64 laser sources, or any other desired number of laser sources.

In some embodiments, the plurality of laser emitters may include multiple monolithic laser arrays. By way of example, instead of fabricating a single laser array having 32 active regions, it may be possible to fabricate two monolithic laser arrays each having 16 active regions. For example, as illustrated in FIG. 2C, laser array 250 may include monolithic laser arrays 260 and 262. Laser array 260 may include active regions (e.g., laser emitters) 256 (e.g., n₁-n₁₆) spaced apart by inactive regions 958 (e.g., m₁-m₁₅). Similarly, laser array 262 may include active regions (e.g., laser emitters) 256 (e.g., n₁₇-n₃₂) spaced apart by inactive regions 258 (e.g., m₁₆-m₃₁). As also illustrated in FIG. 2C, monolithic laser arrays 260 and 262 may both be fabricated on the same wafer. Alternatively, monolithic laser arrays 260 and 262 may be fabricated on different wafers or on different portions of the same wafter. Laser arrays 260 and 262 may be diced from the wafers and then assembled adjacent to each other to form a single 1-D laser array 250. Laser arrays 260 and 262 may be assembled via a suitable manufacturing or assembly process (e.g., bonding) to precisely align laser arrays 260 and 262.

The laser light sources may also be arranged in various configurations within the 1-D array. In some embodiments, a ratio of active regions to inactive regions in the monolithic laser array may be 1:1. For example, in some embodiments, a 1-D laser array may be configured to operate with a 1:1 ratio of active laser channels to inactive interstitial space between the laser channels. This may be accomplished in several ways. For example, 16 laser channels may be arranged in a 1-D array 270 such that each pair of adjacent laser sources may be separated by an interstitial inactive space of equal size as each laser source. As a result, as illustrated in FIG. 2D, the 1-D array may include an alternating and repeating sequence of one laser source 272 adjacent to one interstitial inactive space 276 in the array. As illustrated in FIG. 2D, the laser source 272 and interstitial inactive region 274 may be similarly sized (e.g., approximately 0.01 mm×0.1 mm, or 0.001 mm×0.1 mm). After the laser beam is emitted, each beam may be collimated by one or more collimators 1112. Once the beam is collimated, its size spot size in far field may be expressed as an angular size. Thus, for example, as illustrated in FIG. 2D, beams emitted from laser array 270 of FIG. 2D may have an angular width of 0.1° after being collimated and a spacing between adjacent collimated beams may be 0.2°. Non-limiting examples of angular beam spot sizes are e.g., 0.07 degrees×0.11 degrees, or 0.1×0.05 degrees, or 0.1×0.1 degrees, or 0.1×0.2 degrees, or 0.1×0.4 degrees. Although laser array 270 includes 16 such units, other 1:1 ratio array configurations may also be used. For example, as illustrated in FIG. 2E, eight active laser channels 276 may be interleaved by eight similarly or differently sized inactive spaces 278. As illustrated in FIG. 2E, the laser source 276 and interstitial inactive region 278 may be similarly sized (e.g., 0.01 mm×0.2 mm). By way of another example, as illustrated in FIG. 2F, four active laser channels 280 may be interleaved by four similarly or differently sized inactive spaces 282. As illustrated in FIG. 2F, the laser source 280 and interstitial inactive region 282 may be similarly sized (e.g., 0.01 mm×0.4 mm). In each case, the power of the laser sources may be selected to provide a desired total power. In one example, the sixteen-channel array may include sixteen 30 W laser sources, the eight-channel array may include eight 60 W laser sources, and the four-laser source array may include four 120 W laser sources, all yielding a total maximum power of 480 W. The emitters may have any suitable power level (e.g., between 20 W to 200 W). In some embodiments, a ratio of active region width to inactive region width in the monolithic laser array may be 1:2 or any other ratio.

### The Scanning Unit

FIG. 3A provides a diagrammatic representation of an exemplary LIDAR system 100 that mechanically scans the environment of LIDAR system 100. In this example, LIDAR system 100 may include a motor or other mechanisms for rotating housing 200 about the axis of the LIDAR system 100 (e.g., scan axis 119, as shown in FIG. 1A). Alternatively, the motor (or other mechanism) may mechanically rotate a rigid structure associated with LIDAR system 100 that houses deflector 114, among other components. In some cases, the rotated structure may also include one or more light sources 112 and one or more sensors 116, but in other cases, light sources 112 and sensors 116 may be maintained in a fixed, non-rotating position. As described above, projecting unit 102 may include at least one light source 112 configured to project light emission. The projected light emission may travel along an outbound path towards field of view 120. Specifically, the projected light emission may be reflected by first deflector 114A through an exit aperture 301 when projected light 204 travel towards optional optical window 124. The reflected light emission may travel along a return path from object 208 towards sensing unit 106. For example, the reflected light 206 may be reflected by deflector 114B when reflected light 206 travels towards sensing unit 106. A person skilled in the art would appreciate that a LIDAR system with a rotation mechanism for synchronically rotating one or more light sources or one or more sensors, may use this synchronized rotation instead of (or in addition to) steering an internal light deflector. In some cases, only a single deflector 114 may be included, and both the transmission light paths (Tx) and return light paths (Rx) may be incident upon deflector 114.

In embodiments in which the scanning of field of view 120 is mechanical, the projected light emission may be directed to exit aperture 301 that is part of a wall 302 separating projecting unit 102 from other parts of LIDAR system 100. In some examples, wall 302 can be formed from a transparent material (e.g., glass) coated with a reflective material to form deflector 114B. In this example, exit aperture 301 may correspond to the portion of wall 302 that is not coated by the reflective material. Additionally or alternatively, exit aperture 301 may include a hole or cut-away in the wall 302. Reflected light 206 may be reflected by deflector 114B and directed towards an entrance aperture 303 of sensing unit 106. In some examples, an entrance aperture 303 may include a filtering window configured to allow wavelengths in a certain wavelength range to enter sensing unit 106 and attenuate other wavelengths. The reflections from an object in field of view 120 may be reflected by deflector 114B and made incident upon sensor 116. By comparing several properties of reflected light 206 with projected light 204, at least one aspect of the object may be determined. For example, by comparing a time when projected light 204 was emitted by light source 112 and a time when sensor 116 received reflected light 206, a distance between the object and LIDAR system 100 may be determined. In some examples, other aspects of the object, such as shape, color, material, etc. may also be determined.

In some examples, the LIDAR system 100 (or part thereof, including at least one light source 112 and at least one sensor 116) may be rotated about at least one axis to determine a three-dimensional map of the surroundings of the LIDAR system 100. For example, the LIDAR system 100 may be rotated about a substantially vertical axis (e.g., scan axis 119) as illustrated by arrow 304 in order to scan field of view 120. Although FIG. 3A illustrates that the LIDAR system 100 is rotated clockwise about the axis as illustrated by the arrow 304, additionally or alternatively, the LIDAR system 100 may be rotated in a counterclockwise direction. In some examples, the LIDAR system 100 may be rotated 360 degrees about the vertical axis. In other examples, the LIDAR system 100 may be rotated back and forth along a sector smaller than 360-degree of the LIDAR system 100. For example, the LIDAR system 100 may be mounted on a platform that wobbles back and forth about the axis without making a complete rotation.

In some embodiments, a beam splitter may be configured to transmit each of the plurality of laser beams and to re-direct a plurality of reflected beams received from the field of view of the LIDAR system. FIG. 3B illustrates an exemplary LIDAR system 100 including beam splitter 306. As illustrated in FIG. 3B, LIDAR system 100 may include monolithic laser array 308 configured to emit one or more beams of laser light (e.g., 312, 314, 316, 318). Monolithic laser array 308 that may include 16 or 32 active regions 313. For example, as illustrated in FIG. 3B, monolithic laser array 308 may include active laser emitting regions 313 with adjacent pair of active laser emitting regions 313 spaced apart by one or more non-laser emitting inactive regions 315. Other numbers of laser sources may be used. For example, some embodiments may include 4, 8, 32, 64 laser sources, or any other desired number of laser sources.

The one or more beams of laser light may be collimated by one or more collimators 310 before beams 312, 314, 316, and/or 318 are incident on beam splitter 306. Beam splitter 306 may allow laser light beams 312, 314, 316, and/or 318 to pass through and be incident on deflectors 317, 319, which may be configured to direct laser light beams 312, 314, 316, and/or 318 towards FOV 120. Although only two deflectors 317, 319 have been illustrated in FIG. 3B, it is contemplated that LIDAR system 100 may include more than two deflectors 317, 319 configured to direct one or more of the light beams 312, 314, 316, and/or 318 towards FOV 120. One or more objects in FOV 120 may reflect one or more of the light beams 312, 314, 316, and/or 318. As illustrated in FIG. 3B, the reflected light beams may be represented as laser light beams 322, 324, 326, and/or 328. Although reflected laser light beams 322, 324, 326, and/or 328 are illustrated in FIG. 3B as being directly incident on beam splitter 306, it is contemplated that some or all of light beams 322, 324, 326, and/or 328 may be directed by deflectors 317, 319 and/or another deflector towards beam splitter 306. When light beams 322, 324, 326, and/or 328 reach splitter 306, splitter 306 may be configured to direct reflected light beams 322, 324, 326, and/or 328 received from FOV 120 towards detector 330 via lens 332. Monolithic detector 330 may include a plurality of light sensitive active regions 331 separated by inactive regions 333. The sizes of active and inactive regions 331 and 333, respectively, may be equal or unequal. Although FIG. 3B illustrates four light beams being emitted by monolithic laser array 308, it is contemplated that monolithic laser array 308 may emit any number of light beams (e.g., less than or more than four).

In some embodiments, the beam splitter is configured to re-direct each of the plurality of laser beams and pass a plurality of reflected beams received from the field of view of the LIDAR system. By way of example, FIG. 3C illustrates an exemplary LIDAR system 100 that may include monolithic laser array 308, collimator 310, beam splitter 306, deflector 317, 319, lens and/or optical filter 332 and detector 330. As illustrated in FIG. 3C, monolithic laser array 308 may emit one or more laser light beams 312, 314, 316, and/or 318 that may be collimated by one or more collimators 310 before being incident on beam splitter 306. Beam splitter 306 may be configured to direct one or more of the laser light beams 312, 314, 316, and/or 318 towards deflectors 317, 319, which in turn may be configured to direct the one or more laser light beams 312, 314, 316, and/or 318 towards FOV 120. As discussed above, one or more objects in FOV 120 may reflect one or more of the laser light beams 312, 314, 316, and/or 318. Reflected laser light beams 322, 324, 326, and/or 328 may be directed by deflectors 317, 319 to be incident on beam splitter 306. It is also contemplated that some or all of reflected laser light beams 322, 324, 326, and/or 328 may reach beam splitter 306 without being directed by deflector 317, 319 towards beam splitter 306. As illustrated in FIG. 3C, beam splitter 306 may be configured to allow the reflected laser light beams 322, 324, 326, and/or 328 to pass through beam splitter 306 towards detector 330. One or more lenses and/or optical filters 332 may receive the reflected laser light beams 322, 324, 326, and/or 328 and direct these light beams towards detector 330. Although FIG. 3C illustrates four light beams being admitted by monolithic laser array 308, it is contemplated that monolithic laser array 308 may emit any number of light beams (e.g., less than or more than four).

### The Sensing Unit

FIGS. 4A-4D depict various configurations of sensing unit 106 and its role in LIDAR system 100. Specifically, FIG. 4A is a diagram illustrating an example sensing unit 106 with a detector array. One skilled in the art will appreciate that the depicted configurations of sensing unit 106 are exemplary only and may have numerous alternative variations and modifications consistent with the principles of this disclosure.

FIG. 4A illustrates an example of sensing unit 106 with detector array 400. In this example, at least one sensor 116 includes detector array 400. LIDAR system 100 is configured to detect objects (e.g., bicycle 208A and cloud 208B) in field of view 120 located at different distances from LIDAR system 100 (could be meters or more). Objects 208 may be a solid object (e.g., a road, a tree, a car, a person), fluid object (e.g., fog, water, atmosphere particles), or object of another type (e.g., dust or a powdery illuminated object). When the photons emitted from light source 112 hit object 208 they either reflect, refract, or get absorbed. In some cases, as shown in the FIG. 4A, only a portion of the photons reflected from object 208A may enter optional optical window 124. As each ~15 cm change in distance results in a travel time difference of 1 ns (since the photons travel at the speed of light to and from object 208), the time differences between the travel times of different photons hitting the different objects may be detectable by a time-of-flight sensor with sufficiently quick response.

Sensor 116 includes a plurality of detection elements 402 for detecting photons of a photonic pulse reflected back from field of view 120. The detection elements may all be included in detector array 400, which may have a rectangular arrangement (e.g., as shown) or any other arrangement. Detection elements 402 may operate concurrently or partially concurrently with each other. Specifically, each detection element 402 may issue detection information for every sampling duration (e.g., every 1 nanosecond). In one example, detector array 400 may be a SiPM (Silicon photomultipliers) which is a solid-state single-photon-sensitive device built from an array of single photon avalanche diodes (SPADs, serving as detection elements 402) on a common silicon substrate. Similar photomultipliers from other, non-silicon materials may also be used. Although a SiPM device works in digital/switching mode, the SiPM is an analog device because all the microcells are read in parallel, making it possible to generate signals within a dynamic range from a single photon to hundreds and thousands of photons detected by the different SPADs. As mentioned above, more than one type of sensor may be implemented (e.g., SiPM and APD). Possibly, sensing unit 106 may include at least one APD integrated into an SiPM array and/or at least one APD detector located next to a SiPM on a separate or common silicon substrate.

In one embodiment, detection elements 402 may be grouped into a plurality of regions or pixels 404. The regions are geometrical locations or environments within sensor 116 (e.g., within detector array 400)—and may be shaped in different shapes (e.g., rectangular as shown, squares, rings, and so on, or in any other shape). While not all of the individual detectors, which are included within the geometrical area of a region 404, necessarily belong to that region, in most cases they will not belong to other regions 404 covering other areas of the sensor 310—unless some overlap is desired in the seams between regions. As illustrated in FIG. 4A, the regions may be non-overlapping regions 404, but alternatively, they may overlap. Every region may be associated with a regional output circuitry 406 associated with that region. The regional output circuitry 406 may provide a region output signal of a corresponding group of detection elements 402. For example, the region of output circuitry 406 may be a summing circuit, but other forms of combined output of the individual detector into a unitary output (whether scalar, vector, or any other format) may be employed. Optionally, each region 404 is a single SiPM, but this is not necessarily so, and a region may be a sub-portion of a single SiPM, a group of several SiPMs, or even a combination of different types of detectors.

In the illustrated example, processing unit 108 is located in a separate housing 200B (within or outside) host 210 (e.g., within vehicle 110), and sensing unit 106 may include a dedicated processor 408 for analyzing the reflected light. Alternatively, processing unit 108 may be used for analyzing reflected light 206. It is noted that LIDAR system 100 may be implemented multiple housings in other ways than the illustrated example. For example, light deflector 114 may be located in a different housing than projecting unit 102 and/or sensing unit 106. In one embodiment, LIDAR system 100 may include multiple housings connected to each other in different ways, such as: electric wire connection, wireless connection (e.g., RF connection), fiber optics cable, and any combination of the above.

In one embodiment, analyzing reflected light 206 may include determining a time of flight for reflected light 206, based on outputs of individual detectors of different regions. Optionally, processor 408 may be configured to determine the time of flight for reflected light 206 based on the plurality of regions of output signals. In addition to the time of flight, processing unit 108 may analyze reflected light 206 to determine the average power across an entire return pulse, and the photon distribution/signal may be determined over the return pulse period (“pulse shape”). In the illustrated example, the outputs of any detection elements 402 may not be transmitted directly to processor 408, but rather combined (e.g., summed) with signals of other detectors of the region 404 before being passed to processor 408. However, this is only an example and the circuitry of sensor 116 may transmit information from a detection element 402 to processor 408 via other routes (not via a region output circuitry 406).

Sensor 116 may be composed of a matrix (e.g., 4×6) of pixels 404. In one embodiment, a pixel size may be about 1×1 mm. Sensor 116 may be two-dimensional in the sense that it has more than one set (e.g., row, column) of pixels 404 in two non-parallel axes (e.g., orthogonal axes, as exemplified in the illustrated examples). The number of pixels 404 in sensor 116 may vary between differing implementations, e.g., depending on the desired resolution, signal to noise ratio (SNR), desired detection distance, and so on. For example, sensor 116 may have anywhere between 5 and 5,000 pixels. In another example (not shown in the figure), sensor 116 may be a one-dimensional matrix (e.g., 1×4, 1×8, etc. pixels).

It is noted that each detector pixel 404 may include a plurality of detection elements 402, such as Avalanche Photo Diodes (APD), Single Photon Avalanche Diodes (SPADs), combination of Avalanche Photo Diodes (APD) and Single Photon Avalanche Diodes (SPADs)or detecting elements that measure both the time of flight from a laser pulse transmission event to the reception event and the intensity of the received photons. For example, each pixel may include anywhere between 20 and 5,000 SPADs. The outputs of detection elements 402 in each detector pixel 404 may be summed, averaged, or otherwise combined to provide a unified pixel output.

According to some embodiments, measurements from each detector pixel 404 may enable determination of the time of flight from a light pulse emission event to the reception event and the intensity of the received photons. The reception event may be the result of the light pulse being reflected from object 208. The time of flight may be a timestamp value that represents the distance of the reflecting object to optional optical window 124. Time of flight values may be realized by photon detection and counting methods, such as Time Correlated Single Photon Counters (TCSPC), analog methods for photon detection such as signal integration and qualification (via analog to digital converters or plain comparators) or otherwise.

In some embodiments, during a scanning cycle, each instantaneous position of at least one light deflector 114 may be associated with a particular portion 122 of field of view 120. The design of sensor 116 enables an association between the reflected light from a single portion of field of view 120 and multiple detector pixels 404. Therefore, the scanning resolution of LIDAR system may be represented by the number of instantaneous positions (per scanning cycle) times the number of pixels 404 in sensor 116. The information from each pixel 404 represents the basic data element from which the captured field of view in the three-dimensional space is built. This may include, for example, the basic element of a point cloud representation, with a spatial position and time of flight/range value. In one embodiment, the reflections from a single portion of field of view 120 that are detected by multiple pixels 404 may be returning from different objects located in the single portion of field of view 120. For example, the single portion of field of view 120 may be greater than 50×50 cm at the far field, which can include two, three, or more objects partly covered by each other.

In some embodiments, a ratio of light sensitive active regions to inactive regions in the detector is 1:1. For example, in some embodiments, a 1-D detector 1130 may be configured to operate with a 1:1 ratio of active to inactive regions. This may be accomplished in several ways. For example, as illustrated in FIG. 4B, detector 330 may include n active regions (n₁ to n_{N}) and N−1 inactive regions (m₁ to m_{N-1}), and each pair of active regions may be separated by an inactive region. As illustrated in FIG. 4B, the 1-D detector may include an alternating and repeating sequence of active region 331 adjacent to one inactive region 333 in the array of equal size. Thus, the ratio of active to inactive regions may be 1:1.

In some embodiments, a ratio of light sensitive active regions to inactive regions in the detector is 1:2. In addition to a 1:1 array, as represented by FIG. 4B above, a 1:2 ratio array may also be used. For example, as represented in FIG. 4C, detector 330 may instead include an alternating and repeating sequence of active region 331 adjacent to an inactive region 333, where the inactive region 333 may have a width two times the width of each active region 331. Other ratios of the laser source and inactive space are also contemplated. In some embodiments, a ratio of light sensitive active regions to inactive regions in the detector is 1:3. In some embodiments, a ratio of light sensitive active regions to inactive regions in the detector is 1:5. In some embodiments, a ratio of light sensitive active regions to inactive regions in the detector is in between 1:1 and 1:10. FIG. 4D illustrates an example where the ratio of the active to inactive regions is 1:5. In this example, each active region 331 is separated by an inactive region 333 having a width equal to five times the width of an active region 331.

Any number of active and inactive regions may be present on monolithic detector 330. For example, N for detector array 330 in FIGS. 4B-4D, may range from 1 to any desired number. Thus, for example, N may be 4, 8, 16, 32, 64, etc. In some embodiments, the detector may include 4 light sensitive active regions (e.g., N=4). In some embodiments, the detector may include 8 light sensitive active regions (e.g., N=8). In some embodiments, the detector may include 16 light sensitive active regions (e.g., N=16). In some embodiments, the detector may include 32 light sensitive active regions (e.g., N=32).

A plurality of rays representing each laser beam may be reflected from the field of view. The plurality of reflected rays may form a spot on the detector (e.g., 330). It is contemplated that in some embodiments the spot of reflected laser light beam rays may be incident on only one active region 331 of, for example, detector 330 or on more than one active region of detector 330. FIG. 4B illustrates an exemplary spot 350 that may be incident on more than one active region 331 (e.g., n2, n3) of detector 330. By ensuring that spot 350 is incident on more than one active region 331, it may be possible to ensure that more than one active region generates a signal corresponding to a detected object from which laser beams were reflected. The separate signals corresponding to a region on a detected object enables increased resolution for that region, i.e., each active region is a distinct pixel of a subregion within the region on the detected object.

### The Processing Unit

FIGS. 5A and 5B depict different functionalities of processing units 108 in accordance with some embodiments of the present disclosure. Specifically, FIG. 5A is a diagram illustrating emission patterns in a single frame-time for a single portion of the field of view, and FIG. 5B is a diagram illustrating emission scheme in a single frame-time for the whole field of view.

FIG. 5A illustrates four examples of emission patterns in a single frame-time for a single portion 122 of field of view 120 associated with an instantaneous position of light deflector 114 (e.g., a specific rotational angle about axis 119 and a specific tilt angle about tilt axis 121). Consistent with embodiments of the present disclosure, processing unit 108 may control at least one light source 112 and light deflector 114 (or coordinate the operation of at least one light source 112 and at least one light deflector 114) in a manner enabling light flux to vary over a scan of field of view 120. Consistent with other embodiments, processing unit 108 may control only at least one light source 112 and light deflector 114 may be moved or pivoted in a fixed predefined pattern.

Diagrams A-D in FIG. 5A depict the power of light emitted towards a single portion 122 of field of view 120 over time. In Diagram A, processor 118 may control the operation of light source 112 in a manner such that during scanning of field of view 120 an initial light emission is projected toward portion 122 of field of view 120. When projecting unit 102 includes a pulsed-light light source, the initial light emission may include one or more initial pulses (also referred to as “pilot pulses”). Processing unit 108 may receive from sensor 116 pilot information about reflections associated with the initial light emission. In one embodiment, the pilot information may be represented as a single signal based on the outputs of one or more detectors (e.g., one or more SPADs, one or more APDs, one or more SiPMs, etc.) or as a plurality of signals based on the outputs of multiple detectors. In one example, the pilot information may include analog and/or digital information. In another example, the pilot information may include a single value and/or a plurality of values (e.g., for different times and/or parts of the segment).

Based on information about reflections associated with the initial light emission, processing unit 108 may be configured to determine the type of subsequent light emission to be projected towards portion 122 of field of view 120. The determined subsequent light emission for the particular portion of field of view 120 may be made during the same scanning cycle (i.e., in the same frame) or in a subsequent scanning cycle (i.e., in a subsequent frame).

In Diagram B, processor 118 may control the operation of light source 112 in a manner such that during scanning of field of view 120 light pulses in different intensities are projected towards a single portion 122 of field of view 120. In one embodiment, LIDAR system 100 may be operable to generate depth maps of one or more different types, such as any one or more of the following types: point cloud model, polygon mesh, depth image (holding depth information for each pixel of an image or of a 2D array), or any other type of 3D model of a scene. The sequence of depth maps may be a temporal sequence, in which different depth maps are generated at a different time. Each depth map of the sequence associated with a scanning cycle (interchangeably “frame”) may be generated within the duration of a corresponding subsequent frame-time. In one example, a typical frame-time may last less than a second. In some embodiments, LIDAR system 100 may have a fixed frame rate (e.g., 10 frames per second, 25 frames per second, 50 frames per second) or the frame rate may be dynamic. In other embodiments, the frame-times of different frames may not be identical across the sequence. For example, LIDAR system 100 may implement a 10 frames-per-second rate that includes generating a first depth map in 100 milliseconds (the average), a second frame in 92 milliseconds, a third frame at 142 milliseconds, and so on.

In Diagram C, processor 118 may control the operation of light source 112 in a manner such that during scanning of field of view 120 light pulses associated with different durations are projected towards a single portion 122 of field of view 120. In one embodiment, LIDAR system 100 may be operable to generate a different number of pulses in each frame. The number of pulses may vary between 0 to 32 pulses (e.g., 1, 5, 12, 28, or more pulses) and may be based on information derived from previous emissions. The time between light pulses may depend on desired detection range and can be between 500 ns and 5000 ns. In one example, processing unit 108 may receive from sensor 116 information about reflections associated with each light-pulse. Based on the information (or the lack of information), processing unit 108 may determine if additional light pulses are needed. It is noted that the durations of the processing times and the emission times in diagrams A-D are not in-scale. Specifically, the processing time may be substantially longer than the emission time. In diagram D, projecting unit 102 may include a continuous-wave light source. In one embodiment, the initial light emission may include a period of time where light is emitted and the subsequent emission may be a continuation of the initial emission, or there may be a discontinuity. In one embodiment, the intensity of the continuous emission may change over time.

Consistent with some embodiments of the present disclosure, the emission pattern may be determined per each portion of field of view 120. In other words, processor 118 may control the emission of light to allow differentiation in the illumination of different portions of field of view 120. In one example, processor 118 may determine the emission pattern for a single portion 122 of field of view 120, based on detection of reflected light from the same scanning cycle (e.g., the initial emission), which makes LIDAR system 100 extremely dynamic. In another example, processor 118 may determine the emission pattern for a single portion 122 of field of view 120, based on detection of reflected light from a previous scanning cycle. The differences in the patterns of the subsequent emissions may result from determining different values for light-source parameters for the subsequent emission, such as any one of the following: a) overall energy of the subsequent emission; b) energy profile of the subsequent emission; c) a number of light-pulse-repetition per frame; d) light modulation characteristics such as duration, rate, peak, average power, and pulse shape; and e) wave properties of the subsequent emission, such as polarization, wavelength, etc.

Consistent with the present disclosure, the differentiation in the subsequent emissions may be put to different uses. In one example, it is possible to limit emitted power levels in one portion of field of view 120 where safety is a consideration, while emitting higher power levels (thus improving signal-to-noise ratio and detection range) for other portions of field of view 120. This is relevant for eye safety, but may also be relevant for skin safety, safety of optical systems, safety of sensitive materials, and more. In another example, it is possible to direct more energy towards portions of field of view 120 where it will be of greater use (e.g., regions of interest, further distanced targets, low reflection targets, etc.) while limiting the lighting energy to other portions of field of view 120 based on detection results from the same frame or previous frame. It is noted that processing unit 108 may process detected signals from a single instantaneous field of view several times within a single scanning frame time; for example, subsequent emission may be determined upon after every pulse emitted, or after a number of pulses emitted.

FIG. 5B illustrates three examples of emission schemes in a single frame-time for field of view 120. Consistent with embodiments of the present disclosure, at least on processing unit 108 may use obtained information to dynamically adjust the operational mode of LIDAR system 100 and/or determine values of parameters of specific components of LIDAR system 100. The obtained information may be determined from processing data captured in field of view 120, or received (directly or indirectly) from host 210. Processing unit 108 may use the obtained information to determine a scanning scheme for scanning the different portions of field of view 120. The obtained information may include a current light condition, a current weather condition, a current driving environment of the host vehicle, a current location of the host vehicle, a current trajectory of the host vehicle, a current topography of road surrounding the host vehicle, or any other condition or object detectable through light reflection. In some embodiments, the determined scanning scheme may include at least one of the following: (a) a designation of portions within field of view 120 to be actively scanned as part of a scanning cycle, (b) a projecting plan for projecting unit 102 that defines the light emission profile at different portions of field of view 120; (c) a deflecting plan for scanning unit 104 that defines, for example, a deflection direction, frequency, and designating idle elements within a reflector array; and (d) a detection plan for sensing unit 106 that defines the detectors sensitivity or responsivity pattern.

In addition, processing unit 108 may determine the scanning scheme at least partially by obtaining an identification of at least one region of interest within the field of view 120 and at least one region of non-interest within the field of view 120. In some embodiments, processing unit 108 may determine the scanning scheme at least partially by obtaining an identification of at least one region of high interest within the field of view 120 and at least one region of lower-interest within the field of view 120. The identification of the at least one region of interest within the field of view 120 may be determined, for example, from processing data captured in field of view 120, based on data of another sensor (e.g., camera, GPS), received (directly or indirectly) from host 210, or any combination of the above. In some embodiments, the identification of at least one region of interest may include identification of portions, areas, sections, pixels, or objects within field of view 120 that are important to monitor. Examples of areas that may be identified as regions of interest may include, crosswalks, moving objects, people, nearby vehicles or any other environmental condition or object that may be helpful in vehicle navigation. Examples of areas that may be identified as regions of non-interest (or lower-interest) may be static (non-moving) far-away buildings, a skyline, an area above the horizon and objects in the field of view. Upon obtaining the identification of at least one region of interest within the field of view 120, processing unit 108 may determine the scanning scheme or change an existing scanning scheme. Further to determining or changing the light-source parameters (as described above), processing unit 108 may allocate detector resources based on the identification of the at least one region of interest. In one example, to reduce noise, processing unit 108 may activate detectors 410 where a region of interest is expected and disable detectors 410 where regions of non-interest are expected. In another example, processing unit 108 may change the detector sensitivity, e.g., increasing sensor sensitivity for long range detection where the reflected power is low.

Diagrams A-C in FIG. 5B depict examples of different scanning schemes for scanning field of view 120. Each square in field of view 120 represents a different portion 122 associated with an instantaneous position of at least one light deflector 114. Legend 500 details the level of light flux represented by the filling pattern of the squares. Diagram A depicts a first scanning scheme in which all of the portions have the same importance/priority and a default light flux is allocated to them. The first scanning scheme may be utilized in a start-up phase or periodically interleaved with another scanning scheme to monitor the whole field of view for unexpected/new objects. In one example, the light source parameters in the first scanning scheme may be configured to generate light pulses at constant amplitudes. Diagram B depicts a second scanning scheme in which a portion of field of view 120 is allocated with high light flux while the rest of field of view 120 is allocated with default light flux and low light flux. The portions of field of view 120 that are the least interesting may be allocated with low light flux. Diagram C depicts a third scanning scheme in which a compact vehicle and a bus (see silhouettes) are identified in field of view 120. In this scanning scheme, the edges of the vehicle and bus may be tracked with high power and the central mass of the vehicle and bus may be allocated with less light flux (or no light flux). Such light flux allocation enables concentration of more of the optical budget on the edges of the identified objects and less on their center which have less importance.

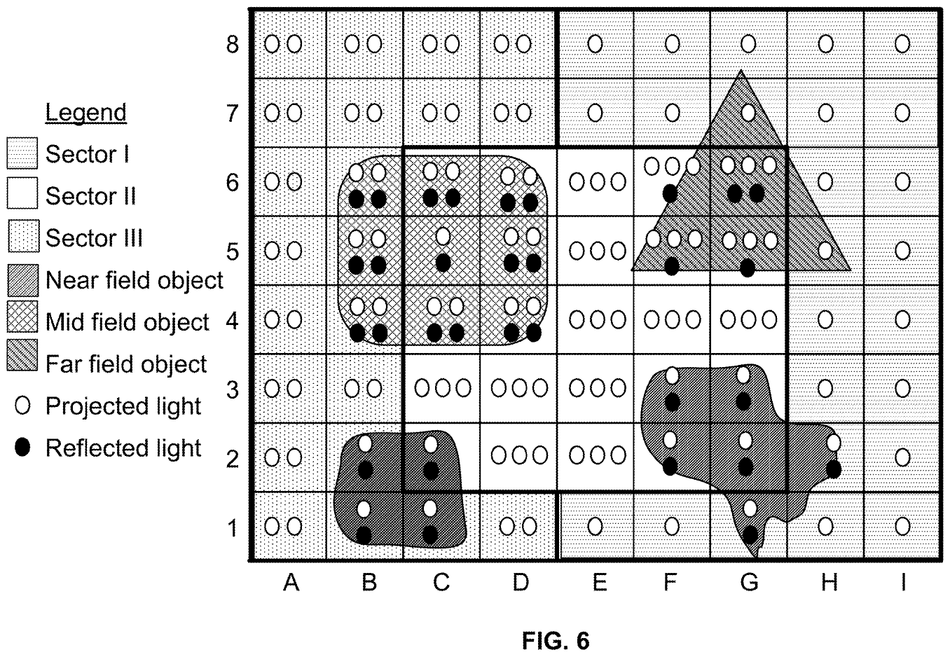

FIG. 6 illustrates the emission of light towards field of view 120 during a single scanning cycle. In the depicted example, a portion of field of view 120 is represented by an 8×9 matrix, where each of the 72 cells corresponds to a separate portion 122 associated with a different instantaneous position of at least one light deflector 114. In this exemplary scanning cycle, each portion includes one or more white dots that represent the number of light pulses projected toward that portion, and some portions include black dots that represent reflected light from that portion detected by sensor 116. As shown, field of view 120 is divided into three sectors: sector I on the right side of field of view 120, sector II in the middle of field of view 120, and sector III on the left side of field of view 120. In this exemplary scanning cycle, sector I was initially allocated with a single light pulse per portion; sector II, previously identified as a region of interest, was initially allocated with three light pulses per portion; and sector III was initially allocated with two light pulses per portion. Also as shown, scanning of field of view 120 reveals four objects 208: two free-form objects in the near field (e.g., between 5 and 50 meters), a rounded-square object in the mid field (e.g., between 50 and 150 meters), and a triangle object in the far field (e.g., between 150 and 500 meters). While the discussion of FIG. 6 uses number of pulses as an example of light flux allocation, it is noted that light flux allocation to different parts of the field of view may also be implemented in other ways such as: pulse duration, pulse angular dispersion, wavelength, instantaneous power, photon density at different distances from light source 112, average power, pulse power intensity, pulse width, pulse repetition rate, pulse sequence, pulse duty cycle, wavelength, phase, polarization, and more. The illustration of the light emission as a single scanning cycle in FIG. 6 demonstrates different capabilities of LIDAR system 100. In a first embodiment, processor 118 is configured to use two light pulses to detect a first object (e.g., the rounded-square object) at a first distance, and to use three light pulses to detect a second object (e.g., the triangle object) at a second distance greater than the first distance. In a second embodiment, processor 118 is configured to allocate more light to portions of the field of view where a region of interest is identified. Specifically, in the present example, sector II was identified as a region of interest and accordingly it was allocated with three light pulses while the rest of field of view 120 was allocated with two or less light pulses. In a third embodiment, processor 118 is configured to control light source 112 in a manner such that only a single light pulse is projected toward to portions B1, B2, and Cl in FIG. 6, although they are part of sector III that was initially allocated with two light pulses per portion. This occurs because the processing unit 108 detected an object in the near field based on the first light pulse. Allocation of less than maximal amount of pulses may also be a result of other considerations. For examples, in at least some regions, detection of object at a first distance (e.g., a near field object) may result in reducing an overall amount of light emitted to this portion of field of view 120.

Additional details and examples on different components of LIDAR system 100 and their associated functionalities are included in Applicant's United States Patent Application Publication No. 2018/0100928 A1, published Apr. 12, 2018; Applicant's United States Patent Application Publication No. 2018/0113216 A1, published Apr. 26, 2018; Applicant's United States Patent Application Publication No. 2018/0081037 A1, published Mar. 22, 2018; and Applicant's United States Patent Application Publication No. 2018/0081038 A1, published Mar. 22, 2018, which are incorporated herein by reference in their entirety.

### High Bandwidth Contactless Communications System for a Rotatable LIDAR

A rotatable LIDAR system typically includes a rotor and a stator that need to be in communication with each other to scan a 360-degree field of view about the LIDAR system. Increasing the rotation speed of the rotor can increase the accuracy of the LIDAR system, however, it can also cause failure of the communications system due to friction at a rotating interface. The friction between the rotor and the stator of the LIDAR system may be significant, especially when the rotor rotates at a speed greater than 1000 rpm. Disclosed embodiments provide systems, methods, and devices for facilitating contactless communications in rotatable LIDAR systems that facilitates a high-speed rotatable LIDAR system. Consistent with the disclosed embodiments, an exemplary system may include two communications windings separated by a gap of between 50 and 120 microns. The two communications windings may enable data communications in a bandwidth of between 1 MHz and 2 GHz.

For example, for various applications, a rotatable LIDAR system may provide certain advantages. In the context of automotive LIDAR systems, as shown in FIG. 1A, LIDAR system 100 may be compact to allow for placement on top of vehicle 110, and may be designed to scan a 360 degree, 3-dimensional (3D) field of view in the vehicle environment.

In some embodiments, a rotatable LIDAR system involves a contactless rotating LIDAR communications system. The contactless rotating LIDAR communications system may refer to any communications system that facilitates communications between two (or more) parts of a rotatable LIDAR system where a rotating portion is not in contact with a stationary portion. According to some disclosed embodiments, the contactless rotating LIDAR communications system may enable communications between a stator and a rotor of a rotatable LIDAR system at a bandwidth approximately between 1 MHz and 10 GHz and at a bit rate of at least 0.5 gbps. For example, the contactless rotating LIDAR communications system may include a first communications winding on the rotor and a second communications winding on the stator. A contactless data link may be established in a rotary transformer between the first communications winding facing the second communications winding. Alternating signal current in one of the communications windings is transmitted to the other communications winding, and vice versa, via electrical inductive and capacitive coupling. Consistent with the present disclosure, the first communications winding and the second communications winding of the contactless rotating LIDAR communications system may be separated from each other by a gap.

In some embodiments, a rotatable LIDAR system includes a rotor and a stator opposing the rotor. The term “rotor” broadly refers to a moving element of a rotatable LIDAR system. The rotor may be configured to rotate, for example, when the presence of certain electromagnetic fields generate a torque about an axis of the rotor. Similarly, the term “stator” broadly refers to a substantially stationary element of the rotatable LIDAR system. The stator may generate the electromagnetic fields resulting in the torque that causes the rotor to rotate. Examples of horizontal cross-sections of the rotor and the stator include round, square, triangular, rectangular, oval, or any other shaped cross-section. Consistent with the present disclosure, the rotor may include one or more components of LIDAR system 100. In some configurations, the rotor may include at least one light source (e.g., light source 112), a movable light deflector, (e.g., deflector 114), and a light detector (e.g., sensor 116); and the stator may include at least one processor (e.g., processor 118) and a motor configured to rotate the rotor. In other configurations, the rotor may include only some of the components listed above and the rest of the components may be included in the stator or vice-versa. In addition, each of the rotor and the stator may include a communications component (e.g., a communications winding) to facilitate communication with various components of the rotatable LIDAR system mounted on either the rotor or the stator.

In some embodiments, a rotatable LIDAR system includes a motor configured to rotate the rotor. The term “motor” generally refers to any device that causes rotation. Such structures may be in the form of a device, engine, and/or mechanism that converts one form of energy into mechanical energy. Examples of motors may include, without limitation, electric motors, Direct Current (DC) motors, alternating current (AC) motors, vibration motors (without shaft weights), brushless motors, switched reluctance motors, synchronous motors, rotary motors, servo motors, coreless motors, stepper motors, universal motors, variations of one or more of the same, combinations of one or more of the same, or any other suitable motors. In some embodiments, the motor may be configured to rotate the rotor at speeds of greater than 3000 rpm, greater than 4000 rpm, greater than 5000 rpm, greater than 6000 rpm, greater than 7000 rpm, greater than 8000 rpm, greater than 9000 rpm, greater than 10,000 rpm, or at any other higher or lower rotational speed.

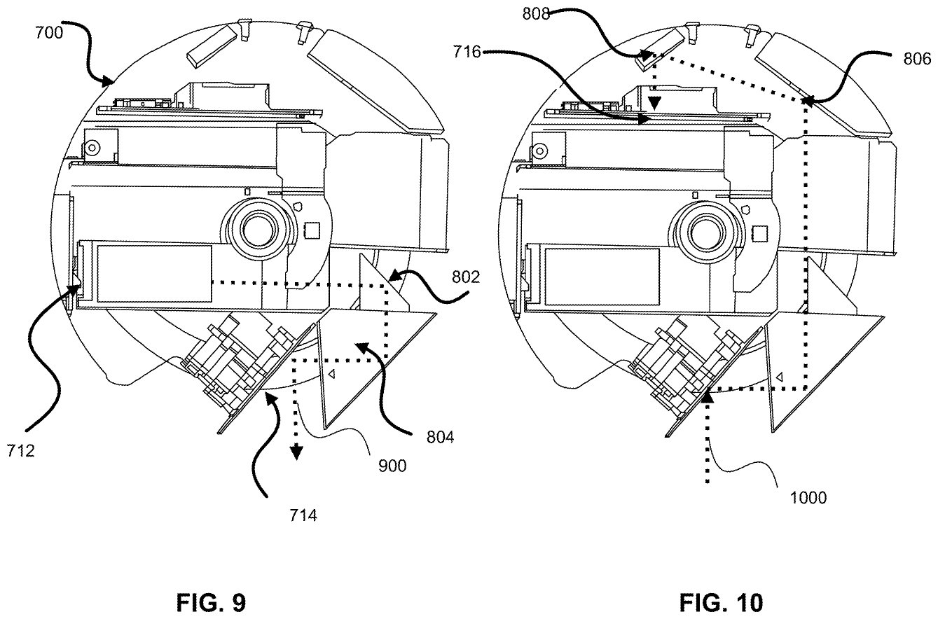

In some embodiments, a rotatable LIDAR system includes a light source mounted on the rotor and configured to output a light beam. As discussed above, the term “light source” broadly refers to any device configured to emit light. In one embodiment, the light source may be a laser such as a solid-state laser, laser diode, a high-power laser, or an alternative light source such as, a light emitting diode (LED)-based light source. From a geometric standpoint, a light beam may be described as a concentrated and coherent flow of photons, which represents the propagation of electromagnetic radiation traveling in a specific direction or along a designated path. Light beams may also be conceptualized as a grouping of light rays that travel together in a coherent manner. While the individual rays within the beam may exhibit slight variations in direction or wavelength, they generally share an overarching trajectory or orientation. The collective effect of these multiple rays forms the light beam, which possesses a discernible spatial distribution and may carry energy and information. An exemplary optical path for the transmission of a projected light in a rotatable LIDAR system is depicted in FIG. 9. Consistent with the present disclosure, the light source mounted on the rotor may include a multichannel laser and configured to concurrently output multiple light beams. Using a multichannel laser may enable an enlarged vertical field of view, a higher frame capture rate or pixel rate, and/or variable resolution capabilities. Additional details and examples of light sources that may be used in a rotatable LIDAR system are discussed above with reference to LIDAR system 100 and are not repeated herein.

In some embodiments, a rotatable LIDAR system includes a movable light deflector mounted on the rotor in a path of the light beam. As discussed above, the term “light deflector” broadly refers to any mechanism or module which is configured to make light deviate from its original path. A light deflector may be considered “movable” if it causes light to deviate in a variable way from its original path. In one embodiment, the movable light deflector may include a plurality of optical components, such as at least one reflecting element (e.g., a mirror) and at least one refracting element (e.g., a prism, a lens). The movable light deflector may be configured to cause the light beam to deviate to differing degrees. Specifically, the movable light deflector may be configured to vertically scan a field of view with the light beam as the rotor rotates. The term “vertically scan a field of view” broadly refers to scanning the environment of LIDAR system by moving or pivoting the movable light deflector about a tilt axis to deflect light in differing directions (e.g., up and down) toward different parts of the field of view. The field of view may refer to an extent of the observable environment of LIDAR system in which objects may be detected. The tilt axis may be perpendicular to the rotation axis of the LIDAR system. The rotation axis being an imaginary axis about which the body rotates in a circular or oscillatory movement. In other words, the rotation of the LIDAR system responsible for horizontal scanning of the field of view and the tilting of the movable light deflector responsible for vertical scanning of the field of view. Additional details and examples of light deflectors that may be used in a rotatable LIDAR system are discussed above with reference to LIDAR system 100 and are not repeated herein.

In some embodiments, a rotatable LIDAR system includes a light detector mounted on the rotor. It is noted that the terms “light sensor” and “light detector” may be used interchangeably in this disclosure. Accordingly, the term “light detector” broadly refers to any device, element, or system capable of measuring properties (e.g., power, frequency, phase, pulse timing, pulse duration) of electromagnetic waves associated with the reflected light and to generate an output relating to the measured properties. Consistent with the present disclosure, the light detector may be configured to receive, while the rotor rotates and the light deflector moves, reflections of light from the field of view. Since photons travel at the speed of light to and from object (the timing of which is significantly greater than the rotation of the LIDAR system and/or the tilting of the moveable light deflector), the light detector receives the reflections at a known instantaneous position of the moveable light deflector. An exemplary optical path for the receipt of reflected light in a rotatable LIDAR system is depicted in FIG. 10. Additional details and examples of light sensors or light detectors that may be used in a rotatable LIDAR system are discussed above with reference to LIDAR system 100 and are not repeated herein.

In some embodiments, a rotatable LIDAR system includes a first communications winding on the rotor and a second communications winding on the stator. The term “communications winding” broadly refers to any type of conductor, irrespective of shape, cross-section, or number of turns, having a curved, twisted, or spiral course or form, and which is adapted to carry electrical current. A communications winding may comprise for example, without limitation, a single strand of conductive material, multiple strands of such material (whether intertwined, separate, or otherwise), or a bifilar winding. For example, the first communications winding may be a single loop of wire. Consistent with the present disclosure, the first and second communications winding may form a wireless data link that may enable uni-directional or bi-directional data transmission using inductive and capacitive coupling. In some embodiments, once the communications windings are energized, signals may be transmitted between the communications windings by electrical, inductive, and capacitive coupling. Specifically, alternating signal current may be transmitted from the first communications winding to the second communications winding and vice versa. In addition, the geometry of the communications windings may have a direct impact on the frequency band of the wireless data link. According to some disclosed embodiments, the first communications winding is configured to transmit, in a bandwidth of between 1 MHz and 2 GHz, signals associated with the received reflections. Similarly, in some disclosed embodiments, the second communications winding is configured to receive the transmitted signals from the first communications winding in the bandwidth of between 1 MHz and 2 GHz. In this disclosure, the term “bandwidth” may refer to measure of the width of a range of frequencies, measured in hertz or width of the channel spectrum used for data transmission. The term “bandwidth” is not intended to be equated to the term “bit rate” which is the number of bits transmitted per unit time. In some examples, the bandwidth may be between 10 MHz and 1.5 GHz, between 100 MHz and 1 GHz, or any bandwidth between the values listed above. Moreover, the first communications winding may transmit at a bit rate of at least 0.5 gbps, at least 1 gbps, at least 1.5 gbps, at least 2 gbps, at least 3 gbps, at least 4 gbps, at least 5 gbps, at least 6 gbps, at least 7 gbps, at least 8 gbps, at least 9 gbps, at least 10 gbps, or more. Additional details and examples of communications winding that may be used in a rotatable LIDAR system are discussed below with reference to FIGS. 12 to 16.

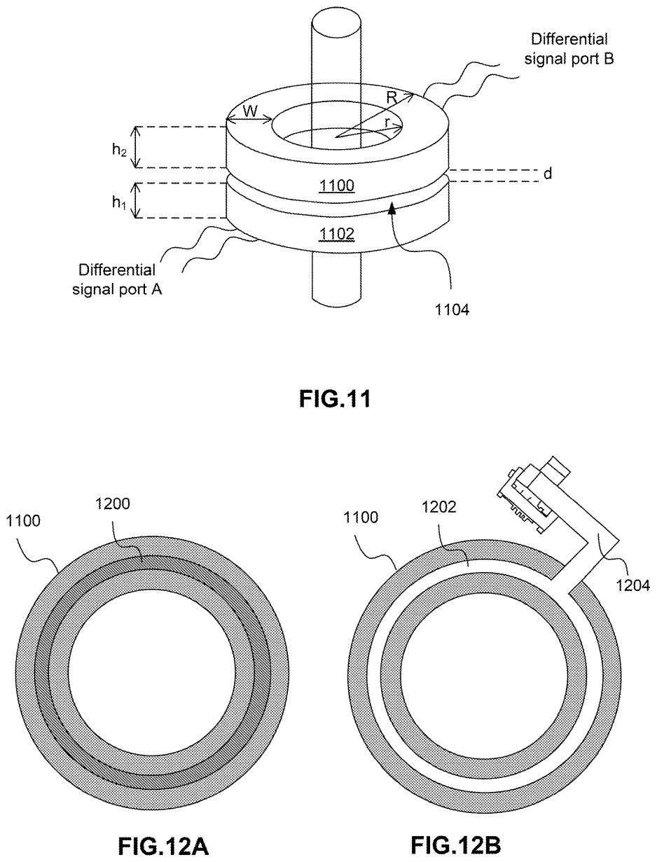

In some embodiments, the second communications winding is spaced from the first communications winding by a gap of between 50 and 120 microns, and the first communications winding and the second communications winding overlap each other on opposite sides of the gap. The term “gap” broadly refers to an area in the rotatable LIDAR system that separates the first communications winding and the second communications winding. In some cases, the gap may be filled with air. In other cases, the gap may be filled with inert gases or any other materiel that does not interfere with a wireless data link formed by the first and second communications winding. In one example, the second communications winding may be spaced from the first communications winding by a gap of between 80 and 110 microns. In alternative embodiments, the second communications winding may be spaced from the first communications winding by a gap of between 50 and 300 microns. For example, the gap may be between 65 and 250 microns, between 80 and 200 microns, between 100 and 150 microns, or any other distance. Additional details and examples of the gap between the first and second communications winding that may be used in a rotatable LIDAR system are discussed below with reference to FIGS. 11 to 13.

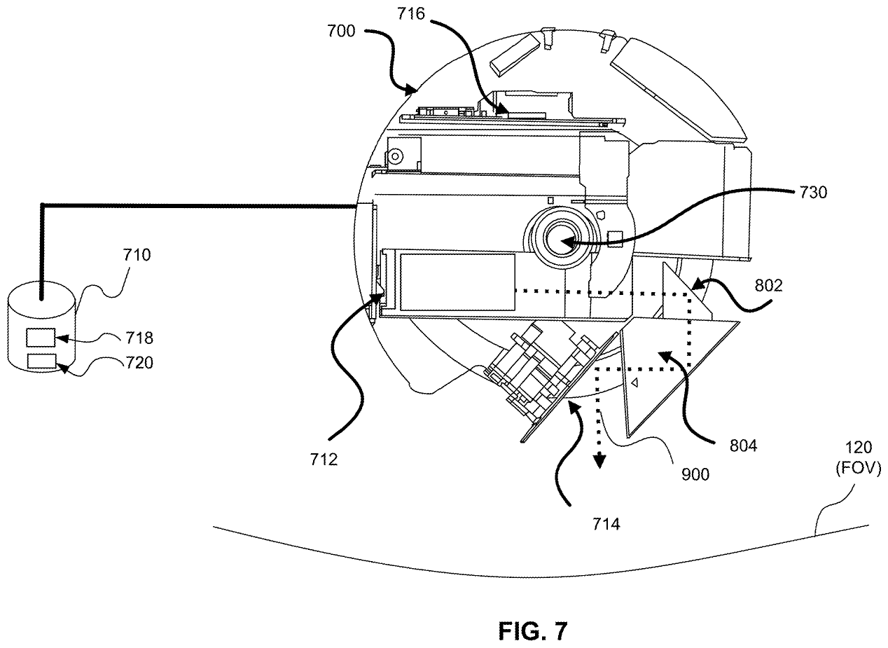

FIG. 7 is a diagrammatic illustration of an example of a conceptual rotatable LIDAR system, consistent with some embodiments of the present disclosure. A rotatable LIDAR system may comprise of a rotor 700 associated with a light source 712, a movable light deflector 714, a light detector 716, a stator 710 associated with processor 718, and a motor 720. In the example shown, the direction of rotation of a rotor 700 (from a top view) is counterclockwise about rotation axis 730. Rotor 700, however, may also be configured to rotate in a clockwise direction. In one example, movable light deflector 714 may include a folding mirror. Light source 712 may include an array of laser sources that generate multiple beams to form a multibeam array, which may be made incident upon movable light deflector 714. In turn, movable light deflector 714 deflects the multibeam array toward field of view 120 in the form of a projected multibeam array. Thereafter, light detector 716 may be configured to receive, via movable light deflector 714, laser light resulting from one or more of the plurality of laser beams reflected from at least one object in field of view 120.

For illustration purposes, movable light deflector 714 is depicted outside rotor 700, however, a person skilled in the art would recognize that this configuration is optional and not a requirement. Specifically, processor 718 may be located on rotor 700 and not on stator 710. Additionally or alternatively, movable light deflector 714 may also be located on rotor 700. In this position, the column of beams included in the multibeam array may be projected onto movable light deflector 714 in a sustainably vertically oriented column. In turn, projected multibeam array may be projected toward field of view 120 also in a sustainably horizontally oriented column. Each vertical portion of the field of view may be illuminated by a different light source.

Rotating such a vertically oriented column of laser beams toward field of view 120 can yield several benefits. By way of example, multiple horizontal scan lines can be scanned simultaneously, as movable light deflector 714 spins about rotation axis 730. Not only can such an arrangement enable larger vertical scan angles over field of view 120, but it may also reduce the time required to complete a single full scan of field of view 120 because multiple portions of the field of view are being scanned simultaneously. In some embodiments, a single full scan of field of view 120 may include 360 degrees in the horizontal dimension and a predetermined angular height (e.g., at least 35 degrees, at least 40 degrees, or at least 45 degrees) in the vertical dimension.

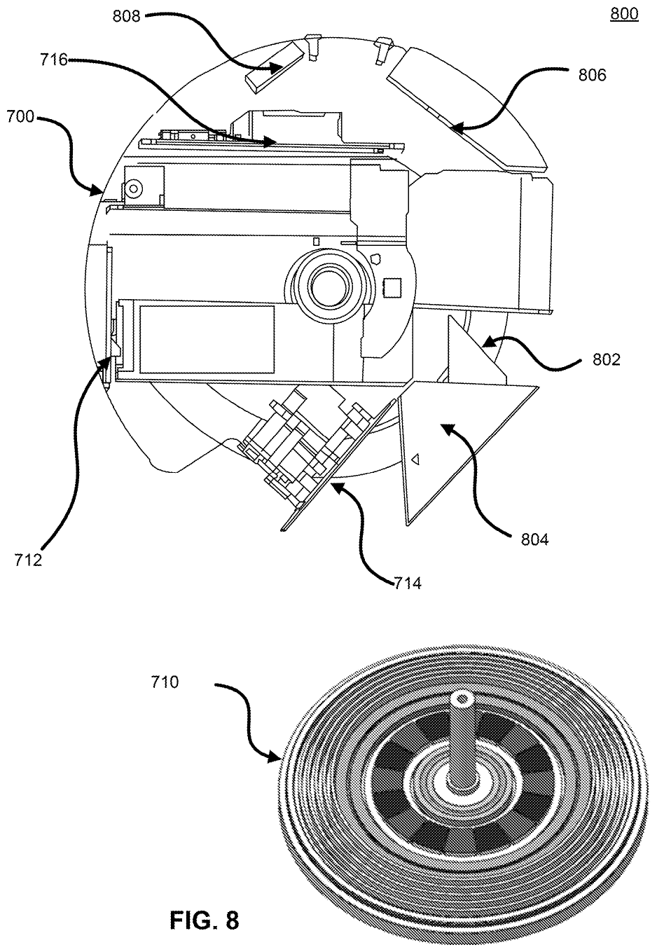

FIG. 8 is a diagrammatic illustration of an example implementation of a rotatable LIDAR system, consistent with some embodiments of the present disclosure. The diagrammatic illustration of a rotatable LIDAR system 800 includes a schematic top view of an example rotor 700 and a schematic perspective view of an example stator 710. As shown, light source 712, movable light deflector 714, and light detector 716 are all mounted on rotor 700. In addition, rotor 700 may include: a transmission (TX) mirror 802, a prism 804, a receipt (Rx) folding mirror 806, and a deflector mirror 808.

In some embodiments, light source 712 of rotatable LIDAR system 800 includes a multichannel laser, such as a monolithic multichannel laser bar. The laser bar may include multiple diode lasers spaced apart on a single substrate by a predetermined distance. By way of an example, light source 712 may include 8, 16 or 32 laser sources arranged in a one-dimensional (1D) array. The diodes may emit light at a wavelength of between 850 nm and 950 nm (e.g., about 905 nm), between 1450 nm and 1650 nm (e.g., about 1550 nm), or any wavelength suitable for a particular application.

In some embodiments, movable light deflector 714 of rotatable LIDAR system 800 may include any type of structure or combination of structures capable of redirecting one or more incident light beams toward field of view 120 and redirecting one or more reflections toward light detector 716. In some embodiments, movable light deflector 714 includes a folding mirror configured to rotate about a substantially vertically oriented tilt axis (e.g., a horizonal axis). In other words, the deflection caused movable light deflector 714 vertical and movable light deflector 714 rotates about a horizonal axis. The movable light deflector 714, together with the rotation of rotor 700, will result in a complete 360 degrees scan of the horizontal field of view. In some cases, movable light deflector 714 may rotate about a horizontal tilt axis, but does not move about other axes. In some cases, however, movable light deflector 714 may move about the horizontal tilt axis, but may also be configured to move about one or more other axes.

In some embodiments, light detector 716 of rotatable LIDAR system 800 may include a plurality of detection elements that may receive light reflections from objects in the field of view of rotatable LIDAR system 800. Measurements from each detection element may enable determination of the time of flight from a light pulse emission event to the reception event. The intensity of received photons may also be determined based on the received laser light reflections. Various types of detection elements may be used. For example, light detector 716 may include an array of detection elements, such as, e.g., a multichannel SiPM (Silicon Photomultiplier) array, a SPAD (single-photon avalanche diode) array, or an APD (avalanche photodiodes) array. Light detector 716 may include an array of detection elements including combination of at least some of SPADs, SIPMs, APDs, and other types of detection elements.

FIG. 9 is a diagrammatic illustration of an exemplary optical path for transmission of projected light 900 in rotatable LIDAR system 800, and FIG. 10 is a diagrammatic illustration of an exemplary optical path for reception of reflected light 1000 in rotatable LIDAR system 800. As shown, in the transmission direction, projected light 900 is projected form light source 712. Thereafter, projected light 900 may be deflected by TX mirror 802, deflected again by a surface of prism 804, and directed to movable light deflector 714 for scanning field of view 120. In the reception direction, reflected light 1000 is received from field of view 120 to movable light deflector 714. Thereafter, reflected light 1000 may be deflected by a surface of prism 804, deflected again by compensator mirror 806 and deflector mirror 808, and then directed to light detector 716.

FIG. 11 is diagrammatic representation of an example of a conceptual contactless rotating LIDAR communications system, consistent with some embodiments of the present disclosure. A contactless rotating LIDAR communications system may include two communication rings, one for rotor 700 and another for stator 710. The term “communication ring” refers to any element from a magnetically permeable material used to form a magnetic field with reduced losses for enabling communications via a wireless data channel. A magnetically permeable material refers to any number of materials commonly used for forming inductive cores or similar components, including without limitation various formulations made from ferrite. By way of non-limiting example, the communications rings of rotatable LIDAR system 800 may be composed of 4c65 ferrite (NiZn Ferrite). The communication rings do not necessarily have to be a circular magnetically permeable loop. Other shapes may be used for communication rings, such as, rectangular, circular, oblong, oval, or elliptical. In some embodiments, the distance between the rotor's communications ring and the stator's communications ring may be designed to be close enough to support signal transmission between rotor 700 and stator 710. By way of example, the distance between the rotor communication ring and the stator communications ring may be between 50 and 300 microns. Since the magnetic permeability may affects communications parameters (e.g., insertion loss), the communications ring should have a sufficient magnetic permeability over the entire frequency bandwidth of the wireless transmission (e.g., between 1 MHz and 2 GHz). Some disclosed embodiments involve a rotor including a ring having magnetic permeability greater than 1500. By way of example, each of the rotor's communications ring and the stator's communications ring may have magnetic permeability greater than 1000 N/A², greater than 1250 N/A², greater than 1500 N/A², or more.

As illustrated in FIG. 11, a contactless rotating LIDAR communications system may include a rotor communications ring 1100, a stator communications ring 1102, and a gap 1104 between rotor communications ring 1100 and stator communications ring 1102. Example dimensions of rotor communications ring 1100 and stator communications ring 1102 may be: a height (h₁ and h₂) of between 1 mm and 5 mm, a width (W) of between 10 mm and 15 mm, an inner radius (r) of between 8 mm and 10 mm, and an outer radius (R) of between 13 and 18 mm. In some embodiments, the inner diameters, the outer diameters, and the heights of rotor communications ring 1100 and stator communications ring 1102 may be substantially the same. In other embodiments, at least one of the inner diameter, the outer diameter, and the height of rotor communications ring 1100 may differ from a corresponding dimension of stator communications ring 1102. A first surface of rotor communications ring 1100 and a second surface of stator communications ring 1102 may be separated by gap 1104. Gap 1104 may be associated with a distance (d) greater than 10 microns but less than 300 microns, less than 250 micron, less than 200 microns, less than 150 microns, less than 100 microns, or less than 50 microns.

Consistent with some embodiments of the present disclosure, each of rotor communications ring 1100 and stator communications ring 1102 may include a communications winding for facilitating contactless communications between rotor 700 and stator 710. Specifically, rotor communications ring 1100 may include a first communications winding for transmitting data at a bandwidth approximately between 1 MHz and 2 GHz and stator communications ring 1102 may include a second communications winding for receiving data at a bandwidth approximately between 1 MHz and 2 GHz. Moreover, each communications ring may include a circumferential groove therein that provides mechanical support for the communications windings. For example, the first communications winding may be located in a first circumferential grove of rotor communications ring 1100, and the second communications winding may be located in a second circumferential grove of stator communications ring 1102.

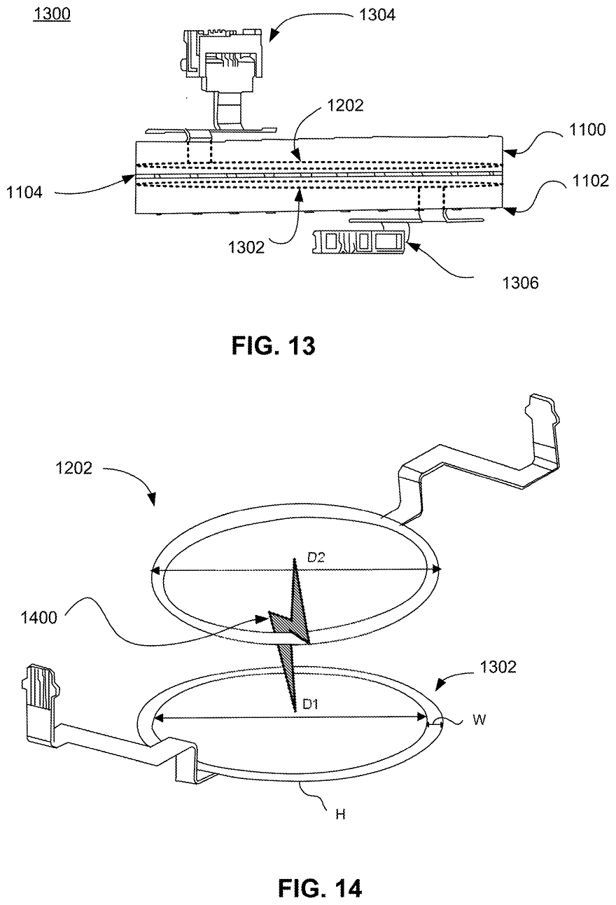

FIGS. 12A and 12B are diagrammatic top view illustrations of rotor communications ring 1100, with and without, a communications winding, consistent with some embodiments of the present disclosure. As mentioned above, rotor communications ring 1100 and stator communications ring 1102 may have circumferential grooves to accommodate the communications windings. The term “groove” may broadly refer to any opening in the communications ring or on a surface of the communications ring. A circumferential groove may have a closed curve shape that may be the same as the shape of the communications ring. For example, the shape of the circumferential groove may be rectangular, circular, oblong, oval, or elliptical. Some disclosed embodiments involve a ring including a circumferential groove therein, and with the first communications winding is located in the groove. Ring is any structure that at least partially surrounds another structure. A circumferential groove includes any slot, channel, hollow, trench, canal or indentation that either completely or partially surrounds a structure. By way of example, rotor communications ring 1100 may include a first circumferential groove 1200 therein, wherein a first communications winding 1202 may be located in first circumferential groove 1200. Similarly, stator communications ring 1102 may include a second circumferential groove (not shown) therein, and a second communications winding 1302 (shown in FIG. 13) may be located in the second circumferential groove. In some embodiments, the rotor includes a first ferrite ring with a first circumferential groove therein, and the stator includes a second ferrite ring with a second circumferential groove therein, and wherein the first communications winding is embedded in the first circumferential groove and the second communications winding is embedded in the second circumferential groove. By way of example rotor 700 may include a first ferrite ring (e.g., rotor communications ring 1100) with a first circumferential groove therein, and stator 710 may include a second ferrite ring (e.g., stator communications ring 1102) with a second circumferential groove therein. The rotor's communications winding (e.g., first communications winding 1202) may be embedded in the first circumferential groove, and the stator's communications winding (e.g., second communications winding 1302) may be embedded in the second circumferential groove. In related embodiments, the first communications winding is spaced from walls of the first circumferential groove and the second communications winding is spaced from walls of the second circumferential groove. With reference to the illustrated LIDAR system, first communications winding 1202 may be spaced from walls of the first circumferential groove and second communications winding 1302 may be spaced from walls of the second circumferential groove. Moreover, rotor communications ring 1100 and stator communications ring 1102 may be positioned one above the other, such that their circumferential grooves are facing but spaced from each other.

Consistent with the present disclosure, a gap (e.g., gap 1104) is designed to position first communications winding 1202 and second communications winding 1302 at a suitable distance for induction between the associated communications windings. For ease of discussion and illustration, the gap between first communications winding 1202 and second communications winding 1302 is referred hereinafter as gap 1104, however, it is understood that in some cases the gap between first communications winding 1202 and second communications winding 1302 may be greater or smaller than the gap between rotor communications ring 1100 and stator communications ring 1102. According to some embodiments, a distance of the gap between first communications winding 1202 and second communications winding 1302 (i.e., distance “d” of gap 1104) may be selected based on dimensions of the communication windings. By way of non-limiting example, a ratio between a diameter of a communication winding and a distance of the gap is between 50 and 500 microns, or between 50 and 200 microns, or between 50 and 120 microns. In addition, first communications winding 1202 and second communications winding 1302 may overlap each other on opposite sides of the gap.

FIG. 13 is a diagrammatic illustration of an example implementation of a contactless rotating LIDAR communications system 1300 of rotatable LIDAR system 800, consistent with some embodiments of the present disclosure. Contactless rotating LIDAR communications system 1300 may include rotor communications ring 1100 housing first communications winding 1202 and stator communications ring 1102 housing a second communications winding 1302. In some embodiments, the first communications winding is embodied in a flexible PCB. A flexible PCB includes any flexible electronics or flex circuits. By a way of example, first communications winding 1202 and/or second communications winding 1302 is embodied in a flexible Printed Circuit Board (PCB). However, in other cases, first communications winding 1202 and/or second communications winding 1302 may be a regular coil. Consistent with the present disclosure, the flexible PCB may be a single component that functions as a communications winding and a connector. The connector may be configured to be connected with a processor (e.g., communication chip). In the illustrated example, first communications winding 1202 may be associated with a connecting element 1304 and second communications winding 1302 may be associated with a connecting element 1306.

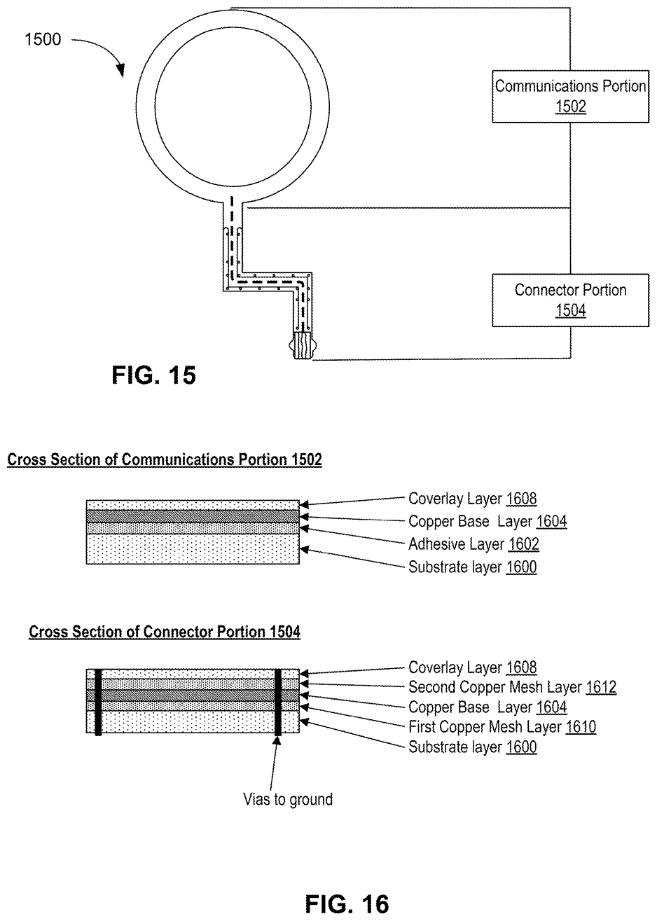

Some disclosed embodiments may involve a first communications winding associated with discrete impedance matching components embedded in the flexible PCB. For example, impedance matching components may be part of the flexible electronics. By way of example, when first communications winding 1202 is embodied in a flexible PCB, first communications winding 1202 may be associated with discrete impedance matching components embedded in the flexible PCB. By way of example, the discrete impedance matching components include at least one of: a transformer, a capacitor, a resistor, an inductor, or a coil. Additional details on the flexible PCB are described below with reference to FIGS. 15 and 16. Once the communications windings are energized, signals may be transmitted between the communications windings by electrical, inductive, and capacitive coupling. The communications between the two communications windings may be two-way, i.e., signals may be transmitted from stator 710 to rotor 700, and from rotor 700 to stator 710. Specifically, alternating signal current may be transmitted from first communications winding 1202 to second communications winding 1302, and vice versa, via electrical inductive and capacitive coupling. In some cases, the timing of the communications between first communications winding 1202 and second communications winding 1302 may be modulated.

FIG. 14 is a diagrammatic illustration of the two communications windings included in contactless rotating LIDAR communications system 1300. Consistent with some embodiments of the present disclosure, the first communications winding and the second communications winding overlap each other on opposite sides of the gap. By way of example, first communications winding 1202 have more than 85% overlap, more than 90% overlap, more than 92.5% overlap, more than 95% overlap, more than 99% overlap with second communications winding 1302. In addition, first communications winding 1202 may be positioned substantially parallel to second communications winding 1302 such that gap 1104 may be a uniform value.

In some embodiments, first communications winding 1202 and second communications winding 1302 may create a wireless communications channel 1400 that enables bi-directional data transmission. The geometry of the communications windings may have a direct impact on the frequency band of wireless communications channel 1400. In contactless rotating LIDAR communications system 1300, the geometry of the communications windings enables data exchange at a bandwidth approximately between 1 MHz and 2 GHz. In some embodiments, first communications winding 1202 and second communications winding 1302 may have substantially the same geometry. Some disclosed embodiments may involve the first communication winding and the second communication winding sharing a substantially same diameter. In other words, both windings may have roughly the same diameter. (e.g., less than 10% deviation). Specifically, in the example implementation, first communications winding 1202 and second communications winding 1302 may have substantially a same diameter. For example, both communications windings may have an inner diameter (D1) of between 20 mm and 22 mm and an outer diameter (D2) between 28 mm and 30 mm.

Some disclosed embodiments may involve the first communication winding with a circumference between 60 mm and 90 mm. For example, in some cases, first communications winding 1202 and second communications winding 1302 may have a circumference between 60 mm and 90 mm. In addition, in some embodiments, the first communications winding is formed of a wire having a width greater than a height thereof. In other words, first communications winding 1202 and/or second communications winding 1302 may be formed of a wire having a width (W) greater than a height (H) thereof. As shown, the communications windings may have a ‘flattened’ shape. In some embodiments, a ratio between the height of the wire and the width of the wire (H:W) is between 1:3 and 1:20. By a way of example, the width of the communications windings may be 1.3 mm and the height of the communications windings may be 130 microns.

Consistent with some disclosed embodiments, wireless communications channel 1400 may be used to transmit signals associated with data from light detector 716 in a bandwidth of between 1 MHz and 2 GHz. Specifically, wireless communications channel 1400 may enable first communications winding 1202 to simultaneously transmit first data at first frequency band (e.g., about 10 MHz), second data at second frequency band (e.g., about 100 MHz), and third data at third frequency band (e.g., about 1 GHz). The first frequency band, the second frequency band, and the third frequency band are all included in bandwidth of between 1 MHz and 2 GHz. In some embodiments, second band associated with frequencies at least 10 greater than frequencies associated with the first band; and third band associated with frequencies at least 10 times greater than frequencies associated with the second band. Moreover, rotatable LIDAR system 800 may concurrently scan field of view 120 with multiple beams (e.g., 8 beams, 16 beams, 32 beams, 64 beams, or more), and spin at a revolution rate (e.g., between 3000 RPM and 7500 RPM). To process all the data captured by light detector 716, contactless rotating LIDAR communications system 1300 is configured to transmit at a bit rate between 0.5 and 2.5 gigabytes per second (gbps). By way of example, the bit rate may be 0.5 gbps, 0.7 gbps, 1.0 gbps, 1.5 gbps, or 2 gbps.

Consistent with the present disclosure, in order to be able to transmit at bandwidth of between 1 MHz and 2 GHz and at a bit rate between 0.5 and 2.5 gbps, contactless rotating LIDAR communications system 1300 may be designed to minimize values of an insertion loss and a return loss. The insertion loss represents the amount of signal power lost between the input node (e.g., first communications winding 1202) and the output node (e.g., second communications winding 1302) of the channel per frequency. The return loss represents the amount of signal power reflected back towards the transmitting source per frequency. The values of the insertion loss and the return loss depend on the frequencies used for transmission. In a first example, for data transmitted at 0.5 GHz the insertion loss may be less than 1 dB and the return loss may be less than −20 dB. In a second example, for data transmitted at 1.5 GHz the insertion loss may be less than −10 dB and the return loss may be less than −20.

In disclosed embodiments, the distance between first communications winding 1202 and second communications winding 1302 (e.g., gap 1104) may also be chosen to accommodate minimal insertion loss and minimal return loss. In addition, the geometric design of the communications windings may be selected to be less sensitive to relative rotations between rotor 700 and stator 710. By way of example, the circumference of the communications windings may be selected to avoid measurable capacitive differences between the communications windings.

Consistent with disclosed embodiments, a communications winding (e.g., first communications winding 1202 and/or second communications winding 130) may be part of a flex PCB. FIG. 15 is diagrammatic illustration of a flex PCB 1500 included in rotatable LIDAR system 800, consistent with some embodiment of the present disclosure. Flex PCB 1500 includes a communications portion 1502 and a connector portion 1504. Communications portion 1502 may include a communications winding and connector portion 1504 may include at least one connector configured to connect with a processing device (e.g., a communication chip). Communications portion 1502 may have copper traces for attachment with connector portion 1504. In some embodiments, the impedance between flex PCB 1500 and the processing device is substantially matched to minimize signal reflection at connection nodes along a communication signal path. For example, at the node of connection to the PCB connector, the input impedance of flex PCB 1500 may be designed to have a value of 100 ohm. Moreover, the part of flex PCB 1500 up to communications portion 1502 may end with discrete impedance matching components embedded in the flexible PCB to match the impedance of the communications winding. The discrete matching components may be implemented at different locations between the flex connector and the flex communications winding.

FIG. 16 includes diagrammatic cross-sectional illustrations of Flex PCB 1500, consistent with some embodiments of the present disclosure. Flex PCB 1500 includes two cross-sectional views because the configurations of communications portion 1502 and connector portion 1504 differ from each other. But, in some embodiments, the configurations of communications portion 1502 and connector portion 1504 may have one or more layers in common.

As depicted, communications portion 1502 of the example flex PCB 1500 may have a substrate layer 1600 (e.g., polyimide) and a copper base layer 1604 containing two (or more) traces of copper. Consistent with the present disclosure, copper base layer 1604 forms a communications winding (e.g., first communications winding 1202 or second communications winding 1302). Copper base layer 1604 may be adhered to substrate layer 1600 with an adhesive layer 1602. Copper base layer 1604 may also be covered by a thin coverlay layer 1608 (e.g., polyimide). Coverlay layer 1608 may be thin relative to other layers to reduce interference to the wireless communication between the communications windings. In some embodiments, impedance matching components between the connector portion and the controller may be required.

Connector portion 1504 of the example flex PCB 1500 may be designed with additional layers to ensure impedance matching. Specifically, connector portion 1504 may include a first copper mesh layer 1610 below copper base layer 1604 and a second copper mesh layer 1612 above copper base layer 1604. The first and second copper mesh layers may be a cross-hatched mesh, or any other pattern of mesh resulting in a non-uniform thickness of the copper layer in the connector portion. Connector portion 1504 may include one or more vias to ground. By way of example, substrate layer 1600, copper base layer 1604, and coverlay layer 1608 may be common by both communications portion 1502 and connector portion 1504. In one embodiment, flex PCB 1500 may include connecting components between communications portion 1502 and connector portion 1504. The connecting components may be a resistor and a capacitor for each trace in communications portion 1502. By way of example, flex PCB 1500 may include two resistors and two capacitors.

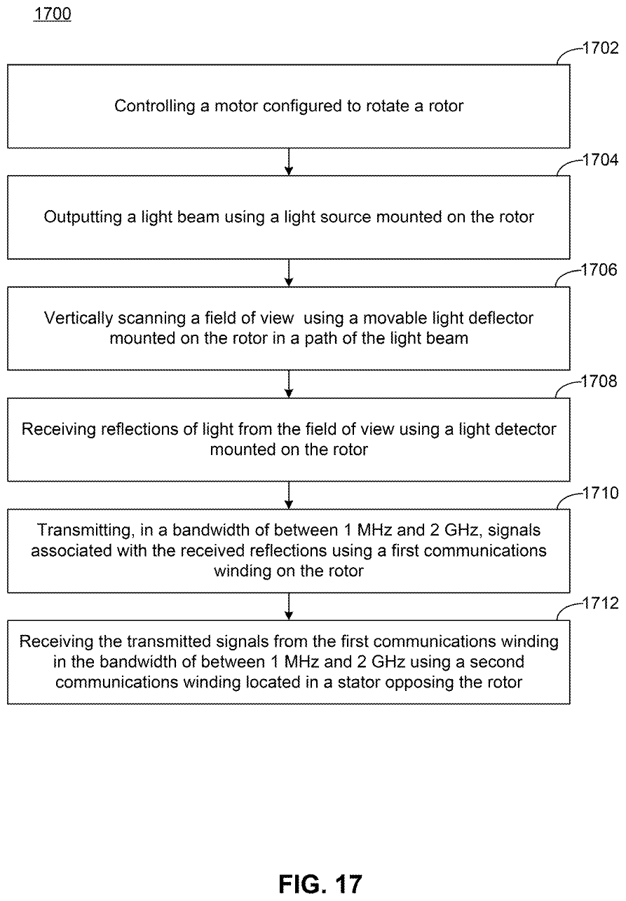

FIG. 17 is a flowchart of an example process 1700 for contactless rotating LIDAR communications method, according to embodiments of the present disclosure. In some embodiments, process 1700 may be performed by at least one processor (e.g., processor 118) to perform operations or functions described herein. In some embodiments, some aspects of process 1700 may be implemented as software (e.g., program codes or instructions) stored in a memory or a non-transitory computer-readable storage medium. In some embodiments, some aspects of process 1700 may be implemented as hardware (e.g., a specific-purpose circuit). In some embodiments, process 1700 may be implemented as a combination of software and hardware. For purposes of illustration, in the following description, reference is made to certain components of rotatable LIDAR system 800. It will be appreciated, however, that other implementations are possible and that any combination of components or devices may be utilized to implement the exemplary method. It will also be readily appreciated that the illustrated method can be altered to modify the order of steps, delete steps, or further include additional steps, such as steps directed to different embodiments described above.

Referring to FIG. 17, process 1700 may include a step 1702 of controlling a motor configured to rotate a rotor. For example, controlling motor 720 to rotate rotor 700 at a speed greater than 6000 rpm. Process 1700 may also include a step 1704 of outputting a light beam using a light source mounted on the rotor. By way of example, using light source 712 that includes a multichannel laser to concurrently output multibeam array 722 toward field of view 120. Process 1700 may also include a step 1706 of vertically scanning a field of view with the light beam as the rotor rotates using a movable light deflector mounted on the rotor in a path of the light beam. For example, scanning field of view 120 using movable light deflector 714 that may be a folding mirror configured to rotate about a substantially vertically oriented scan axis. Process 1700 may also include a step 1708 of receiving, while the rotor rotates and the light deflector moves, reflections of light from the field of view using a light detector mounted on the rotor. For example, the reflections of light may be part of reflected light 206 being detected by light detector 716 and enable determination of the time of flight from object 208.

Process 1700 may also include a step 1710 of transmitting, in a bandwidth of between 1 MHz and 2 GHz, signals associated with the received reflections using a first communications winding on the rotor. By way of example, first communications winding 1202 may transmit the signals at a bit rate of at least 1 gbps. Process 1700 may also include a step 1712 of receiving the transmitted signals from the first communications winding in the bandwidth of between 1 MHz and 2 GHz using a second communications winding located in a stator opposing the rotor. For example, second communications winding 1204 may receive the signals at a bit rate of at least 1 gbps. In some embodiments, the second communications winding may be spaced from the first communications winding by a gap of between 50 microns and 120 microns. By way of example, gap 1104 may be less than 100 microns. In other embodiments, the first communications winding and the second communications winding may overlap each other on opposite sides of the gap.

Consistent with other disclosed embodiments, a contactless rotating LIDAR communications system is provided. Such a contactless rotating LIDAR communications system may include at least one processor configured to execute process 1700 described by executing software (e.g., program codes or instructions) stored in a memory or a non-transitory computer-readable storage medium. As used herein, a non-transitory computer-readable storage medium refers to any type of physical memory on which information or data readable by at least one processor can be stored. Examples include Random Access Memory (RAM), Read-Only Memory (ROM), volatile memory, nonvolatile memory, hard drives, CD ROMs, DVDs, flash drives, disks, any other optical data storage medium, any physical medium with patterns of holes, markers, or other readable elements, a PROM, an EPROM, a FLASH-EPROM or any other flash memory, NVRAM, a cache, a register, any other memory chip or cartridge, and networked versions of the same. The terms “memory” and “computer-readable storage medium” may refer to multiple structures, such as a plurality of memories or computer-readable storage mediums located within an input unit or at a remote location. Additionally, one or more computer-readable storage mediums can be utilized in implementing a computer-implemented method. Accordingly, the term computer-readable storage medium should be understood to include tangible items and exclude carrier waves and transient signals.

In an embodiment, a contactless rotating LIDAR communications system comprises a rotor; a motor configured to rotate the rotor; a light source mounted on the rotor and configured to output a light beam; a movable light deflector mounted on the rotor in a path of the light beam, the light deflector being configured to vertically scan a field of view with the light beam as the rotor rotates; a light detector mounted on the rotor and configured to receive, while the rotor rotates and the light deflector moves, reflections of light from the field of view; a first communications winding on the rotor, the first communications winding being configured to transmit, in a bandwidth of between 1 MHz and 2 GHz, signals associated with the received reflections; a stator opposing the rotor and having a second communications winding thereon for receiving the transmitted signals from the first communications winding in the bandwidth of between 1 MHz and 2 GHz, wherein the second communications winding is spaced from the first communications winding by a gap of between 50 and 120 microns, and wherein the first communications winding and the second communications winding overlap each other on opposite sides of the gap

In some embodiments of the contactless rotating LIDAR communications system, the motor is configured to rotate the rotor at a speed greater than 3000 rpm.

In some embodiments of the contactless rotating LIDAR communications system, the motor is configured to rotate the rotor at a speed greater than 6000 rpm.

In some embodiments of the contactless rotating LIDAR communications system, the light source includes a multichannel laser.

In some embodiments of the contactless rotating LIDAR communications system, the first communications winding is a single loop of wire.

In some embodiments of the contactless rotating LIDAR communications system, the first communications winding is configured to transmit at a bit rate of at least 0.5 gbps.

In some embodiments of the contactless rotating LIDAR communications system, the first communications winding is configured to transmit at a bit rate of at least 1 gbps.

In some embodiments of the contactless rotating LIDAR communications system, the first communications winding has a circumference between 60 mm and 90 mm.

In some embodiments of the contactless rotating LIDAR communications system, the first communications winding is formed of a wire having a width greater than a height thereof.

In some embodiments of the contactless rotating LIDAR communications system, a ratio between the height of the wire and the width of the wire is between 1:3 and 1:20.

In some embodiments of the contactless rotating LIDAR communications system, the second communications winding is spaced from the first communications winding by the gap of between 80 and 110 microns.

In some embodiments of the contactless rotating LIDAR communications system, the first communications winding and the second communications winding have substantially a same diameter.

In some embodiments of the contactless rotating LIDAR communications system, the rotor includes a ring having magnetic permeability greater than 1500, the ring including a circumferential groove therein, and wherein the first communications winding is located in the groove.

In some embodiments of the contactless rotating LIDAR communications system, the first communications winding is embodied in a flexible PCB.

In some embodiments of the contactless rotating LIDAR communications system, the first communications winding is associated with discrete impedance matching components embedded in the flexible PCB.

In some embodiments of the contactless rotating LIDAR communications system, the discrete impedance matching components include at least one of a capacitor, a resistor, or a coil.

In some embodiments of the contactless rotating LIDAR communications system, the rotor includes a first ferrite ring with a first circumferential groove therein, and the stator includes a second ferrite ring with a second circumferential groove therein, and wherein the first communications winding is embedded in the first circumferential groove and the second communications winding is embedded in the second circumferential groove.

In some embodiments of the contactless rotating LIDAR communications system, the first communications winding is spaced from walls of the first circumferential groove and the second communications winding is spaced from walls of the second circumferential groove.

In an embodiment, a contactless rotating LIDAR communications method comprises controlling a motor configured to rotate a rotor; outputting a light beam using a light source mounted on the rotor; vertically scanning a field of view with the light beam as the rotor rotates using a movable light deflector mounted on the rotor in a path of the light beam; receiving, while the rotor rotates and the light deflector moves, reflections of light from the field of view using a light detector mounted on the rotor; transmitting, in a bandwidth of between 1 MHz and 2 GHz, signals associated with the received reflections using a first communications winding on the rotor; and receiving the transmitted signals from the first communications winding in the bandwidth of between 1 MHz and 2 GHz using a second communications winding located in a stator opposing the rotor, wherein the second communications winding is spaced from the first communications winding by a gap of between 50 and 120 microns, and wherein the first communications winding and the second communications winding overlap each other on opposite sides of the gap.

In an embodiment, a contactless rotating LIDAR communications system comprises at least one processor configured to: control a motor configured to rotate a rotor; output a light beam using a light source mounted on the rotor; vertically scanning a field of view with the light beam as the rotor rotates using a movable light deflector mounted on the rotor in a path of the light beam; receive, while the rotor rotates and the light deflector moves, reflections of light from the field of view using a light detector mounted on the rotor; transmit, in a bandwidth of between 1 MHz and 2 GHz, signals associated with the received reflections using a first communications winding on the rotor; receive the transmitted signals from the first communications winding in the bandwidth of between 1 MHz and 2 GHz using a second communications winding located in a stator opposing the rotor; wherein the second communications winding is spaced from the first communications winding by a gap of between 50 and 120 microns, and wherein the first communications winding and the second communications winding overlap each other on opposite sides of the gap.

### Movable Light Deflector for a High-Speed Rotational LIDAR

In a LIDAR rotating at a high rotational speed (e.g., above 3000 revolutions per minute or rpm), the mirror, used to direct the laser beams towards the field of view (FOV) and the reflected light received from the FOV towards a detector, may need to be thin to avoid unacceptable inertial effects that occur during rotation. However, a thin mirror is likely to bend when subjected to high centrifugal forces generated by the high rotational speeds. Bending and/or other deformation of the mirror depends on the mirror geometry (width, height, and/or thickness), the material properties of the mirror, and the position of the mirror relative to a rotation axis. This may become even more important when the mirror is mounted at a peripheral location of the rotor in relation to the rotation axis of the rotor. It may also be more important for systems directing multiple beams towards a FOV, as the area required to deflect multiple beams simultaneously is increased. Additionally, in cases when the mirror is on the receive path of reflections, the size of the mirror is essentially the size of the system aperture for light collection, and determines the system range and other system parameters. If the size of the mirror is increased, the ratio of mirror area to thickness may also increase creating a geometry more sensitive to deformation. As such, multibeam LIDAR systems using a single scanning mirror may be particularly susceptible to this problem. Bending or deformation of the mirror may cause laser light generated in the LIDAR to be directed to a portion of the FOV different from an intended target FOV position. Similarly, a bent or deformed mirror may direct reflected light beam received from the FOV to impinge on a light detector at a location other than an intended target position. Both of these conditions may lead to an erroneous detection of a position and/or distance of an object in the FOV.

The disclosed system may include a mirror attached to a mirror holder. The mirror holder may be mounted at a peripheral location of the rotor. For a given rotational speed of the LIDAR, it may be possible to determine an amount of deformation of the mirror. In the disclosed system, the mirror holder, and connection points of the mirror holder with the mirror may be selected to account for and/or minimize any deflections or deformations of the mirror caused by the centrifugal forces exerted on the mirror. For example, as will be described below in detail, the number of supports in the mirror holder, the distance between the supports, a number of connection points between the supports and the mirror, and/or the distances between the connection points may be selected to compensate for and/or minimize deflections or deformations of the mirror caused by the centrifugal forces exerted on the mirror.

Some disclosed embodiments may involve a rotatable LIDAR system. A rotatable LIDAR system may be understood as described and exemplified elsewhere in this disclosure. A rotatable LIDAR system may refer to a LIDAR system capable of being rotated about a rotational axis. For example, as discussed elsewhere in this disclosure, a rotatable LIDAR system may be rotatable over a 360-degree angle to allow the LIDAR system to scan a 360 degree, 3-dimensional (3D) field of view of the environment in which the LIDAR system may be located. By way of example, FIG. 1A illustrates a rotatable LIDAR system 100 that may be configured to be rotatable about a rotational axis 119. In one exemplary embodiment as illustrated in FIG. 1A, LIDAR system 100 may be mounted on vehicle 110 such that FOV 120 extends over a full 360 degrees relative to vehicle 100. It is contemplated, however, that LIDAR system may be mounted to other structures that may be stationary or may be attached to a vehicle that may include automobiles, trains, ships, airplanes, a movable gantry, or any other type of movable structure.

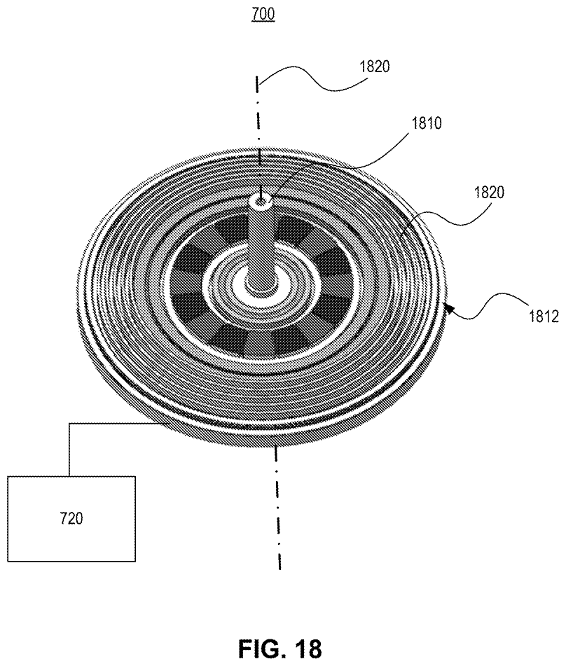

In some disclosed embodiments, the rotatable LIDAR system includes a rotor having an axis of rotation. A rotor may be understood as disclosed and exemplified elsewhere in this disclosure. An axis of rotation may refer to a generally straight line around which points of a body move in circles. An axis of rotation passing through the rotating body may include a straight line through fixed points of a rotating rigid body around which all other points of the body move in circles. An axis of rotation of a rotor may refer to a straight line that may be generally perpendicular to the rotor and may include fixed points in the rotor about which the remainder of the rotor may move in a circular fashion. By way of example, as illustrated in FIG. 1A, rotatable LIDAR system 100 may rotate about an axis of rotation 119. By way of another example, FIG. 18 illustrates rotor 700 having a shaft 1810 and rotor base 1812. Rotor 700, including shaft 1810 and rotor base 1812 may rotate about a rotational axis 1820.

In some disclosed embodiments, the rotatable LIDAR system includes a motor configured to rotate the rotor about the axis of rotation. A motor configured to rotate the rotor may be understood as disclosed and exemplified elsewhere in this disclosure. By way of example, as illustrated in FIGS. 7 and 18, motor 720 may be configured to rotate rotor 700 about axis of rotation 1820. In some disclosed embodiments, the rotor is configured to rotate at a rotational speed ranging between 3000 rpm to 7500 rpm. It is to be understood that the rotor may be configured to rotate at many different speeds, for example, greater than 3000 rpm, greater than 4000 rpm, greater than 5000 rpm, greater than 6000 rpm, greater than 7000 rpm, greater than 8000 rpm, greater than 9000 rpm, greater than 10,000 rpm, or at any other higher or lower rotational speed. As discussed elsewhere in this disclosure, increasing a rotation speed of the rotor, for example, to between 3000 rpm to 7500 rpm may help increase the data capture rate of the LIDAR system, enabling higher resolution measurements and more accurate scene perception.

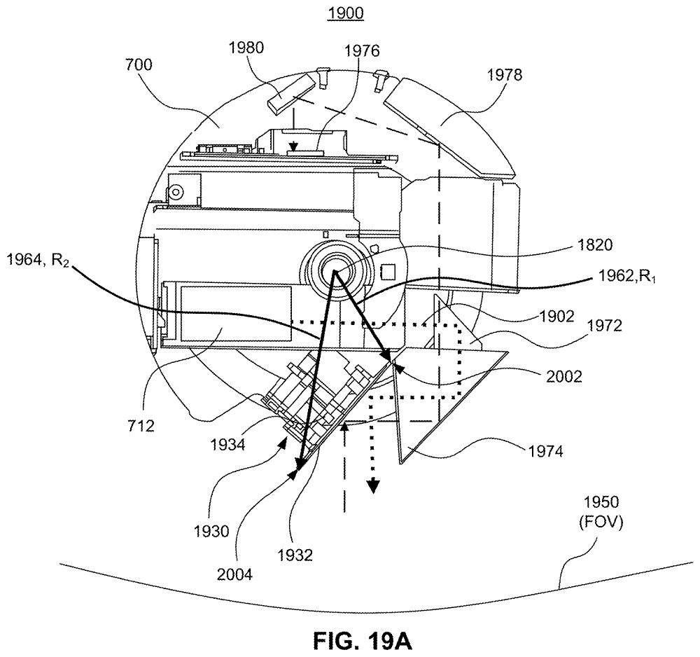

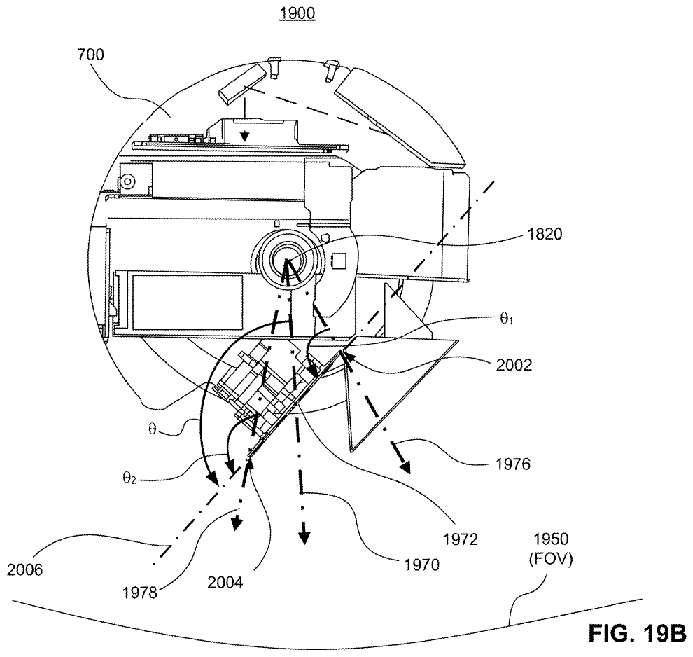

In some disclosed embodiments, the LIDAR system includes a light source mounted on the rotor and configured to emit a light beam towards a field of view. A field of view, and a light source configured to emit a light beam towards a field of view may be understood as disclosed and exemplified elsewhere in this disclosure. In some disclosed embodiments, the LIDAR system includes a movable light deflector mounted on the rotor. A movable light deflector may be understood as disclosed and exemplified elsewhere in this disclosure. By way of example, FIG. 19A illustrates a top plan view of an exemplary LIDAR system 1900. As illustrated in FIG. 19A, LIDAR system 1900 may include a rotor 700 and a light source 712 mounted on rotor 700. Light source 712 may be configured to emit light beam 1902 toward a field of view 1950, which may be similar to FOV 120 discussed elsewhere in this disclosure. Although illustrated as an arc, the FOV 1950 may span 360 degrees surrounding the axis of rotation 1820 of the rotor of the LIDAR system.

In some embodiments, the movable light deflector is configured to direct the emitted light beam from the light source towards the field of view. Directing the emitted light beam may refer to causing the emitted light beam to travel in a particular direction. The movable light deflector is configured to reflect a light beam incident on the movable light deflector. The movable light deflector may be positioned such that the reflected light beam may be caused to travel towards the FOV. By way of example, FIG. 19A illustrates a top plan view of LIDAR system 1900. As illustrated in FIG. 19A, light source 712 emits a light beam that is directed by one or more optical elements such as prisms 1972 and 1974 towards movable light deflector 1930. Mirror 1932 of movable light deflector 1930 may be positioned such that light beam 1902 may be caused to travel towards FOV 1950.

Some disclosed embodiments involve a light detector mounted on the rotor and configured to receive a reflected light beam reflected from an object in the field of view. A light detector may be similar to a sensing unit or sensor configured to detect reflections from objects in the field of view as disclosed and exemplified elsewhere in this disclosure. For example, the disclosed light detector may receive reflected light received by the LIDAR system from the FOV. By way of example, as illustrated in FIG. 19A, LIDAR system 1900 may include light detector 1976 that may receive reflected light beam 1904 received by LIDAR system 1900 from FOV 1950.

In some disclosed embodiments, the LIDAR system includes at least one optical element disposed between the movable light deflector and the light detector, wherein the at least one optical element is configured to direct the reflected light beam from the movable light deflector to the light detector. An optical element may be understood as described and exemplified elsewhere in this disclosure. In some disclosed embodiments, the at least one optical element includes at least one of a prism or a mirror. For example, the optical element may include one or more of a mirror, a prism, a lens, a polarizer, a diffuser, a diffraction grating, a beam-splitter, an optical window, a filter, a waveplate, a reflector, a crystal, or any other component configured to alter a beam of light (e.g., alter an angle or direction of the beam, alter a frequency of the beam, split the beam, polarize the beam, absorb the beam, alter an amplitude of the beam). By way of example, as illustrated in FIG. 19A, the one or more optical elements may include prisms 1972, 1974, and/or mirrors 1978, 1980. As also illustrated in FIG. 19A, reflected light beam 1904 may be received by LIDAR system 1900 from FOV 1950. Light beam 1904 may be reflected by movable light deflector 1930 towards prism 1974, which may redirect beam 1904 through prism 1972 towards mirror 1978. Mirror 1978 may in turn reflect light beam 1904 towards mirror 1980, which may reflect light beam 1904 so that light beam 1904 impinges on detector 1976. Although several prisms 1972, 1974, and mirrors 1978, 1980 have been illustrated in FIG. 19A, it is to be understood that LIDAR system 1900 may have more or less number of prisms and/or mirrors disposed between movable light deflector 1930 and detector 1976.

In some disclosed embodiments, the movable light deflector includes a mirror support attached to the rotor. A support may refer to a structure that holds up or serves as a foundation for a component. A mirror support may refer to a structure that holds up a mirror. For example, a mirror support may include a column, a truss, a pedestal, a frame, a girder, a post, any combination thereof, or any other structure that may hold up the mirror. At least a portion of the structure (e.g., mirror support) may be attached to the rotor via fasteners, welding, brazing, using adhesives, or using any other means of connecting or attaching a structure to another structure such as a rotor.

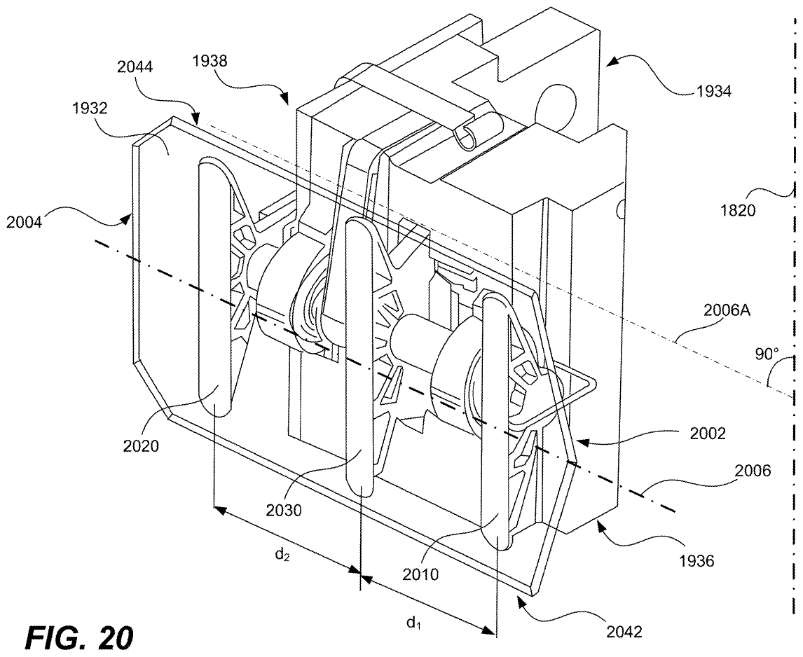

In some disclosed embodiments, the movable light deflector includes a mirror attached to the mirror support. A mirror may refer to a component capable of deflecting or changing a direction of a light beam that may be incident on the mirror. In particular, a mirror may refer to a component that reverses the direction of a light beam to an equal yet opposite angle from which the light beam is incident on the mirror. A mirror may have a thickness between 400-800 microns. The area of the reflective surface of a mirror may be between 700-900 mm², or between 800-850 mm² to meet an optical requirement of the LIDAR system. In some embodiments, the mirror may have chamfered corners. The chamfered corners may be asymmetrical in the longitudinal axis of the mirror. A mirror may be made of one of a variety of materials such as glass, silicon (coated or uncoated), or polished metal such as silver or aluminum. The silicon may be coated with a dielectric coating or a gold coating. In some exemplary embodiments, a mirror may include a transparent material (e.g., glass or thin polymeric material) with a reflective coating of silver or aluminum applied to one surface of the transparent material. In the disclosed embodiments, a portion of the mirror support, different from the portion attached to the rotor, may be attached to the mirror via fasteners, welding, brazing, adhesives, or using any other means of connecting or attaching a structure (e.g., mirror support) to another structure such as a mirror. By way of example, FIG. 19A illustrates movable light deflector 1930 having mirror 1932 attached to mirror support 1934. FIG. 20 illustrates another view of exemplary movable light deflector 1930. As illustrated in FIG. 20, movable light deflector 1930 may include mirror 1932. Mirror 1932 has been illustrated as being transparent in FIG. 20 to show some of the other structural elements located behind FIG. 20. It is to be understood that in the disclosed embodiments, mirror 1932 is capable of reflecting light incident on mirror 1932. Movable light deflector 1930 may also include mirror support 1934. Mirror support 1934 may be attached to rotor 700 (see e.g., FIGS. 18, 19A) at a base or lower end 1936 of mirror support 1934. Mirror 1932 may be attached to mirror support 1934 at upper end 1938 of mirror support 1934.

In some disclosed embodiments, the mirror extends from a first end to a second end along a deflector longitudinal axis. As discussed above, the mirror in disclosed embodiments may include a component capable of deflecting or changing a direction of a light beam that may be incident on the component. In some embodiments, the mirror may extend in a lengthwise direction from one end (e.g., first end) of the mirror to an opposite end (e.g., second end). In some embodiments, the mirror may be symmetrically arranged about a longitudinal axis or virtual line extending along the lengthwise direction. By way of example, FIG. 20 illustrates mirror 1932 extending from first end 2002 to second end 2004 along a deflector longitudinal axis 2006.

In some disclosed embodiments, the deflector longitudinal axis is perpendicular to the axis of rotation of the rotor. The deflector longitudinal axis may be disposed at an angle relative to the axis of rotation of the rotor to which the movable light deflector is attached. In some exemplary embodiments, the deflector longitudinal axis may be disposed at an angle generally 90° (e.g., perpendicular) relative to the axis of rotation of the rotor. It is to be understood that terms like generally and about as used in this disclosure should be interpreted as encompassing typical design, manufacturing, and/or machining tolerances. Thus, for example, generally perpendicular may encompass angles in the range of 90°±5°. By way of example, FIG. 20 illustrates an axis of rotation 1820 of rotor 700 and deflector longitudinal axis 2006. As illustrated in FIG. 20, a virtual projection 2006A of deflector longitudinal axis 2006 is positioned to intersect with axis of rotation 1820 of rotor 700. As further illustrated in FIG. 20, projection 2006A and, therefore, deflector longitudinal axis 2006 may be disposed generally perpendicular to longitudinal axis 2006.

In some disclosed embodiments, the first end and the second end are positioned at different radial distances relative to the axis of rotation of the rotor. A radial distance may refer to a distance of a point located on the mirror relative to the axis of rotation of the rotor as measured in a plane perpendicular to the axis of rotation. The first end of the mirror may be positioned at a first radial distance from the axis of rotation and the second end of the mirror may be positioned at a second radial distance from the axis of rotation. In some exemplary embodiments, the first and second distance may be unequal or different from each other. By way of example, FIG. 19A illustrates axis of rotation 1820 of rotor 700. Axis of rotation 1820 is visible as a point on FIG. 19A, because axis of rotation 1820 is disposed perpendicular to the plane of rotor 700 and goes into the page or into the plane of FIG. 19A. As illustrated in FIG. 19A, first end 2002 of mirror 1932 may be positioned at first radial distance 1962 (e.g., “R₁”) relative to axis of rotation 1820 of rotor 700. As also illustrated in FIG. 19A, second end 2004 of mirror 1932 may be positioned at second radial distance 1964 (e.g., “R₂”) relative to axis of rotation 1820 of rotor 700. As also illustrated in FIG. 19A, radial distance R₁ is different from radial distance R₂. For example, radial distance R₁ is smaller than radial distance R₂, although in some embodiments, radial distance R₁ may be larger than radial distance R₂.

In some disclosed embodiments, the deflector longitudinal axis is slanted relative to a radial direction extending through a center of the movable light deflector. Slanted may refer to a condition of being inclined or angled at an angle different from perpendicular (e.g., different from 90°). Thus, for example, being slanted may encompass angles other than 90°±5°. As discussed above, first and second ends of the mirror may be disposed at different radial distances relative to the axis of rotation of the rotor to which the mirror may be attached via the mirror support. As a result, the deflector longitudinal axis may not be perpendicular to a radial axis extending from the mirror rotational axis through a geometric center of the mirror. By way of example, FIG. 19B illustrates top plan view of rotor 700. As illustrated in FIG. 19B, axis of rotation 1820 may be disposed perpendicular to the plane of rotor 700 and may go into the page or into the plane of FIG. 19B. Radial axis 1970 may extend radially from axis of rotation 1820 through geometric center 1972 (e.g., center equidistant from first and second ends 2002, 2004 along deflector longitudinal axis 2006). As illustrated in FIG. 19B, deflector longitudinal axis 2006 may be disposed at an angle A relative to radial axis 1970. Angle A may be different from 90°±5° so that deflector longitudinal axis 2006 may be slanted relative to radial axis 1970.

In some disclosed embodiments, the deflector longitudinal axis is inclined at an obtuse angle relative to a radial direction extending through the movable light deflector between the first end and the second end. As discussed above, angle A between deflector longitudinal axis 2006 and radial axis 1970 passing through center 1972 of mirror 1932 (see e.g., FIG. 19A) may be different from 90°±5°. In some embodiments, angle A may be obtuse (e.g., >90°+5°). Furthermore, radial axes 1976 and 1978 may pass through first and second ends 2002 and 2004, respectively, of mirror 1932 (see e.g., FIG. 19A). Deflector longitudinal axis 2006 may be disposed at an angle A1 relative to radial axis 1976 and at an angle A2 relative to radial axis 1978. In some embodiments, each of angles A, A1, A2, and any angles between A1 and A2 between deflector longitudinal axis 2006 and a radial axis extending through mirror 1932 (see e.g., FIG. 19A) between first end 2004 and second end 2006 may all be obtuse (e.g., >90°).

In some disclosed embodiments, the mirror support includes a plurality of support arms attached to the mirror, the support arms being spaced apart from each other. A support arm may refer to a structure that holds up a structure like the mirror. For example, a support arm may include a column, a truss, a frame, a girder, a post, any combination thereof, or any other elongated structural member that may hold up the mirror. In some embodiments, the mirror support may include more than one support arm, each of which may be attached to the mirror via fasteners, welding, brazing, using adhesives, or using any other means of connecting or attaching a structure such as the support arm to another structure such as a mirror. Being spaced apart may refer to being positioned such that there is a distance between two items. Thus, for example, support arms spaced apart from each other may be separated from each other by a predetermined distance. By way of example, FIG. 20 illustrates a perspective view of movable light deflector 1900 that includes a mirror support 1934 that has a plurality of support arms 2010, 2020, and 2030. Although the exemplary embodiment of FIG. 20 illustrates three support arms, mirror support 1934 may include any number of support arms (e.g., 1, 2, 3, 4, or more). As also illustrated in FIG. 20, the support arms are spaced apart from each other. For example, support arm 2030 is positioned at a distance “d₁” relative to support arm 2010 and support arm 2020 is positioned at a distance “d₂” relative to support arm 2030, where d₁ and d₂ are distances measured along deflector longitudinal axis 2006.

In some disclosed embodiments, the plurality of support arms includes a central support arm, a first support arm spaced apart from the central support arm by a first distance, and a second support arm spaced apart from the central support arm by a second distance. As discussed above, in some embodiments, the mirror support may include three support arms, one of which may be a central support arm that may be located between the other two support arms. Furthermore, each of the other two support arms may be spaced apart (e.g., located at a predetermined distance) from the central support arm. By way of example, as illustrated in FIG. 20, mirror support 1934 may include central support arm 2030, first support arm 2010 and second support arm 2020. First support arm 2010 may be spaced apart from central support arm 2030 by first distance d₁. Similarly, second support arm 2020 may be spaced apart from central support arm 2030 by second distance d₂.

In some disclosed embodiments, the first distance equals the second distance. In some disclosed embodiments, the first distance is different from the second distance. As discussed above, in some embodiments, the mirror support may include three support arms, one of which may be a central support arm that may be located between the other two support arms. Furthermore, each of the other two support arms may be spaced apart (e.g., located at a predetermined distance) from the central support arm. The distance between adjacent pairs of support arms may be equal or unequal. For example, the distances between adjacent pairs of support arms may be selected such that the mirror may be adequately supported to minimize deformations of the mirror when subjected to centrifugal forces generated due to rotation of the mirror about a rotational axis. In particular, the distances between adjacent pairs of support arms may be selected such that deformations of the mirror between a first pair of support arms may be offset by a deformation of the mirror between the second pair of support arms, thus minimizing a total amount of deformation of the mirror. By way of example, as illustrated in FIG. 20, mirror support 1934 may include central support arm 2030, first support arm 2010 and second support arm 2020. In some embodiments, distance d₁ between central support arm 2030 and first support arm 2010 may be about equal to distance d₂ between central support arm 2030 and second support arm 2020. In other embodiments, distance d₁ between central support arm 2030 and first support arm 2010 may be different from (e.g., greater than or less than) distance d₂ between central support arm 2030 and second support arm 2020. For example, in a configuration where a radial distance 1964 or R₂ of second end 2004 of mirror 1934 is greater than a radial distance 1962 or R₁ of first end 2002 of mirror 1934, a magnitude of centrifugal force on second end 2004 may be larger than a magnitude of centrifugal force on first end 2002. Thus, second end 2004 may tend to deform more than first end 2002. In such a configuration, decreasing distance d₂ relative to distance d₁ may help reduce an amount of deformation of second end 2004 relative to the deformation of mirror 1932 adjacent to central support arm 2030, as compared to the deformation of first end 2002 relative to the deformation of mirror 1932 adjacent to central support arm 2030. In other embodiments, a thickness and/or curvature of mirror 1934 may vary between first and second ends 2002 and 2004. In such a configuration it may be sufficient to maintain equal distances d₁ and d₂ or to maintain distance d₁>d₂ to ensure deformation of the mirror at second end 2004 is less than a predetermined threshold amount of deformation.

In some disclosed embodiments, the mirror extends from a proximal end adjacent to the rotor to a distal end in a direction transverse to a plane of the rotor. As discussed above, the disclosed mirror may extend from a first end to a second end in a lengthwise direction along the deflector longitudinal axis. The mirror may also have a width, such that the mirror may extend from a location adjacent to an upper surface of the rotor in a transverse direction (e.g., in a direction perpendicular or angled relative to the upper surface of the rotor). By way of example, as illustrated in FIG. 20, mirror 1932 may extend from proximal end 2042, disposed adjacent to an upper surface 1822 (see e.g., FIG. 18) of rotor 700 (see e.g., FIG. 18) to distal end 2044 in a direction transverse to a plane (e.g., upper surface 1822) of rotor 700. In some embodiments, mirror 1932 may be disposed generally perpendicular to upper surface 1822 of rotor 700. In some embodiments, mirror 1932 may be slanted at an angle (e.g., different from perpendicular) to upper surface 1822 of rotor 700. As also illustrated in FIG. 20, in some embodiments, mirror 1932 may have a polygonal shape. It is contemplated, however, that mirror 1932 may have a rectangular, square, triangular, elliptical, circular, or any other shape.

In some disclosed embodiments, each of the plurality of support arms contacts the mirror at a single corresponding location. As discussed above, each of the support arms may be attached to the mirror to support or hold up the mirror when assembled on a rotor of the rotatable LIDAR. Each of the support arms may be in contact with the mirror at a single location at which the support arm may be attached to the mirror. In some disclosed embodiments, each of the first support arm, the central support arm, and the second support arm contacts the mirror at a plurality of locations. Although support arms in contact with a single location have been described above, it may be beneficial to have support arms that are in contact with and attached to the mirror at more than one location. In some embodiments, one or more support arms may contact and be attached to the mirror at only one location, while one or more other support arms may contact and be attached to the mirror at more than one location. In some disclosed embodiments, each of the first support arm, the central support arm, and the second support arm contacts the mirror at a pair of locations. For example, each support arm may contact the mirror and may be attached to the mirror at two locations spaced apart from each other. Doing so may help distributed the weight of the mirror on each support arm. Furthermore, contacting and attaching each support arm to more than one location on the mirror may allow each support arm to provide additional stiffness to the mirror that may help reduce deformation of the mirror when subjected to centrifugal forces.

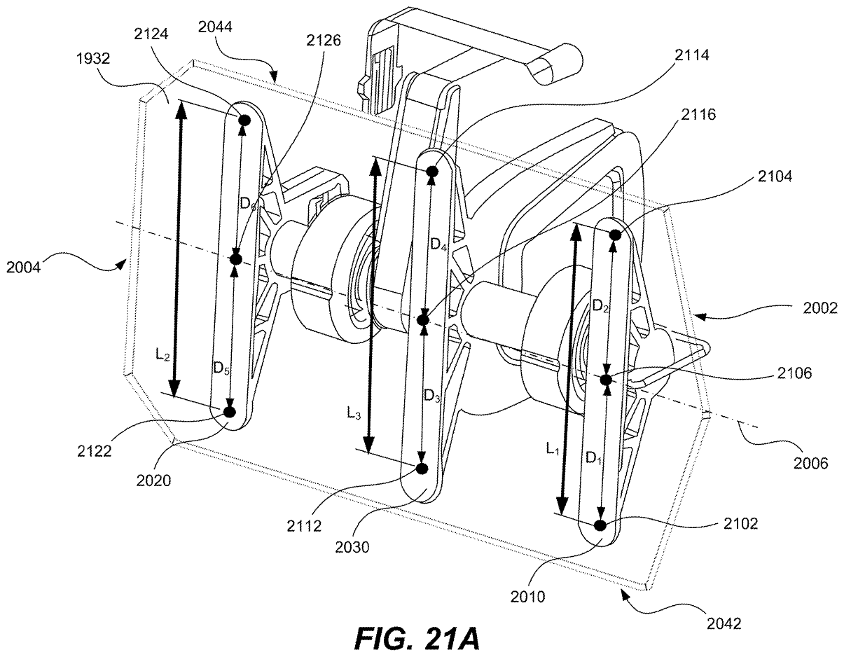

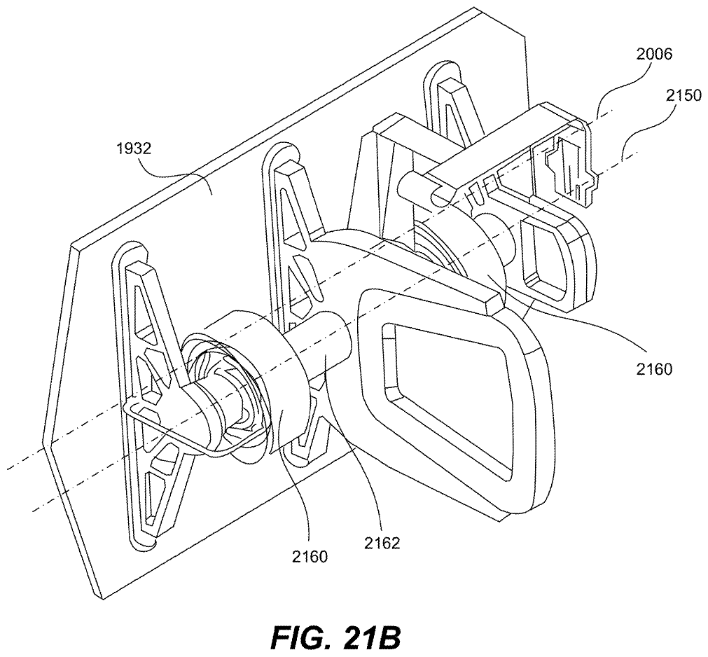

In some disclosed embodiments, at least one of the plurality of support arms contacts the mirror at three locations including a first location adjacent to the proximal end; a second location adjacent to the distal end; and a third location between the first location and the second location. As discussed above, one or more support arms may contact the mirror and be attached to the mirror at a plurality of locations, for example, three locations. One of the three locations may be disposed adjacent the proximal end of the mirror, another may be disposed adjacent a distal end of the mirror, and a third one may be disposed between the other two locations. As discussed above, contacting and attaching to the mirror at a plurality of locations may allow the one or more support arms to impart additional stiffness to the mirror that may help reduce deformation of the mirror when subjected to centrifugal forces. By way of example, FIG. 21A illustrates a mirror supported by a plurality of support arms contacting the mirror at a plurality of locations. As illustrated in FIG. 21A, movable light deflector 1930 may include mirror 1932. Mirror 1932 has been illustrated as being transparent in FIG. 21A merely to show some of the other structural elements located behind FIG. 21A. It is to be understood that in the disclosed embodiments, mirror 1932 is capable of reflecting light incident on mirror 1932. For example, as illustrated in FIG. 21A, mirror support 1934 may include three support arms 2010, 2020, and 2030. First support arm 2010 may contact the mirror and be attached to the mirror at first location 2102 disposed adjacent to proximal end 2042 of mirror 1932. First support arm 2010 may also contact the mirror and be attached to the mirror at second location 2104 disposed adjacent to distal end 2044 of mirror 1932. Further, first support arm 2010 may contact the mirror and be attached to the mirror at third location 2106 disposed in between first location 2102 and second location 2106. In some embodiments as illustrated in FIG. 21A, third location 2106 may coincide with deflector longitudinal axis 2006, whereas in other embodiments, third location 2106 may be spaced apart from longitudinal axis 2006 along a width of mirror 1932.

As further illustrated in FIG. 21A, central support arm 2030 may contact the mirror and be attached to the mirror at fourth location 2112 disposed adjacent to proximal end 2042 of mirror 1932. Central support arm 2030 may also contact the mirror and be attached to the mirror at fifth location 2114 disposed adjacent to distal end 2044 of mirror 1932. Further, central support arm 2030 may contact the mirror and be attached to the mirror at sixth location 2116 disposed in between first location 2112 and second location 2114.

Similarly, second support arm 2020 may contact the mirror and be attached to the mirror at seventh location 2122 disposed adjacent to proximal end 2042 of mirror 1932. Second support arm 2020 may also contact the mirror and be attached to the mirror at eighth location 2124 disposed adjacent to distal end 2044 of mirror 1932. Further, second support arm 2020 may contact the mirror and be attached to the mirror at ninth location 2126 disposed in between first location 2122 and second location 2124. Although each of support arms 2010, 2020, and 2030 has been illustrated in FIG. 21A as contacting mirror 1932 at three locations, in some embodiments, one or more of support arms 2010, 2020, and 2030 may contact mirror 1932 at less than or more than three locations.

In some disclosed embodiments, a distance between a pair of locations for the first support arm is different from a distance between the pair of locations for at least one of the central support arm and the second support arm. As discussed above, some or all support arms of a mirror support may contact the mirror at more than one location. The spacing or distance between the locations at which one of the support arms contacts the mirror may be equal or unequal compared to the spacing or distance between the locations at which one of the other support arms contacts the mirror. By selecting the distances between the contact locations for the different arms, it may be possible to adjust an amount of stiffness imparted to different portions of the mirror, which in turn may help to minimize deformations of the different portions of the mirror when subject to centrifugal forces. By way of example, as illustrated in FIG. 21A, a distance between first location 2102 and third location 2106 at which first support arm 2010 contacts mirror 1932 may be “D₁,” whereas the distance between second location 2104 and third location 2106 at which first support arm 2010 contacts mirror 1932 may be “D₂.” Likewise, a distance between fourth location 2112 and sixth location 2116 at which central support arm 2030 contacts mirror 1932 may be “D₃,” whereas the distance between fifth location 2113 and sixth location 2116 at which central support arm 2030 contacts mirror 1932 may be “D₄.” Similarly, a distance between seventh location 2122 and ninth location 2126 at which second support arm 2020 contacts mirror 1932 may be “D₅,” whereas the distance between eighth location 2124 and ninth location 2126 at which third support arm 2020 contacts mirror 1932 may be “D₆.” Some or all distances D₁, D₂, D₃, D₄, D₅, and D₆ may be equal or unequal.

In some disclosed embodiments, the third location is equidistant from the first location and the second location. For example, distance D₁ between first location 2102 and third location 2106 may be equal to distance D₂ between second location 2104 and third location 2106 such that third location 2106 may be equidistant from the first location 2102 and second location 2104. In some disclosed embodiments, the third location is nearer to one of the first location and the second location. For example, in some embodiments, distance D₁ may be smaller than distance D₂ such that third location 2106 may be nearer to first location 2102 as compared to second location 2104. In other exemplary embodiments, distance D₁ may be greater than distance D₂ such that third location 2106 may be nearer to second location 2104 as compared to first location 2102.

In some disclosed embodiments, a distance between the pair of locations for the first support arm is different from a distance between the pair of locations for at least one of the central support arm and the second support arm. As discussed above, some or all distances D₁, D₂, D₃, D₄, D₅, and D₆ between contact locations of support arms 2010, 2020, or 2030 with mirror 1932 may be equal or unequal. For example, in some embodiments, distance D₁ may be different from distance D₃. Thus, for example, distance D₁ between pair of locations such as first location 2102 and third location 2106 for first support arm 2010 may be different from distance D₂ between pair of locations such as fourth location 2112 and sixth location 2116 for central support arm 2020. As another example, distance D₂ may be different from distance D₆. Thus, for example, distance D₂ between pair of locations such as second location 2104 and third location 2106 for first support arm 2010 may be different from distance D₆ between pair of locations such as eighth location 2124 and ninth location 2126 for second support arm 2020.

In some disclosed embodiments, a length of the central support arm is greater than a length of the first support arm or the second support arm. A length of each support arm may be determined in a transverse or width direction relative to the deflector longitudinal axis or relative to an upper surface of the rotor. For example, as illustrated in FIG. 21A, lengths of each support arm 2010, 2020, and 2030 may be determined in a direction transverse to deflector longitudinal axis 2006 and along a width direction of mirror 1932. For example, first support arm 2010 may have a length “L₁,” second support arm 2020 may have a length “L₂,” and central support arm 2030 may have a length “L₃.” Some or all of lengths L₁, L₂, and L₃ may be equal or unequal. In some embodiments, length L₃ of central support arm 2020 may be larger than lengths L₁ and L₂ of first and second support arms 2010 and 2030, respectively.

In some disclosed embodiments, the mirror is rotatable about an axis parallel to the deflector longitudinal axis. As discussed above, the mirror may be mounted to a rotor and rotatable about an axis of rotation of the rotor. This may allow the mirror to scan a 360° field of view by directing light towards the FOV and receiving reflected light from the FOV. However, a vertical extent (in a direction parallel to the axis of rotation) scannable by a fixed mirror may be determined by a width of the mirror and a width of the illumination beam reflected by the mirror. As also discussed above, the mirror may have a deflector longitudinal axis extending along a length of the mirror. Rotating the mirror about an axis parallel to the deflector longitudinal axis may allow the mirror to scan an extent of the FOV that may be larger than that determined solely by the width of the mirror. Thus, in some embodiments, the mirror may be rotatable about an axis that may be perpendicular to the axis of rotation. By way of example, as illustrated in FIG. 21B, mirror 1932 may be rotatable about transverse rotational axis 2150 that may be parallel to deflector longitudinal axis 2006, and like deflector longitudinal axis 2006, transverse rotational axis 2150 of mirror 1932 may also be disposed generally perpendicular to axis of rotation 1820 (see e.g., FIGS. 7, 20) of rotor 700 (see e.g., FIG. 7).

In some embodiments, the mirror includes an actuator configured to rotate the mirror about the axis parallel to the mirror axis. An actuator may refer to a device that makes something move by converting energy (e.g., electrical energy) into a mechanical force. An actuator requires a control device and a source of energy. The source of energy may be mechanical (e.g., by a spring, pneumatic, hydraulic) or electrical (e.g., by a motor, electromagnetism). An actuator configured to rotate the mirror may refer to a device that causes the mirror to rotate by converting energy into a torque or rotational force exerted on the mirror. In some embodiments, the actuator may include an electric motor. In other embodiments, the actuator may include a hydraulic or pneumatic actuator. By way of example, as illustrated in FIG. 21B, mirror 1932 may include one or more actuators 2160 that may be configured to rotate shaft 2162 attached to first, second, and central supports 2010, 2030, and 2020, respectively. Rotation of shaft 2162 may in turn cause mirror 1932 to be rotated about transverse rotational axis 2150 that is parallel to deflector longitudinal axis 2006.

In an embodiment, a rotatable LIDAR system comprises a rotor having an axis of rotation; a motor configured to rotate the rotor about the axis of rotation; a light source mounted on the rotor and configured to emit a light beam towards a field of view; a movable light deflector mounted on the rotor and having a deflector longitudinal axis perpendicular to the axis of rotation of the rotor, the deflector longitudinal axis being slanted relative to a radial direction extending through a center of the movable light deflector, the movable light deflector being configured to direct the emitted light beam from the light source towards the field of view; and a light detector mounted on the rotor and configured to receive a reflected light beam reflected from an object in the field of view.

In some embodiments, the LIDAR system further comprises at least one optical element disposed between the movable light deflector and the light detector, wherein the at least one optical element is configured to direct the reflected light beam from the movable light deflector to the light detector.

In some embodiments of the LIDAR system, the at least one optical element includes at least one of a prism or a mirror.

In some embodiments of the LIDAR system, the movable light deflector includes a mirror support attached to the rotor; and a mirror attached to the mirror support.

In some embodiments of the LIDAR system, the mirror extends from a first end to a second end along the deflector longitudinal axis, and the first end and the second end are positioned at different radial distances relative to the axis of rotation of the rotor.

In some embodiments of the LIDAR system, the deflector longitudinal axis is inclined at an obtuse angle relative to a radial direction extending through the movable light deflector between the first end and the second end.

In some embodiments of the LIDAR system, the mirror is rotatable about an axis parallel to the deflector longitudinal axis.

In some embodiments of the LIDAR system, the mirror includes an actuator configured to rotate the mirror about the axis parallel to the mirror axis.

In some embodiments of the LIDAR system, the mirror support includes a plurality of support arms attached to the mirror, the support arms being spaced apart from each other.

In some embodiments of the LIDAR system, each of the plurality of support arms contacts the mirror at a single corresponding location.

In some embodiments of the LIDAR system, the plurality of support arms includes a central support arm; a first support arm spaced apart from the central support arm by a first distance; and a second support arm spaced apart from the central support arm by a second distance.

In some embodiments of the LIDAR system, the first distance equals the second distance.

In some embodiments of the LIDAR system, the first distance is different from the second distance.

In some embodiments of the LIDAR system, each of the first support arm, the central support arm, and the second support arm contacts the mirror at a plurality of locations.

In some embodiments of the LIDAR system, each of the first support arm, the central support arm, and the second support arm contacts the mirror at a pair of locations, and a distance between the pair of locations for the first support arm is different from a distance between the pair of locations for at least one of the central support arm and the second support arm.

In some embodiments of the LIDAR system, a length of the central support arm is greater than a length of the first support arm or the second support arm.

In some embodiments of the LIDAR system, the mirror extends from a proximal end adjacent to the rotor to a distal end in a direction transverse to a plane of the rotor, and at least one of the plurality of support arms contacts the mirror at three locations including: a first location adjacent to the proximal end; a second location adjacent to the distal end; and a third location between the first location and the second location.

In some embodiments of the LIDAR system, the third location is equidistant from the first location and the second location.

In some embodiments of the LIDAR system, the third location is nearer to one of the first location and the second location.

In some embodiments of the LIDAR system, the rotor is configured to rotate at a rotational speed ranging between 3000 rpm to 7500 rpm.

### Peripheral Optical Pathway for a Rotatable LIDAR

In LIDAR systems, it is often desirable to use a system with a small form factor, which reduces weight and size, making the system easier to maneuver, install, and attach to smaller objects (e.g., vehicles). This also reduces the overall amount of resources needed in the formation of the LIDAR system itself. Reducing the size of a LIDAR system, however, can interfere with a reception pathway by reducing its length and therefore the range, accuracy, and usefulness of the system itself. Longer reception pathways (e.g., focal lengths) are needed to collect sufficient light for longer ranges, but are difficult to implement in LIDAR systems with small form factors. Embodiments described herein involve solutions for this problem, such as by folding optical paths in rotating LIDAR systems.

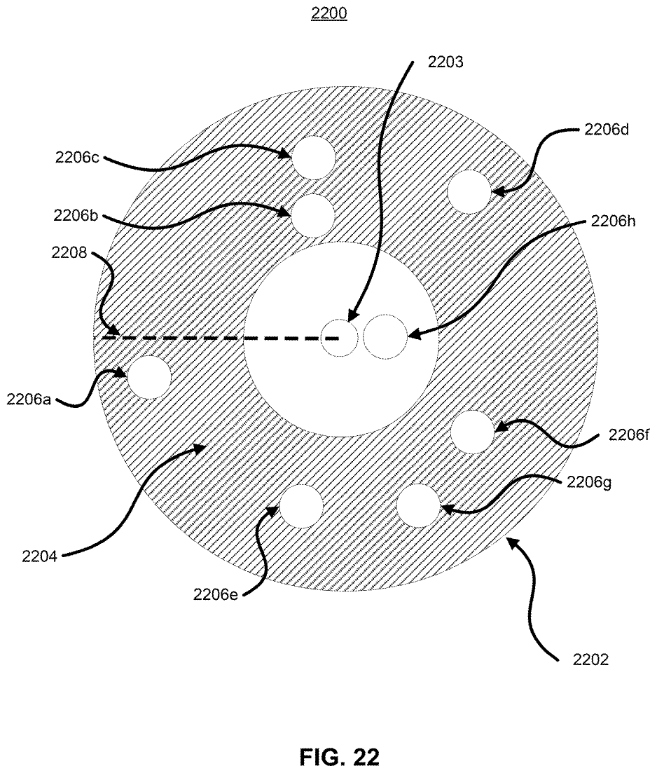

FIG. 22 is a diagrammatic illustration of an arrangement of mounting locations relative to a rotor, consistent with some embodiments of the present disclosure. A rotatable LIDAR system 2200 may include a rotor, such as rotor 2202 (represented by the entire area of the larger circle in FIG. 22). Rotor 2202 may have a central rotational axis (e.g., oriented through the page of FIG. 22) and a plurality of optical component mounting locations about (e.g., partially within, fully within, adjacent to) a peripheral region 2204 (the shaded area depicted in FIG. 22) of the rotor 2202, such as mounting locations 2206a, 2206b, 2206c, 2206d, 2206e, 2206f, and 2206g (collectively referred to as mounting locations 2206). While eight mounting locations are depicted in FIG. 22, any number of mounting locations and/or elements (e.g., elements mounted to one or more mounting locations) may be included as part of a rotatable LIDAR system. In some embodiments, some mounting locations may not exist about a peripheral region 2204 of rotor 2202, such as mounting location 2206h. In some embodiments, rotor 2202 may be connected to a shaft 2203. Rotor 2202 may be relatively flat compared to shaft 2203, which may extend further in a direction of a rotation axis, relative to the rotor. For example, a rotor and a shaft combination may be similar to the depiction shown in FIG. 8. In some embodiments, rotor 2202 and shaft 2203 may share a common rotational axis and/or a common center (e.g., focus). For example, a rotation axis may be oriented through a center (e.g., from the perspective of a circular cross-section) of both the rotor 2202 and shaft 2203. Peripheral region 2204 may surround shaft 2203 and/or may overlap (e.g., at least partially, or completely) with rotor 2202. It is appreciated that aspects discussed with respect to rotor 2202 may also apply to shaft 2203 as well. For example, as rotor 2202 rotates, shaft 2203 may also rotate. As another example, elements mounted around (or on) rotor 2202 may also be mounted around shaft 2203. Peripheral region 2204 may include, for example, an area that overlaps (e.g., partially or completely) rotor 2202 (e.g., from a bird's eye view), but that may or may not overlap shaft 2203. In some embodiments, a peripheral region 2204 of rotor 2202 may be an area (two-dimensional or three-dimensional) that is closer to an outer boundary of the rotor 2202 than the center of the rotor 2202. In some embodiments, peripheral region 2204 may contact rotor 2202 and/or shaft 2203, either partially or completely; in other embodiments, it may not contact rotor 2202 and/or shaft 2203 at all (e.g., peripheral region 2204 may be present above the rotor). Peripheral region 2204 may also surround (e.g., enclose) rotor 2202 and shaft 2203 (as shown in FIG. 22), though in some embodiments it may not. In some embodiments, peripheral region 2204 may be associated with a rotatable LIDAR system (e.g., overlap with a rotatable LIDAR system, be contained within rotatable LIDAR system). In some embodiments, peripheral region 2204 may include areas of the rotor located primarily towards the edge or periphery, consistent with disclosed embodiments. For example, if the cross-section of the rotor is circular, the peripheral regions can be defined as annular areas, such as annular areas that are closer to the outer edge of the rotor than the inner edge. Mounting locations 2206 may be associated with one or more optical elements (e.g., optical components), electronic components, mechanical components, or other components associated with a rotatable LIDAR system. For example, mounting locations 2206 may include hardware configured to mount a component (e.g., an optical element, an electronic element), such as by including a screw hole, snap fasten mechanism, welding point, surface (e.g., textured for an adhesive), or any other structure to which a component may be mounted (e.g., attached).

In some embodiments, elements mounted at the plurality of optical component mounting locations (e.g., mounting locations 2206) may be configured to rotate around the central rotational axis. For example, as rotor 2202 moves in a clockwise direction, elements mounted at the plurality of optical component mounting locations (and the locations themselves) may also move in a clockwise direction, and vice versa. In some embodiments, an element mounted at one of the optical component-mounting locations may be mounted according to a fixed axis (e.g., with a fixed orientation with respect to another component). For example, components may be mounted to a same piece of framing or housing associated with (e.g., part of) a rotatable LIDAR system.

In some embodiments, rotatable LIDAR system 2200 may have particular dimensions, such as one or more of a height, a width, a length, a radius, or a diameter. In some embodiments, rotatable LIDAR system 2200 may have a cylindrical shape (or a predominantly cylindrical shape, as seen in FIG. 11, for example) and/or may have a circular footprint (e.g., from a top, or bird's eye, view), as depicted in figures herein, such as FIGS. 22-24. As an example, an outer shape of housing of rotatable LIDAR system 2200 may have a cylindrical shape, and rotor 2202 may have a particular radius 2208 (or corresponding diameter, not depicted). In some embodiments, a diameter of the rotatable LIDAR system may be between 90 mm-200 mm, inclusive. In some embodiments, the rotor (e.g., rotor 2202) may also have particular dimensions, such as a particular length, a particular radius, and/or a particular diameter. In some embodiments, a dimension (e.g., diameter, height) of the rotor (or shaft 2203, or rotatable LIDAR system) may be between 30 mm-75 mm, inclusive. In some embodiments, a dimension of different aspects of the rotatable LIDAR system may have a particular relationship to each other, such as a particular ratio. In some embodiments, a ratio of a diameter of the rotatable LIDAR system (e.g., a diameter of rotor 2202, a diameter of a circular cross-sectional area of the rotatable LIDAR system) over a height of the rotatable LIDAR system (or a height of shaft 2203) may be between 1.2 and 6.7, inclusive.

In some embodiments, rotor 2202 may rotate due to the operation of a motor (not shown), which may also be part of rotatable LIDAR system 2200. In some embodiments, rotatable LIDAR system 2200 may further include a motor configured to rotate the rotor at a speed of at least 3,000 rotations per minute (rpm). Of course, other rotational speeds are possible, such as, by way of example and without limitation, 2,500 rpm, 4,000 rpm, 5,000 rpm, or between 1,000 and 10,000 rpm. In some embodiments, rotatable LIDAR system 2200 may include more than one motor. In some embodiments, rotatable LIDAR system 2200 may further include a first motor configured to rotate the rotor at a speed of at least 3,000 rpm and a second motor configured to pivot a light deflector (e.g., movable light deflector 714, discussed further below).

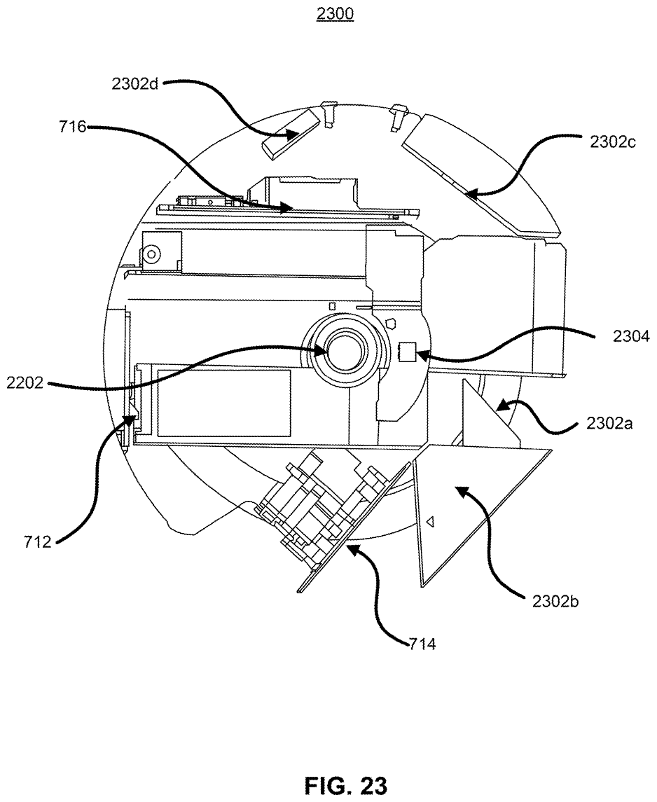

FIG. 23 is a diagrammatic illustration of an example implementation of a rotatable LIDAR system, consistent with some embodiments of the present disclosure. In this exemplary depiction, rotatable LIDAR system 2300 (which may include any or all of the features discussed with respect to LIDAR systems depicted or described elsewhere herein, including rotatable LIDAR system 2200) may include a light source 712, a movable light deflector 714, and/or a light detector 716 (all of which are discussed above with respect to FIG. 7).

In some embodiments, the rotatable LIDAR system 2300 may be configured to scan a vertical field of view (VFOV). Scanning may include one or more of deflecting, reflecting, transmitting, projecting, and/or configuring light waves towards an area, such as an environment external to rotatable LIDAR system 2300. A vertical field of view may include an area to which light waves can be transmitted or projected during an amount of rotation (e.g., a millisecond of time, a half degree of rotation, one degree of rotation, two degrees of rotation) of rotatable LIDAR system 2300. In some embodiments, scanning a VFOV may be facilitated using a light deflector, as discussed herein.

In some embodiments, rotatable LIDAR system 2300 may include a scanning light deflector (e.g., movable light deflector 714), which may be mounted at one of a plurality of optical component mounting locations that exist as part of rotatable LIDAR system 2300, and which may perform, facilitate, or contribute to vertically scanning a field of view. For example, rotatable LIDAR system 2300 may include a scanning light deflector that is mounted at mounting location 2206e. In some embodiments, a scanning light deflector may be structured, shaped, sized, positioned, oriented, angled, and/or have a composition allowing it to deflect light. In some embodiments, the scanning light deflector (e.g., movable light deflector 714) may comprise a prism. Additionally or alternatively, the scanning light deflector (e.g., a movable light deflector 714) may comprise a mirror.

In some embodiments, the scanning light deflector may be configured to vertically scan a field of view as the rotor 2202 rotates. Vertically scanning may include deflecting, reflecting, transmitting, projecting, and/or configuring light waves, which may have been emitted by, for example, light source 712. Vertically scanning may also include one or more of deflecting, reflecting, and/or transmitting light waves toward different portions (e.g., different vertical portions) of a field of view (which may change as rotor 2202 rotates) over time. In some embodiments, the light deflector (e.g., movable light deflector 714) may be configured to both transmit an outbound light beam and transmit (e.g., by deflecting or reflecting) inbound reflections of the light beam. For example, the light deflector may transmit a light beam from the interior of the rotatable LIDAR system to an exterior environment of the rotatable LIDAR system (e.g., a field of view of the rotatable LIDAR system). In some embodiments, such light may reflect off of an object or surface in the exterior environment of the rotatable LIDAR system and may reflect back toward the rotatable LIDAR system. The rotatable LIDAR system may also receive inbound light, such as an inbound reflection of a transmitted light beam. For example, light transmitted from the rotatable LIDAR system may be reflected back toward the rotatable LIDAR system, where it may be received by the rotatable LIDAR system, such as being influenced by (e.g., intersecting, contacting, reaching, propagating to, being impinged by, or being altered by) a light deflector and propagating (e.g., transmitting) along a light reception pathway.

In some embodiments, the light deflector (e.g., movable light deflector 714) may be configured to transmit an outbound light beam or transmit inbound reflections of the light beam. In some embodiments, one light deflector may be configured to transmit an outbound light beam and another light deflector may be configured to transmit inbound reflections of the light beam. In some embodiments, the rotatable LIDAR system may be configured to receive light at an initial entry angle (which may be associated with, e.g., occur at, a light deflector) that is greater than a threshold angle (e.g., a threshold amount of degrees) relative to a terminal angle at which light is received by a light detector. For example, light received at, by, or near movable light deflector 714 may have an angle that is different from an angle of light that is received by light detector 716 (e.g., due to the light being deflected as it travels along a reception pathway). By way of further example, if a threshold angle may be 45 degrees, and light may be received at an initial entry angle of 46 degrees relative to the terminal angle at which light is received by the light detector. In some embodiments, the rotatable LIDAR system may be configured to receive light at an initial entry angle that is greater than 90 degrees different at a terminal angle at which the light is received by the light detector. As another example, the rotatable LIDAR system may be configured to receive light at an initial entry angle that is greater than 70 degrees different at a terminal angle at which the light is received by the light detector.

In some embodiments, the rotatable LIDAR system 2300 may be configured to receive beams (e.g., waves) of light at a particular rate. In some embodiments, the rotatable LIDAR system 2300 may be configured to generate frames (e.g., frames of point cloud data, which may include arrays of point cloud data) at a rate of at least 5 frames per second (FPS). LIDAR system 2300 may be configured to generate frames at a rate of between 5-20 FPS (inclusive) Additionally or alternatively, the rotatable LIDAR system 2300 may have a horizontal field of view between 180 and 360 degrees (inclusive), a vertical field of field between 15 and 115 degrees (inclusive), and a resolution of between 0.25 and 0.025 degrees (inclusive).

In some embodiments, rotatable LIDAR system 2300 may include a light detector 716, which may be mounted at one of a plurality of optical component mounting locations. For example, rotatable LIDAR system 2300 may include a light detector 716 that is mounted at mounting location 2206b. In some embodiments, light detector 716 may be configured to receive, while the rotor rotates, reflections of light from objects in the field of view. For example, light detector 716 may be configured to receive light waves that have been reflected from an environment of rotatable LIDAR system 2300, such as reflections from a stationary object, a moving object, or a surface (e.g., a ground surface, a liquid surface). In some embodiments, light detector 716 may receive multiple reflections of light to use for generating point cloud data. The same light waves may have been initially deflected or otherwise influenced by (e.g., impinged upon) by the scanning light deflector prior to being reflected by an environment of rotatable LIDAR system 2300. In some embodiments, a light detector (e.g., light detector 716) may be configured to receive a plurality of light beams during a single rotation of the rotor. For example, during rotation of the rotor, a light deflector may receive multiple light beams, which may be transmitted along a light reception pathway according to one or more optical components, consistent with disclosed embodiments. In some embodiments, the plurality of light beams may be separated by a particular angular distance. In some embodiments, the plurality of light beams may be separated by an angular distance of 0.1-5 degrees, inclusive. The rotor may be configured to rotate multiple times, and the light detector may also be configured to receive pluralities of light beams for respective rotations.

The rotatable LIDAR system 2300 may also include a plurality of optical elements mounted at others of the plurality of optical component mounting locations. For example, rotatable LIDAR system 2300 may include optical elements 2302a, 2302b, 2302c, and 2302d, which may be mounted at mounting locations 2206f, 2206g, 2206d, and 2206c, respectively. Rotatable LIDAR system 2300 may include, however, any number of optical elements, which may be mounted at different mounting locations than those depicted in the exemplary figures. An optical element may include one or more of a mirror, a prism, a lens, a polarizer, a diffuser, a diffraction grating, a beam-splitter, an optical window, a filter, a waveplate, a reflector, a crystal, or any other component configured to alter a beam of light (e.g., alter an angle of the beam, alter a frequency of the beam, split the beam, polarize the beam, absorb the beam, alter an amplitude of the beam).

Rotatable LIDAR system 2300 may also include at least one electronic component mounting location. For example, rotatable LIDAR system 2300 may also include at least one electronic component mounting location between the central rotational axis and the peripheral region of the rotor. With reference to exemplary FIG. 22, mounting location 2206h may be an electronic component mounting location. With reference to exemplary FIG. 23, rotatable LIDAR system 2300 may include electronic element 2304, which may be mounted at mounting location 2206h. In some embodiments, the at least one electronic component mounting location may include a plurality of electronic component mounting locations. In some embodiments, LIDAR system 2300 may include multiple electronic components, which may be mounted to one or more (e.g., different) electronic component mounting locations. An electronic component may include one or more of a circuit, a processor, a wire, a diode, a capacitor, a memory component, an inductor, a resistor, a printed circuit board (PCB) or any other component associated with receiving, altering, analyzing, determining, transmitting, or otherwise using optical information.

In some embodiments, the LIDAR system may further include at least one laser emitter. A laser emitter may be configured to emit one or more laser light beams, which may constitute beams of transmitted light, consistent with disclosed embodiments. In some embodiments, the at least one laser emitter may emit one or more separate laser light beams (e.g., spaced apart from one another, such as by a threshold spacing amount) to one or more optical elements (e.g., a deflector), which may cause the one or more laser light beams to be projected toward a field of view of the LIDAR system. In some embodiments, the at least one laser emitter may include at least one multichannel laser emitter, which may include a number of different channels. In some embodiments, the at least one multichannel laser emitter may include between 4-128 channels, inclusive. Additionally, in some embodiments, the at least one laser emitter may include a plurality of multichannel laser emitters, any or each of which may include between 4-128 channels, inclusive. In some embodiments, the LIDAR system may include a laser (e.g., a laser emitter) spaced apart from the scanning light deflector. For example, a laser (e.g., laser emitter) may be positioned within the LIDAR system at a predetermined distance from, or at a distance that is at least a threshold distance from, the scanning light deflector.

Elements of rotatable LIDAR system 2300 may be arranged in different ways. As discussed above, in some embodiments, elements of the rotatable LIDAR system may be mounted at fixed orientations with respect to one another, and/or with respect to a structural aspect (e.g., the body or frame of) the rotatable LIDAR system. In some embodiments, the scanning light deflector, the light detector, and the plurality of optical elements may be mounted at fixed orientations with respect to one another. In some embodiments, the central rotational axis of the rotor (discussed above), may be a single (e.g., the only) rotational axis for one or more elements. In some embodiments, the central rotational axis of the rotor (discussed above) may be a single rotational axis associated with the scanning light deflector, the light detector, and the plurality of optical elements.

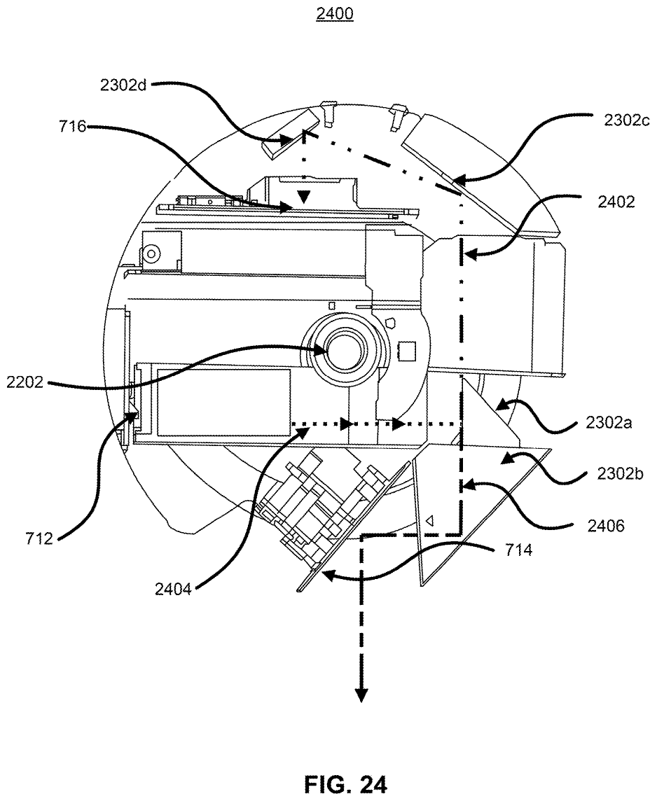

FIG. 24 is a diagrammatic illustration of exemplary optical paths for light in the rotatable LIDAR system of FIG. 23, consistent with some embodiments of the present disclosure. In some embodiments, a rotatable LIDAR system may include at least one optical pathway. An optical pathway may be open space, one or more areas between opaque elements (e.g., electronic and/or structural elements of a rotatable LIDAR system), or any other space configured to allow light (e.g., light on the visible spectrum, light not on the visible spectrum, or both) to transmit. In some embodiments, an optical pathway may be configured (e.g., through orientations, placements, and/or dimensions of one or more areas) to allow for or to cause light to travel along the optical pathway. In some embodiments, an optical pathway may include one or more segments that extend in predominantly linear directions. In some embodiments, multiple segments may be connected to each other, such that an optical pathway has a directional change, as discussed further herein.

In some embodiments, the at least one optical pathway may comprise a light reception pathway or a light transmission pathway. In some embodiments, at least one optical pathway may comprise a light reception pathway and a light transmission pathway. A light reception pathway may include an optical pathway along (e.g., through) which light received by a rotatable LIDAR system can travel (e.g., according to optical components). A light transmission pathway may include an optical pathway along (e.g., through) which light transmitted by a rotatable LIDAR system can travel (e.g., according to optical components). In this exemplary depiction, rotatable LIDAR system 2400 (which may include any or all of the features discussed with respect to LIDAR systems depicted or described elsewhere herein, including rotatable LIDAR system 2200 and/or rotatable LIDAR system 2300) includes a light reception pathway 2402 and a light transmission pathway 2404. In some embodiments, the light reception pathway may be longer than the light transmission pathway. Additionally, the light reception pathway may be a threshold amount longer than the light transmission pathway. For example, the light reception pathway may be at least a threshold number of millimeters or centimeters longer than the light transmission pathway, and/or may be at least a threshold percent longer (e.g., 20% longer, 50% longer, 70% longer, 115% longer). In some embodiments, light reception pathway 2402 plus overlapping pathway 2406 may be considered a continuous (e.g., single) light reception pathway. Similarly, light transmission pathway 2404 plus overlapping pathway 2406 may be considered a continuous (e.g., single) light transmission pathway.

In some embodiments, the rotatable LIDAR system may include an area (e.g., pathway) where multiple pathways overlap. In some embodiments, the light reception pathway and the light transmission pathway may at least partially overlap. With reference to exemplary FIG. 24, rotatable LIDAR system 2300 may include an overlapping pathway 2406, where light reception pathway 2402 and light transmission pathway 2404 travel along (or nearby) the same pathway. In some embodiments, the light reception pathway and the light transmission pathway may be defined in opposite directions in a region at which the light reception pathway and the light transmission pathway at least partially overlap. With reference to exemplary FIG. 24, within overlapping pathway 2406, light reception pathway 2402 may be oriented inward (e.g., towards the interior of rotatable LIDAR system 2300), and light transmission pathway 2404 may be oriented outward (e.g., towards the exterior of rotatable LIDAR system 2300).

In some embodiments, both the light reception pathway and the light transmission pathway may be influenced by (e.g., may intersect, contact, overlap, reach, be impinged by) a same element that is part of the rotatable LIDAR system. In some embodiments, both the light reception pathway and the light transmission pathway may be influenced by (e.g., may intersect, contact, overlap, reach, be impinged by) the scanning light deflector (e.g., movable light deflector 714).

In some embodiments, elements of the rotatable LIDAR system may be configured to alter an angle of light received by the rotatable LIDAR system. For example, one or more elements (e.g., optical components) may have one or more of a particular position, angle, orientation, size, orientation, thickness, material, composition, dimension, and/or shape that cause received light (or transmitted light) to proceed along a particular pathway (e.g., a light reception pathway, a light transmission pathway), consistent with disclosed embodiments. In some embodiments, the plurality of optical elements comprise a reflective surface (e.g. a folding mirror) configured to reflect light from the light transmission pathway and transmit light from the light reception pathway.

In some embodiments, the scanning light deflector and the plurality of optical elements may be configured to alter an angle of light transmitted by the rotatable LIDAR system at least three times. Additionally, the scanning light deflector and the plurality of optical elements may be configured to alter an angle of light received by the rotatable LIDAR system at least four times. Examples of pathways altering an angle of light are discussed further below with respect to FIG. 24. In some embodiments, one or more elements of the rotatable LIDAR system may be configured to alter the angle of light by a number of degrees. In some embodiments, the scanning light deflector and the plurality of optical elements may be configured to alter an angle of light received by the rotatable LIDAR system by a total of more than 180 degrees. A total number of degrees by which the angle of light is altered may be expressed as the difference between an initial angle of light and a final angle of light. For example, a total number of degrees by which the angle of light received by rotatable LIDAR system 2400 is altered may be considered the difference between angle of light received by (e.g., at) the scanning light deflector (e.g., movable light deflector 714) and the angle of light received by (e.g., at) light detector 716. Alternatively, a total of degrees by which the angle of light is altered may be expressed as the summation of multiple angle alterations expressed in degrees. For example, an alteration of 90 degrees leftward followed by an alteration of 90 degrees rightward would be considered a total degree change of 180 degrees.

In some embodiments, the scanning light deflector (e.g., movable light deflector 714) and the plurality of optical elements may define at least one optical pathway having at least one directional change between the scanning light deflector and the light detector. In some embodiments, the optical pathway may be positioned within rotatable LIDAR system 2300 such that light traveling along the pathway travels through the interior of rotatable LIDAR system 2300. In some embodiments, the at least one optical pathway may include at least two directional changes (e.g., corresponding to a directional change of light traveling along the pathway), which may occur at optical elements. For example, the plurality of optical elements may be configured such that the at least one optical pathway includes at least two directional changes. Additionally or alternatively, the plurality of optical elements may be configured such that the at least one optical pathway includes at least three directional changes. For example, a light reception pathway, such as the combination of light reception pathway 2402 and overlapping pathway 2406, may include a directional change at movable light deflector 714, a directional change at optical element 2302b, optical element 2302c, and optical element 2302d. As another example, a light transmission pathway, such the combination of light transmission pathway 2404 and overlapping pathway 2406, may include a directional change at movable light deflector 714, a directional change at optical element 2302b, and optical element 2302a. In some embodiments, rotatable LIDAR system 2300 may include a prism that is common to (e.g., is positioned along or nearby both of, influences both of, intersects both of, impinges upon both of) the light reception pathway and the light transmission pathway. In some embodiments, the prism may be configured to fold (e.g., bend, alter, curl, influence, constrain, direct) the light reception pathway and the light transmission pathway. In some embodiments, optical element 2302a may be configured (e.g., structured, shaped, sized, positioned, oriented, angled, and/or have a composition) to reflect or deflect light traveling along light transmission pathway 2404 and may also be configured to transmit (e.g., with no or minimal angle alteration) light traveling along light reception pathway 2402.

In some embodiments, one optical pathway may include a directional change that is not included in another optical pathway. For example, a light reception pathway may include one directional change that is not included in a light transmission pathway. Additionally or alternatively, a light transmission pathway may include one directional change that is not included in a light reception pathway.

In some embodiments, at least one of the plurality of optical elements may be configured to deflect light. In some embodiments, at least one of the plurality of optical elements may be configured to deflect light traveling along the light reception pathway and light traveling along the light transmission pathway. In some embodiments, the scanning light deflector may be configured to deflect multiple beams of light, which may be traveling in different (e.g., opposite) directions. In some embodiments, the scanning light deflector may be configured to deflect light traveling along the light reception pathway and light traveling along the light transmission pathway. With reference to exemplary FIG. 24, movable light deflector 714 may deflect incoming light traveling along light reception pathway 2402, which may be deflected towards the rotatable LIDAR system 2300 (e.g., towards an element internal to rotatable LIDAR system 2300) and may also deflect outgoing light traveling along light transmission pathway 2404.

In some embodiments, at least one optical pathway may proceed nearby, between, and/or around different components of a rotatable LIDAR system. In some embodiments, the at least one optical pathway encompasses more than 180 degrees of the rotor. With reference to exemplary FIG. 24, the optical pathway of the combination of light reception pathway 2402 and overlapping pathway 2406 encompasses (e.g., travels around) more than 180 degrees around the rotational axis of rotor 2202. In some embodiments, a length of the at least one optical pathway may be greater than a diameter of the rotor. For example, the length of a light reception and/or transmission pathway may be greater than a diameter of the rotor (e.g., rotor 2202). In some embodiments, the at least one optical pathway may surround at least a portion of a plurality of electronic component mounting locations. In some embodiments, a PCB may be mounted at one or more of the electronic component mounting locations. In some embodiments, an optical pathway may be considered to surround an element if it passes past the element, traverses the element, proceeds around the element, proceeds from one side of the element to another side of the element, or partially encloses the element.

In some embodiments, the at least one optical pathway may be oriented on a plane that is intersected by the central rotational axis of the rotor. For example, at least one optical pathway may proceed in one or more directions along a single plane. The central rotational axis of the rotor may intersect, such as by proceeding through, the plane. Additionally, the central rotational axis of the rotor may be perpendicular to the plane. In some embodiments, the at least one optical pathway may be oriented on a plane that is perpendicular to the central rotational axis of the rotor. With reference to exemplary FIG. 24, at least one optical pathway (e.g., light reception pathway 2402, light transmission pathway 2404, overlapping pathway 2406, or a combination thereof) may be oriented on a plane corresponding to the plane (e.g., sheet of paper) the figure is present on, and the central rotational axis of the rotor 2202 may proceed through the plane, towards (or away from) the reader, intersecting the plane of at least one optical pathway. In some embodiments, the at least one optical pathway may be oriented on a plane parallel with the rotor (e.g., parallel with a radius or diameter of the rotor). In some embodiments, the plane may be associated with, or substantially parallel to (e.g., within a threshold number of degrees) a ground plane, the roof plane of a vehicle, or a plane of a surface to which the rotatable LIDAR system is mounted.

In an embodiment, a rotatable LIDAR system comprises a rotor having a central rotational axis and a plurality of optical component mounting locations about a peripheral region of the rotor, wherein components mounted at the plurality of optical component mounting locations are configured to rotate around the central rotational axis; a scanning light deflector mounted at one of the plurality of optical component mounting locations, the scanning light deflector being configured to vertically scan a field of view as the rotor rotates; a light detector mounted at one of the plurality of optical component mounting locations and configured to receive, while the rotor rotates, reflections of light from objects in the field of view; and a plurality of optical elements mounted at others of the plurality of optical component mounting locations, the scanning light deflector and the plurality of optical elements defining at least one optical pathway having at least one directional change between the scanning light deflector and the light detector.

In some embodiments of the rotatable LIDAR system, the at least one optical pathway includes at least two directional changes.

In some embodiments of the rotatable LIDAR system, the at least one optical pathway encompasses more than 180 degrees of the rotor.

In some embodiments of the rotatable LIDAR system, a length of the at least one optical pathway is greater than a diameter of the rotor.

In some embodiments of the rotatable LIDAR system, the light deflector is configured to both transmit an outbound light beam and transmit inbound reflections of the outbound light beam.

In some embodiments of the rotatable LIDAR system, the plurality of optical elements are configured such that the at least one optical pathway includes at least three directional changes.

In some embodiments, the rotatable LIDAR system further comprises a motor configured to rotate the rotor at a speed of at least 3,000 rpm.

In some embodiments, the rotatable LIDAR system further comprises a first motor configured to rotate the rotor at a speed of at least 3,000 rpm and a second motor configured to pivot the light deflector.

In some embodiments, the rotatable LIDAR system further comprises at least one electronic component mounting location between the central rotational axis and the peripheral region of the rotor.

In some embodiments of the rotatable LIDAR system, the at least one electronic component mounting location includes a plurality of electronic component mounting locations, and the at least one optical pathway surrounds at least a portion of the plurality of electronic component mounting locations.

In some embodiments of the rotatable LIDAR system, the at least one optical pathway is oriented on a plane that is intersected by the central rotational axis of the rotor.

In some embodiments of the rotatable LIDAR system, the at least one optical pathway is oriented on a plane that is perpendicular to the central rotational axis of the rotor.

In some embodiments of the rotatable LIDAR system, a diameter of the rotatable LIDAR system is between 90 mm-200 mm, inclusive.

In some embodiments of the rotatable LIDAR system, a dimension of the rotor is between 30 mm-75 mm, inclusive.

In some embodiments of the rotatable LIDAR system, a ratio of a diameter of the rotatable LIDAR system over a length of the rotor is between 1.2 and 6.7, inclusive.

In some embodiments of the rotatable LIDAR system, the rotatable LIDAR system is configured to scan a vertical field of view (VFOV).

In some embodiments of the rotatable LIDAR system, the system is configured to receive the reflections of light at a rate of at least 5 frames per second (FPS).

In some embodiments of the rotatable LIDAR system, the at least one optical pathway comprises a light reception pathway.

In some embodiments of the rotatable LIDAR system, the at least one optical pathway is oriented on a plane parallel with the rotor.

In some embodiments, the rotatable LIDAR system further comprises at least one laser emitter.

In some embodiments of the rotatable LIDAR system, the at least one laser emitter comprises at least one multichannel laser emitter.

In some embodiments of the rotatable LIDAR system, the at least one multichannel laser emitted comprises between 4-128 channels, inclusive.

In some embodiments of the rotatable LIDAR system, the at least one laser emitter comprises a plurality of multichannel laser emitters.

In some embodiments of the rotatable LIDAR system, the light detector is configured to receive a plurality of light beams during a single rotation of the rotor.

In some embodiments of the rotatable LIDAR system, the plurality of light beams are separated by an angular distance of 0.1-5 degrees, inclusive.

In some embodiments of the rotatable LIDAR system, the scanning light deflector, the light detector, and the plurality of optical elements are mounted at fixed orientations with respect to one another.

In some embodiments of the rotatable LIDAR system, the central rotational axis is a single rotational axis associated with the scanning light deflector, the light detector, and the plurality of optical elements.

In some embodiments of the rotatable LIDAR system, the at least one optical pathway comprises a light reception pathway and a light transmission pathway.

In some embodiments of the rotatable LIDAR system, both the light reception pathway and the light transmission pathway are influenced by the scanning light deflector.

In some embodiments of the rotatable LIDAR system, the light reception pathway and the light transmission pathway at least partially overlap.

In some embodiments of the rotatable LIDAR system, the light reception pathway and the light transmission pathway are defined in opposite directions in a region at which the light reception pathway and the light transmission pathway at least partially overlap.

In some embodiments of the rotatable LIDAR system, the light reception pathway is longer than the light transmission pathway.

In some embodiments of the rotatable LIDAR system, the scanning light deflector is configured to deflect light traveling along the light reception pathway and light traveling along the light transmission pathway.

In some embodiments of the rotatable LIDAR system, at least one of the plurality of optical elements is configured to deflect light traveling along the light reception pathway and light traveling along the light transmission pathway.

In some embodiments of the rotatable LIDAR system, the rotatable LIDAR system is configured to receive light at an initial entry angle that is greater than 90 degrees different at a terminal angle at which the light is received by the light detector.

In some embodiments of the rotatable LIDAR system, the scanning light deflector and the plurality of optical elements are configured to alter an angle of light received by the rotatable LIDAR system at least four times.

In some embodiments of the rotatable LIDAR system, the scanning light deflector and the plurality of optical elements are configured to alter an angle of light transmitted by the rotatable LIDAR system at least three times.

In some embodiments of the rotatable LIDAR system, the scanning light deflector and the plurality of optical elements are configured to alter an angle of light received by the rotatable LIDAR system by a total of more than 180 degrees.

In some embodiments of the rotatable LIDAR system, the plurality of optical elements comprise a reflective surface configured to reflect light from the light transmission pathway and transmit light from the light reception pathway.

In some embodiments of the rotatable LIDAR system, the scanning light deflector includes a prism.

In some embodiments of the rotatable LIDAR system, the scanning light deflector includes a mirror.

In some embodiments, the rotatable LIDAR system further comprises a laser spaced apart from the scanning light deflector.

### Rotatable LIDAR System with Common Deflecting Element for Inbound and Outbound Light

As previously described, a rotatable LIDAR system may present notable advantages, particularly in the realm of automotive onboard LIDAR systems. One primary advantage, as depicted in FIG. 1A, is the feasibility of installing a sufficiently compact LIDAR system 100 on the roof of a vehicle 110, enabling a 360-degree, 3-dimensional (3D) scanning of the vehicle's environment. The compactness of the system may facilitate efficient and seamless integration of LIDAR technology into dynamic systems such as vehicles.

An advantageous feature that may be integrated into a rotatable LIDAR system is a shared/common deflecting element for both inbound and outbound light. This common deflecting element may play a central role within the LIDAR system by enabling the transmission and reception of light. Such a component may manage the path of light as it follows either a transmission path or a reflection path. Incorporating a common deflecting element into a LIDAR system may offer several advantages. First, it may simplify the overall design by consolidating the deflection mechanism for inbound and outbound light into a single component, leading to reduced complexity during manufacturing, assembly, and lower production costs due to the decreased number of components. Second, it may enable a more compact system, which may be beneficial when mounting the LIDAR on a vehicle, as it may minimize aerodynamic impact while maintaining aesthetics. Third, precise alignment of light paths may improve accuracy, resolution, and reliability when capturing the 3D field of view. Fourth, the common deflecting element may optimize system efficiency while minimizing energy losses and maximizing overall performance. And fifth, another benefit of employing a shared deflecting element lies in its structural integrity, ensuring that it remains undistorted even under high rotational speeds. For instance, when utilizing a thin mirror positioned at the outer edge of a rotor spinning at speeds exceeding 3000 rpm, the mirror can experience substantial centrifugal forces that might cause deformation or bending. In contrast, a single solid and sturdy component can effectively endure these forces.

In some embodiments, a rotatable LIDAR system may include a rotatable rotor. As mentioned earlier, the term “rotor” encompasses a movable component of a rotatable LIDAR system, specifically here designed to rotate around an axis. A rotor may adopt any kind of form or shape. In some embodiments, the rotatable rotor may be a disk. As used in this context, a disk refers to a relatively flat three-dimensional structure that has a circular cross-section and where the thickness is considered negligible compared to the diameter of its cross-sections. In other words, a disk possesses a low aspect ratio, which is defined as the ratio of thickness to diameter. For instance, a disk may have an aspect ratio below a predetermined threshold, such as 1/10. Alternatively, in some other embodiments, the rotatable rotor may be cylindrical. As used in this context, a cylinder refers to a three-dimensional structure with a circular cross-section, where the thickness is comparable to or within the same order of magnitude as the diameter of its cross-sections. In other words, a cylinder possesses a significant aspect ratio, indicating that its thickness is non-negligible compared to its diameter. For example, a cylinder may have an aspect ratio above a predetermined threshold, such as 1/10, indicating that the thickness and diameter are relatively closer in magnitude.

In accordance with the present disclosure, the rotatable rotor may encompass one or more components of a rotatable LIDAR system. Particularly, in certain embodiments, the rotatable rotor may integrate different optics to support both a reflection light path and a transmission light path. Within the scope of this disclosure, a transmission light path refers to a trajectory followed by a light beam exiting the LIDAR system, while a reflection light path pertains to a path traversed by a light beam collected by the LIDAR system. As discussed earlier, from a geometric standpoint, a light beam may be described as a concentrated and coherent flow of photons, which represents the propagation of electromagnetic radiation traveling in a specific direction or along a designated path. Light beams may also be conceptualized as a grouping of light rays that travel together in a coherent manner. While the individual rays within the beam may exhibit slight variations in direction or wavelength, they generally share an overarching trajectory or orientation. The collective effect of these multiple rays forms the light beam, which possesses a discernible spatial distribution and may carry energy and information. To simplify the visualization schematically, a light beam may be visualized as a cluster of straight lines or rays that emanate from a light source.

In some embodiments, the optics may include a light deflector, a scanning mirror, and a deflecting optical element. As used herein, a light deflector may refer to any kind of component designed to alter the direction or path of light. A light deflector may serve the purpose of altering the direction or path of light beams and may be accomplished through diverse mechanisms such as reflection, refraction, diffraction, or diffusion, depending on the intended purpose and application. In certain embodiments, the light deflector may incorporate a scanning mirror or the scanning mirror may be connected to actuation mechanism of the light deflector. A scanning mirror is a movable mirror designed to redirect or guide a light beam to specific positions or angles, facilitating the scanning or rasterization of the beam over a FOV.

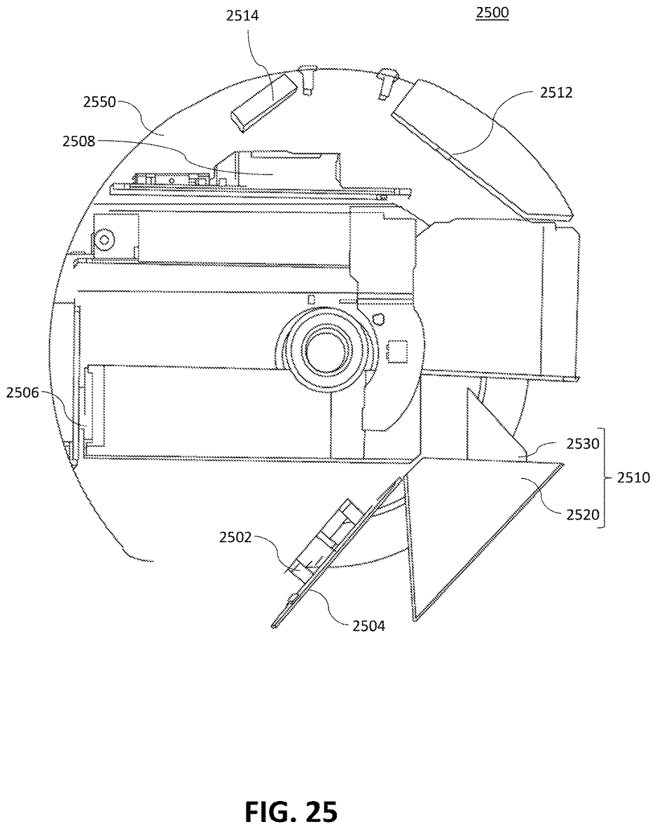

FIG. 25 is a diagrammatic illustration of an example implementation of a rotatable LIDAR system, consistent with some embodiments of the present disclosure. The diagrammatic illustration of a rotatable LIDAR system 2500 includes a schematic top view of an example rotatable rotor 2550. As shown, movable light deflector 2502, operatively connected to scanning mirror 2504 and deflecting element 2510, are mounted on rotor 2500. In addition, the rotatable rotor 2550 may include a laser source 2506, a detector 2508, a folding mirror 2512, and a deflector mirror 2514. In some embodiments, the deflecting optical element 2510 may be mounted at peripheral regions of the rotatable rotor. In this context, peripheral regions of a rotating rotor may indicate those areas of the rotor located primarily towards the edge or periphery. For example, if the cross-section of the rotor is circular, the peripheral regions can be defined as annular areas. These areas have an inner radius equal to a predetermined fraction of the radius of the circular cross-section and an outer radius equal to the radius of the circular cross-section of the rotor. For example, the predetermined fraction of the radius may be half of the radius of the circular cross section of the rotor.

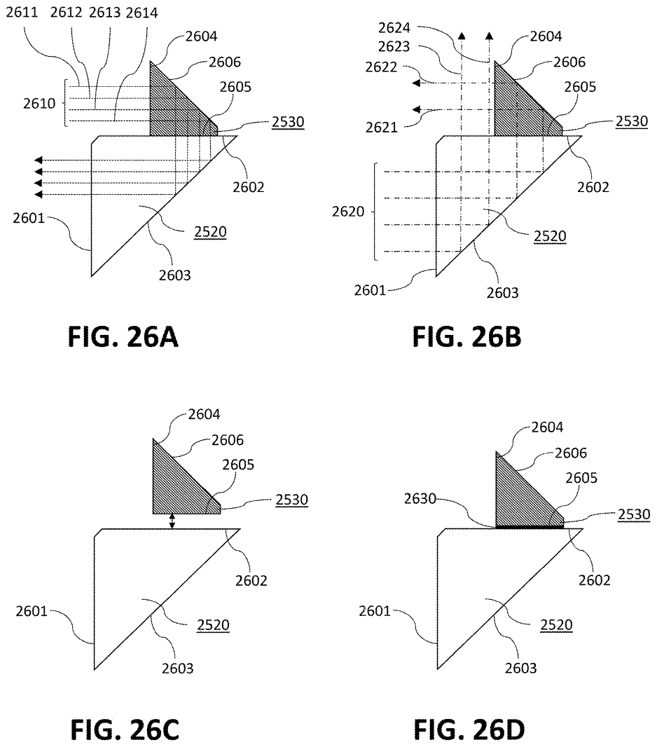

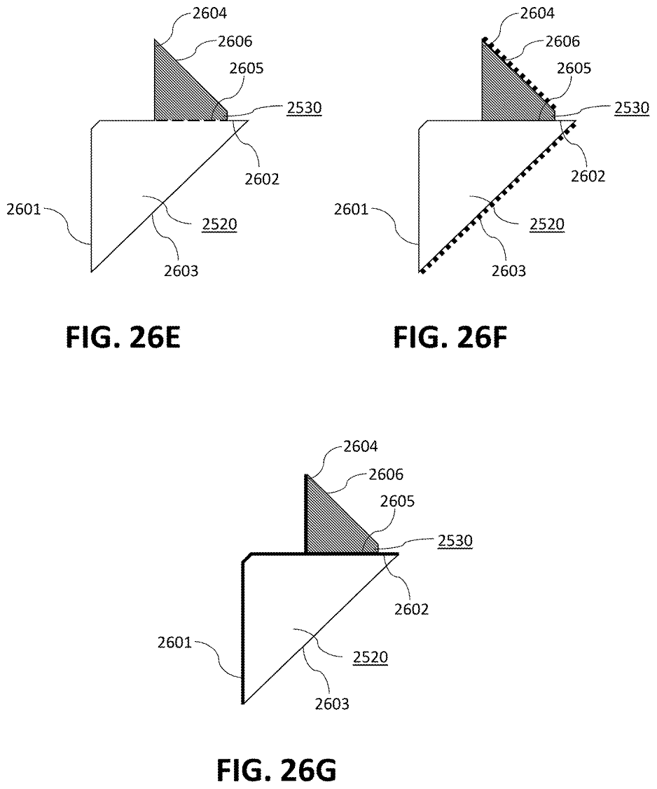

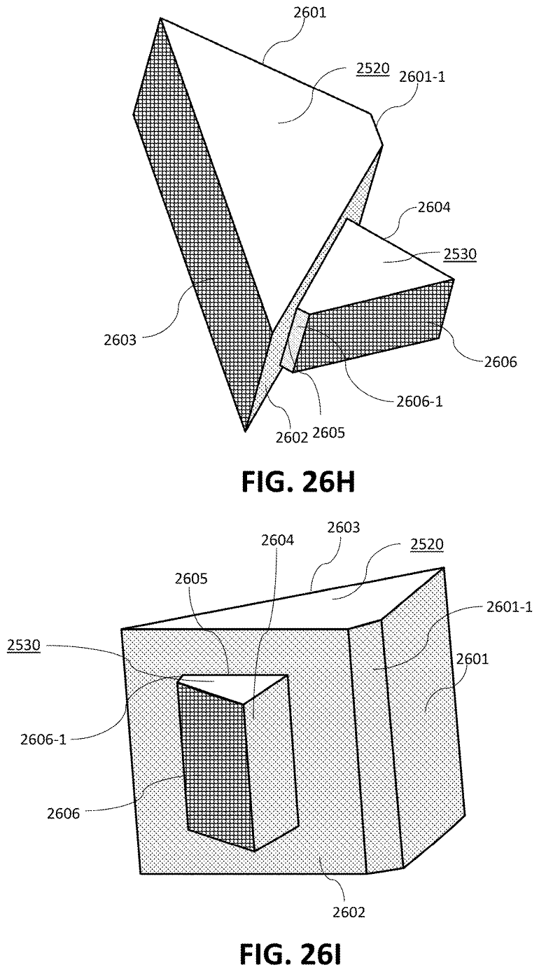

In accordance with the disclosed embodiments and as illustrated in FIG. 25, the deflecting optical element 2510 may include a first optical element portion 2520 and a second optical element portion 2530. FIGS. 26A to 26I illustrate various exemplary implementations of the deflecting optical element 2510. More specifically, FIGS. 26A to 26G show two-dimensional cross-sectional views of the deflecting optical element 2510 along a median plane perpendicular to the rotation axis of the rotor, while FIGS. 26H and 26I show perspective views of the deflecting optical element 2510. For the purpose of clarity, the second optical element portion 2530 is shaded in black in FIGS. 26A to 26G while the first optical element portion 2520 is shown in white.

The figures mentioned above illustrate the configuration of the first optical element portion 2520 and the second optical element portion 2530. The first optical element portion 2520 includes a first surface 2601, a second surface 2602, and a third surface 2603 angularly extending between the first surface 2601 and the second surface 2602. The first surface 2601 and the second surface 2602 are light transmissive, while the third surface 2603 is light reflective. The second optical element portion 2530 includes a fourth surface 2604, a fifth surface 2605, and a sixth surface 2606 angularly extending between the fourth surface 2604 and the fifth surface 2605. The fourth surface 2604 and the fifth surface 2605 are light transmissive, while the sixth surface 2606 is light reflective.

In general terms, within the scope of this context, a light transmissive surface refers to a surface that allows light to pass through it without significant absorption or scattering, thus maintaining the transparency of the surface to light. A light-reflective surface refers to a surface that redirects or reflects incident light, changing its direction of propagation. It is to be appreciated that surfaces may not exhibit absolute transparency or reflectivity. Therefore, a light-reflective or transmissive surface may include a surface that predominantly reflects or allows light to pass through. While there may be minor variations or imperfections in the extent of reflection or transmission, the surface is considered reflective when it primarily redirects light and transmissive when it primarily enables light to pass through without significant absorption, reflection, or scattering.

The behavior of a surface that acts as an interface between two different materials, such as air and glass, can undergo changes in terms of light reflection and transmission properties based on the incident angle of light rays. According to Snell-Descartes law, the reflection behavior of light rays encountering a surface varies with the properties of the materials and the angle of incidence. Total reflection occurs when the incident angle surpasses a critical angle determined by the refractive indices and optical characteristics of the materials involved. In such instances, the light rays are either partially or entirely reflected. Conversely, at incident angles below the critical angle, the light rays can traverse the surface and undergo refraction as they transition into the other material. Consequently, a surface may be regarded as light transmissive when the incident angles of incoming light rays remain below the critical angle and allow the light to pass through while it may be deemed light reflective when the incident angles exceed the critical angle and lead to predominant reflection of the light.

The visual representation of the first 2601, second 2602, third 2603, fourth 2604, fifth 2605, and sixth 2606 surfaces in FIGS. 26H and 26I differs based on their light reflective or transmissive nature. Light transmissive surfaces, namely 2601, 2602, 2604, and 2605, are depicted using a dotted pattern that signifies light may pass through. On the other hand, light reflective surfaces, specifically 2603 and 2606, are represented by a black grid pattern, indicating these surfaces may redirect or reflect incident light.

In accordance with the disclosed embodiments, the first optical element portion 2520 and the second optical element portion 2530 of the deflecting optical element 2510 work in tandem to achieve the desired redirection and manipulation of light beams. Specifically, a first light beam travelling along the transmission light path may enter through the fourth surface 2604 of the second optical element portion 2530. It may then be deflected by the sixth surface 2606 and pass through the fifth surface 2605 and the second surface 2602 before reaching the third surface 2603. The light beam undergoes an additional deflection by the third surface 2603 and emerges through the first surface 2601. On the other hand, a second light beam following the reflection light path may enter through the first surface 2601 of the first optical element portion 2520. The second light beam undergoes deflection by the third surface 2603 and emerges through the second surface 2602. By coordinating the functions of the first 2520 and second 2530 optical element portions, the deflecting optical element 2510 may serve as a common deflective element for both inbound and outbound light beams, encompassing the transmission and reflection paths.

In some embodiments, at least one of the first surface 2601, the second surface 2602, the third surface 2603, the fourth surface 2604, the fifth surface 2605, or the sixth surface 2606 may be defined by a plurality of contiguous faces. For example, FIGS. 26H and 26I show that the first surface 2601 and the sixth surface 2606 include two contiguous faces. One face represents the main surface, while the other is a smaller lateral face (labelled respectively as 2601-1 and 2606-1) connected to the main surface. It is contemplated that the small lateral faces 2601-1 and 2606-1 present on the first surface 2601 and the sixth surface 2606 may not have a significant impact on the functionality of the common deflecting element 2510. For example, these small lateral faces may not be involved in the direct interaction with light rays or light beams, and therefore, they may not play a substantial role in the optical properties or performance of the system.

FIG. 26A illustrates the cooperative mechanism of the deflecting optical element 2510 with respect to a first light beam 2610 including four individual light rays (2611, 2612, 2613, 2614) travelling along the transmission light path. Light beam 2610 enters the common deflecting element 2510 through the fourth surface 2604 of the second optical element portion 2530. The first light beam 2610 undergoes deflection by the sixth surface 2606, following a new trajectory towards the fifth surface 2605. Then, the first light beam 2610 traverses the fifth 2605 and second 2602 surfaces, ultimately reaching the third surface 2603. At this point, it encounters another deflection caused by the third surface 2603. Finally, the first light beam 2610 or equivalently light rays (2611, 2612, 2613, and 2614) emerge from the common deflecting optical element 2510 through the first surface 2601 associated with the first optical element portion 2520.

FIG. 26B illustrates the cooperative mechanism of the deflecting optical element 2510 with respect to a second light beam 2620 including four individual light rays (2621, 2622, 2623, 2624) travelling along the reflection light path. The light beam 2620 enters the common deflecting element 2510 through the first surface 2601 of the first optical element portion 2520. The second light beam 2620 undergoes deflection by the third surface 2603, following a new trajectory towards the second surface 2602 successfully passing through it. In some embodiments, downstream from the second surface 2602 (i.e., after traversing the second surface 2602), a portion of the second light beam 2620, represented by light rays 2621 and 2622, passes through the fifth surface 2605. Subsequently, these rays become deflected by the sixth surface 2606, through the fourth surface 2604. Meanwhile, another portion of the second light beam, consisting of light rays 2623 and 2624, passes through the second surface 2602 and continues along its path without being affected by the presence of the second optical element portion 2530.

In some embodiments, the rotatable LIDAR system 2500, as depicted in FIG. 25 may further comprise a laser 2506 and a detector 2508. In such cases, the configuration of the rotatable LIDAR system 2500 enables the following functionalities during operation: the first light beam 2610 originates from the laser 2506; a first portion (e.g., light rays 2621 and 2622) of the second light beam 2620 is reflected back to the laser 2506 by passing through the fifth surface 2605 and undergoing deflection by the sixth surface 2606 through the fourth surface 2604; and, a second portion (e.g., light rays 2623 and 2624) of the second light beam 2620, after passing through the second surface, impinges on the detector 2508.

Additionally, in some embodiments, the rotatable LIDAR system 2500 may further comprise a folding mirror 2514 and a deflector mirror 2512 configured to deflect the second portion (2623 and 2624) of the second light beam 2620 toward the detector 2508. The folding mirror 2514 and deflector mirror 2512 within the rotatable LIDAR system refer to any kind of components specifically designed to redirect light beams. For example, the folding mirror 2514 may be configured to redirect the light at a 90-degree angle, while the deflector mirror 2512 may be designed to redirect the light at angles greater than 90 degrees. During operation, these components are generally fixed in their positions to ensure consistent and reliable light redirection. However, it is important to note that the angles of deflection may be adjusted by utilizing different settings or mechanisms associated with these mirrors, enabling fine-tuning of the angle of deflection according to the specific requirements of the LIDAR system 2500 and the application at hand.

In some embodiments, the first optical element portion 2520 and the second optical element portion 2530 may have a same refractive index. In other words, both portions may correspond to unified bodies, composed of a single material exhibiting a consistent refractive index denoted n (n represents the ratio of the speed of light in vacuum (c) to the speed of light in the material (v), i.e., n=c/v≥1). For example, in some embodiments, the first optical element portion 2520 and the second optical element portion 2530 may be made from a same type of glass. Examples of types of glass may include BK7, fused silica, SF10, Flint Glass, Crown Glass, or any other kind of glass suitable for crafting optical components. Alternatively, in some other embodiments, the first optical element portion 2520 and the second optical element portion 2530 may have different refractive indices. This means that both portions may correspond to unified bodies, composed of a single material characterized by two different refractive indices n and n′ with n≠n′. For example, in some embodiments, the first optical element portion 2520 and the second optical element portion 2530 may be made from different types of glass, wherein one type of glass has a higher refractive index with respect to the other.

Furthermore, in some embodiments, at least one of the first optical element portion 2520 and the second optical element portion 2530 may have a refractive index greater than 1. In other words, at least one of the two portions 2520, and 2530 may be made from a material different from air or vacuum, such as glass for example. When a material has a refractive index greater than 1, light travelling through that medium will experience a speed reduction compared to its velocity in vacuum.

Additionally, in some embodiments, a first light transparent volume may be formed between the first surface 2601, the second surface 2602 and the third surface 2603, and a second light transparent volume may be formed between the fourth surface 2604, the fifth surface 2605 and the sixth surface 2606. Within the context of this disclosure, a light transparent volume may refer to a region within the deflecting optical element where light may pass through with minimal obstruction, distortion, or energy loss. By having separate volumes for the different portions 2520 and 2530 of the common deflecting optical element 2510, the transmission and manipulation of light beams 2610 and 2620 may be controlled and optimized within each specific region. Light transparent volumes may be characterized by a refractive index. For example, in some embodiments, at least one of the first light transparent volume or the second light transparent volume may have a refraction index greater than or equal to 1.5 and lower than or equal to 1.6. Using these values and assuming that the first and second light transparent volumes are surrounded by air, values of the critical angle mentioned earlier are therefore ranging from 38.7 to 41.8 degrees.

In some embodiments, it is contemplated that the first light transparent volume may be greater than the second light transparent volume. For example, as illustrated in FIGS. 26H and 26I, the first optical element portion 2520 has a volume greatly exceeding the one of the second optical element portion. This discrepancy in the volume values may be attributed to the relative sizes or areas of the surfaces of the first 2520 and second 2530 optical element portions. For example, in some embodiments, the fifth surface 2605 may have a smaller area than the second surface 2605. In cases where the fifth surface 2605 has a smaller surface area than the second surface 2602, these may be scenarios in which at least one dimension, such as length, of the fifth surface 2605 is smaller than the corresponding dimension of the second surface 2602. In addition, this surface difference may also concern several dimensions, without being limited to just one. This means that the fifth surface 2605 may have smaller lengths, widths, or other relevant dimensions than the corresponding dimensions of the second surface 2602. The area of the fifth surface 2605 along the reflection path may reflect light, thereby directing a portion of collected light (2621, 2622) through the 4^{th} surface, away from the detector, as illustrated in FIG. 26B, reducing the efficiency of the LIDAR system. It is therefore advantageous to reduce the area of the fifth surface 2605 relative to the area of the second surface 2502 to maximize the portion of reflected light (2623, 2634) transmitted through the second surface 2602.

For example, as shown in FIGS. 26H and 26I, the fifth surface 2605 of the second optical element part 2530 has a smaller length and width than the second surface 2602 of the first optical element part 2510. In some embodiments, for example, the area of the fifth surface 2605 is smaller than the area of the second surface 2602 by a factor of between 0.27 and 0.4. In some embodiments, the area of the fifth surface 2605 is no larger than half of the area of the second surface 2602.

In some embodiments, the second surface 2602 and the fifth surface 2605 may be spaced apart from each other. This separation can be achieved by employing various materials that do not significantly affect the path of the light beams 2610, and 2620, as described earlier. For instance, as depicted in FIG. 26C, the second surface 2602 and the fifth surface 2605 are shown to be separated by an air gap, indicated by a black double arrow. In alternative scenarios, the separation between the second surface 2602 and the fifth surface 2605 may be filled with a different light-transmitting material, such as glass or a liquid, instead of air. In some embodiments, the material used for the separation does not introduce substantial changes to the behavior and trajectory of the light beams as they traverse the deflecting optical element 2510. Alternatively, in some other embodiments, the second surface 2602 and the fifth surface 2605 may be in contact with each other as illustrated in FIGS. 26A-B and 26H-I for example.

In some embodiments, the second surface 2602 and the fifth surface 2605 of the deflecting optical element 2510 may lie in a common plane. This means that these surfaces may be positioned on the same plane or are aligned with each other, forming a flat and continuous interface within the optical element as illustrated in FIGS. 26A-B and 26H-I for example. By having the second and fifth surfaces in a common plane, the optical paths of the light beams 2610 and 2620 remain uninterrupted and aligned, providing efficient transmission and manipulation of the light within the system. Alternatively, in some other embodiments, an angle may exist between the second surface 2602 and the fifth surface 2605 of the deflecting optical element 2510. Accordingly, these surfaces may not be positioned in a common plane but instead may have a specific angular separation between them. The angle between the second and fifth surfaces may be designed to meet the requirements of the specific application and desired light manipulation within the rotatable LIDAR system. By introducing an angle between these surfaces, it is possible to achieve specific light deflection and redirection characteristics, allowing for customized control over the light beams' paths.

In some embodiments, a portion of the second surface 2602 of the deflecting optical element 2510 may be defined by a face, while the fifth surface 2605 may be defined by an opposing face. In this configuration, the face of the second surface 2602 is bonded or connected to the opposing face of the fifth surface 2605. This bonding creates a secure, transparent connection between these surfaces, which may maintain their alignment and structural integrity within the optical element. The bonding process may help maintain the desired optical properties and functionality of the deflecting optical element, and enable efficient transmission, deflection, and manipulation of the first 2610 and second 2620 light beams.

Furthermore, in some additional embodiments, the face of the second surface 2602 and the opposing surface of the fifth surface 2605 may be bonded using an index-matched adhesive. Within the context of this disclosure, an index-matched adhesive 2630 refers to an adhesive substance that has a refractive index closely approximating that of another material, such as, for example, close to the refractive index of the second surface 2602 and the fifth surface 2605. For instance, if the second surface 2602 and the fifth surface 2605 are made of glass (with a refractive index ranging from 1.4 to 1.6), an index-matched adhesive 2630, such as a resin, with a refractive index similar to that of glass, may bond the two surfaces. By using an index-matched adhesive 2630, the optical path of the light beams, such as 2610 and 2620, may remain undisturbed since the refractive index of the adhesive closely matches that of the second surface 2602 and the fifth surface 2605. Using an index-matched adhesive 2630 may introduce a thin layer of material between the two surfaces, as represented in FIG. 26D by a black line. However, in the context of the overall dimensions and functionality of the deflecting optical element 2510, this thin layer is considered to have a negligible impact on the optical paths, whether for transmission or reflection.

In some embodiments, the first optical element portion 2520 and the second optical element portion 2530 may be integrally formed. In other words, the first optical element portion 2520 and the second optical element portion 2530 may be manufactured or constructed as a single component rather than separate entities creating thereby a cohesive structure, which may enhance the structural integrity and stability of the deflecting optical element. This integration may eliminate the need for separate assembly or bonding processes, simplifying the manufacturing and assembly of the optical element, and increasing its rigidity thereby decreasing distortions of the deflecting surfaces (in particular, when the component rotates with the rotatable rotor, and experiences high centrifugal forces due to its speed of rotation, and peripheral position on the rotor). For example, in embodiments where the first optical element portion 2520 and the second optical element portion 2530 are made of glass, the common deflecting element 2510 can be manufactured by carving a single piece of glass into the desired shape that fulfils the previously described functionality. Alternatively, in some other embodiments, the second surface and the fifth surface may be unified such that the second surface and the fifth surface are indistinguishable. In these scenarios, the manufacturing process may involve starting with separate entities for the first optical element portion 2520 and the second optical element portion 2530. Subsequently, a unification process may be employed to merge the second surface 2602 and the fifth surface 2605, rendering them indistinguishable within the common deflecting element 2510. This unification process may, for example, include fusing the two separate components together, such that the second and fifth surfaces become seamlessly integrated into a single entity. In either scenario, whether the deflecting optical element 2510 is manufactured as a single entity or created by fusing separate components, the outcome is a common deflecting element 2510 that merges seamlessly with the first 2520 and second 2530 optical element portions. This integration results in a unified structure where the second surface 2602 and the fifth surface 2605 become indistinguishable. FIG. 26E visually represents this configuration, where a dashed line symbolically indicates the boundary between the first optical element portion 2520 and the second optical element portion 2530. This representation highlights the unified nature of the common deflecting element and emphasizes the cohesive integration of the second 2602 and fifth 2605 surfaces within the overall structure.

In some embodiments, the sixth surface 2606 and the third surface 2603 may be mirror coated. Within the context of this disclosure, a mirror-coated surface refers to a surface that is covered on one side by a mirror or any other material with high reflectivity, meaning that when a surface is mirror coated, almost all incident light rays are reflected, regardless of the incident angle. To generate a mirror-coated surface, several processes may be employed, such as Physical Vapor Deposition (PVD), Chemical Vapor Deposition (CVD), electroplating or silvering. This mirror coating is represented by thick black dashed lines in FIG. 26F, indicating that the light reflective surfaces 2603 and 2606 of the common deflecting element 2510 are coated with a mirror or another highly reflective material. The mirror coating on the sixth surface 2606 and the third surface 2603 may enhance the reflective properties of these surfaces. It may cause a significant portion of the incident light to be reflected back, contributing to the desired optical functionality of the common deflecting element 2510 described above.

In some embodiments, at least one of the first surface, the second surface, the fourth surface, the fifth surface, or a combination thereof may be an anti-reflective (AR) coated surface. As used herein, an anti-reflective coating refers to a thin film comprising one or more layers applied to a surface to minimize reflection and increase the transmission of light. It may be designed to reduce unwanted reflections that may occur at interfaces between different media, such as air and the surface material. By minimizing reflections, an AR coating may improve optical performance by increasing light transmission and reducing reflections. In certain scenarios, the AR coating may be applied to one or more of the disclosed surfaces. For example, in the exemplary deflecting optical element illustrated in FIG. 26G, the first surface 2601, the second surface 2602, the fourth surface 2604 and the fifth surface 2605 are all AR-coated surfaces, as represented by thick black lines.

In some embodiments, the first optical element portion 2520 may be a first prism, while the second optical element portion 2520 may be a second prism. A prism may refer to an optical element characterized by its geometric shape and the ability to refract (e.g., bend) light. It may consist of two flat polygonal faces that are connected by inclined surfaces. The most common type of prism is the triangular prism, which includes two triangular faces connected by three rectangular or trapezoidal faces. When light enters a prism, it undergoes refraction at each surface, causing the light to change direction. The amount and direction of this bending may depend on the refractive index of the prism material and the angle at which the light strikes the surface. In addition, in some embodiments, the first prism may be adjacent to the second prism. In other words, the first and the second prism may be positioned side by side, or in close proximity to each other, and potentially sharing a common boundary or surface. There are different ways in which the first and second prisms can be positioned adjacent to each other. In some embodiments, the first prism and the second prism may be integrally formed. For example, the first prism and the second prism may be carved or manufactured from a single piece of glass. In some other embodiments, the first prism and the second prism may be affixed together. For instance, the first and second prisms may be bonded together by using an index-matched adhesive or by fusing two surfaces associated with the first and second prisms, effectively joining them together.

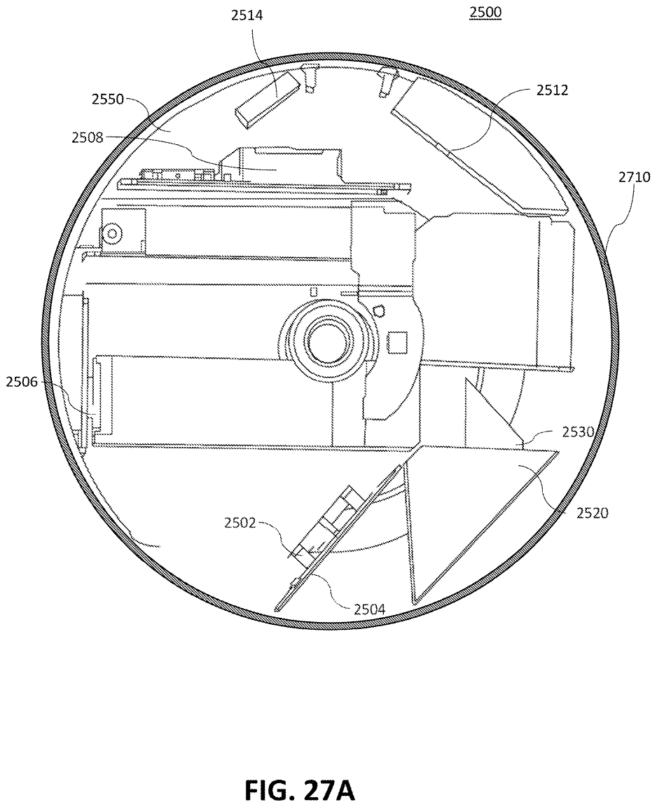

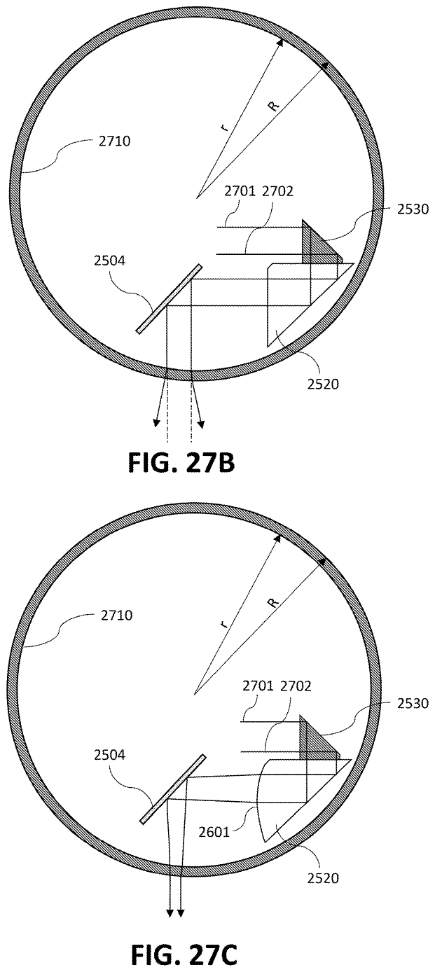

In some embodiments, the rotatable LIDAR system 2500 may further comprise a curved window. In some embodiments, the curved window may have a curvature of no greater than 3.33 m-1 (radius ~56 mm) disposed about an edge of the rotatable rotor and a laser. The curved window may be configured to enable outbound light from the laser to pass therethrough and to enable inbound reflected laser light from a field of view to pass therethrough as well. The curvature of the window may be such that both the outbound laser light and the inbound reflected light experience a degree of distortion corresponding to the curvature. FIG. 27A provides an illustration of an alternative implementation of the rotatable LIDAR system 2500 depicted in FIG. 25, featuring the incorporation of a curved window denoted as 2710.

Consistent with the disclosed embodiments, the curved window 2710 may be made of glass and adopt a refractive index with a value greater than 1. The curvature of window 2710, coupled with its higher refractive index compared to vacuum or air, may introduce small distortions to light beams travelling along transmission or reflection paths. This effect with respect to two light rays 2701 and 2702 travelling along a light transmission path is illustrated in FIG. 27B, which depicts a simplified representation of the rotatable LIDAR system from FIG. 27A. The components shown include the curved window 2710, the first optical element portion 2520, the second optical element portion of the common deflecting element 2510, and the scanning mirror. It should be noted that light rays 2701 and 2702 are emitted from the laser source 2506 (not depicted in this illustration). Once the light rays 2701 and 2702 are deflected by the first 2520 and second 2530 optical element portions, following the principles described earlier and shown in FIG. 26A, they continue their path and reach the scanning mirror 2504. The scanning mirror 2504 further redirects the light rays until they reach the curved window 2710.

As the light rays traverse the curved window 2710, their direction is modified due to the curvature and refractive index of the window 2710. The interaction with window 2710 causes a slight change in the trajectory of the light rays. As a result, the light rays exit the LIDAR system 2500 slightly diverging from their initially sought direction. This divergence is illustrated in FIG. 27B by the depiction of the intended direction of the light rays 2701, and 2702 as black dotted lines. Accordingly, after exiting the LIDAR system 2500 through the curved window 2710, light rays 2701 and 2702 have a slight spread or angular deviation compared to their original intended path.

The divergence of the light rays may be estimated by considering the curvature, refractive index, and thickness of the curved window 2710. The thickness of the window may be defined as the difference between the outer radius (R) and the inner radius (r) of the window, as depicted in FIG. 27B. This estimation may help in understanding and compensating for the deviations introduced by the window. To counteract the distortion effect introduced by the curved window 2710, adjustments may be made to various optical elements along the light transmission or reflection path. These alterations may aim to compensate for the distortions caused by the curvature and refractive properties of window 2710.

Accordingly, in some embodiments, the first surface 2601 or the second surface 2602 of the first optical element portion 2520 may be curved to thereby cancel or reduce the distortion caused by the curved window. By curving one or both of these surfaces, the inherent distortions introduced by the curved window 2710 may be effectively cancelled out or minimized. The specific curvature of the first 2601 or second surface 2602 may be designed and implemented to compensate for the distortions induced by the curved window 2710. By aligning the curvature of these surfaces with the distortions caused by the window, the overall effect on the light rays can be mitigated, resulting in the lights rays exiting or entering the LIDAR system in an intended direction.

FIG. 27C provides another simplified illustration of the LIDAR system 2500 depicted in FIG. 27A. In this simplified version, a specific modification has been made: the first surface 2601 of the first optical element portion 2520 has been designed as curved to cancel out or reduce the distortion effect introduced by the curved window. By curving the first surface 2601 in a calculated manner, the inherent distortions caused by the curved window may be effectively counteracted. For example, as the light rays 2701 and 2702 pass through the curved convex first surface 2601 of the first optical element portion 2520, they experience a slight convergence. This convergence may compensate to a significant extent for the divergence introduced by the curved window 2710. As a result, when the light rays exit the LIDAR system 2500, they may regain their originally sought direction. The intentional curvature of the first surface 2601 may counteract the distortions introduced by the curved window. By curving the surface in a specific manner, the light rays may be manipulated to converge, partially correcting for the divergence that occurred earlier.

In some alternative embodiments, the third surface 2603 of the first optical element portion 2520 may be curved to thereby cancel or reduce the distortion caused by the curved window. Similar to the previously described embodiments, it is contemplated that the third surface 2603 of the first optical element portion 2520 may be curved. This curvature may counteract the distortions introduced by the curved window. By designing the curvature of the third surface 2603 to align with the distortions caused by the window, the overall effect on the light rays can be effectively cancelled or minimized. It is to be appreciated that in this configuration, the third surface may still be mirror coated and thus correspond to a concave mirror. Similarly, in yet further embodiments, where the first optical element portion 2520 corresponds to a first prism, and the second optical element portion 2530 corresponds to a second prism, it is contemplated that at least one of the first prism or the second prism may include a curved surface for cancelling the distortion caused by the curved window.

In an embodiment, a rotatable LIDAR system comprises a rotatable rotor having optics thereon for supporting a reflection light path and a transmission light path, wherein the optics include: a light deflector; a scanning mirror; and a deflecting optical element, wherein the deflecting optical element includes: a first optical element portion having a first surface, a second surface, and a third surface angularly extending between the first surface and the second surface, wherein the first surface and the second surface are light transmissive, and wherein the third surface is light reflective; and a second optical element portion having a fourth surface, a fifth surface, and a sixth surface angularly extending between the fourth surface and the fifth surface, wherein the fourth surface and the fifth surface are light transmissive, and wherein the sixth surface is light reflective; wherein the first optical element portion and the second optical element portion are configured to cooperate such that: a first light beam travelling along the transmission light path passes through the fourth surface, becomes deflected by the sixth surface through the fifth surface and the second surface to the third surface, and becomes deflected by the third surface through the first surface, and a second light beam travelling along the reflection light path passes through the first surface and becomes deflected by the third surface through the second surface.

In some embodiments of the rotatable LIDAR system, downstream from the second surface, a portion of the second light beam passing through to the fifth surface becomes deflected by the sixth surface through the fourth surface.

In some embodiments of the rotatable LIDAR system, the second surface and the fifth surface are spaced apart from each other.

In some embodiments of the rotatable LIDAR system, the fifth surface has a smaller area than the second surface.

In some embodiments of the rotatable LIDAR system, the second surface and the fifth surface are in contact with each other.

In some embodiments of the rotatable LIDAR system, the first optical element portion and the second optical element portion are integrally formed.

In some embodiments of the rotatable LIDAR system, the second surface and the fifth surface lie in a common plane.

In some embodiments of the rotatable LIDAR system, a portion of the second surface is defined by a face and the fifth surface is defined by an opposing face, and wherein the face of the second surface is bonded to the opposing face of the fifth surface.

In some embodiments of the rotatable LIDAR system, the face of the second surface and the opposing surface of the fifth surface are bonded using an index-matched adhesive.

In some embodiments of the rotatable LIDAR system, the second surface and the fifth surface are unified such that the second surface and the fifth surface are indistinguishable.

In some embodiments, the rotatable LIDAR system further comprises a laser and a detector, wherein the rotatable LIDAR system is configured such that, during use, the first light beam emanates from the laser, a first portion of the second light beam is reflected back to the laser by passing through the fifth surface and being deflected by the sixth surface through the fourth surface, and a second portion of the second light beam impinges on the detector after passing through the second surface.

In some embodiments, the rotatable LIDAR system further comprises a folding mirror and a deflector mirror, wherein the rotatable LIDAR system is configured such that, during use, the second portion of the second light beam impinges on the detector after passing through the second surface and being deflected by the folding mirror and the deflector mirror.

In some embodiments of the rotatable LIDAR system, the deflecting optical element is mounted at peripheral regions of the rotatable rotor.

In some embodiments of the rotatable LIDAR system, the first optical element portion and the second optical element portion have a same refractive index.

In some embodiments of the rotatable LIDAR system, the first optical element portion and the second optical element portion are made from different types of glass.

In some embodiments of the rotatable LIDAR system, the first optical element portion and the second optical element portion are made from a same type of glass.

In some embodiments of the rotatable LIDAR system, at least one of the first optical element portion and the second optical element portion has a refractive index greater than 1.

In some embodiments of the rotatable LIDAR system, a first light transparent volume is formed between the first surface, the second surface and the third surface, and a second light transparent volume is formed between the fourth surface, the fifth surface and the sixth surface.

In some embodiments of the rotatable LIDAR system, the first light transparent volume is greater than the second light transparent volume.

In some embodiments of the rotatable LIDAR system, at least one of the first light transparent volume or the second light transparent volume has a refraction index greater than or equal to 1.5 and lower than or equal to 1.6.

In some embodiments of the rotatable LIDAR system, the sixth surface and the third surface are mirror coated.

In some embodiments of the rotatable LIDAR system, at least one of the first surface, the second surface, the fourth surface, the fifth surface, or a combination thereof is an anti-reflective (AR) coated surface.

In some embodiments of the rotatable LIDAR system, the rotatable rotor is a disk.

In some embodiments of the rotatable LIDAR system, the rotatable rotor is cylindrical.

In some embodiments of the rotatable LIDAR system, at least one of the first surface, the second surface, the third surface, the fourth surface, the fifth surface, or the sixth surface is defined by a plurality of contiguous faces.

In some embodiments, the rotatable LIDAR system further comprises a curved window with a curvature of no greater than 3.33 m-1 disposed about an edge of the rotatable rotor and a laser, the curved window being configured to enable outbound light from the laser to pass therethrough and to enable inbound reflected laser light from a field of view to pass therethrough, wherein the curvature of the window is such that outbound laser light and inbound reflected light are distorted by an amount correlated to the curvature.

In some embodiments of the rotatable LIDAR system, the first surface or the second surface is curved to thereby cancel or reduce the distortion caused by the curved window.

In some embodiments of the rotatable LIDAR system, the third surface is curved to thereby cancel the distortion caused by the curved window.

In some embodiments of the rotatable LIDAR system, the first optical element portion is a first prism and the second optical element portion is a second prism.

In some embodiments of the rotatable LIDAR system, at least one of the first prism or the second prism includes a curved surface for cancelling the distortion caused by the curved window.

In some embodiments of the rotatable LIDAR system, the first prism is adjacent to the second prism.

In some embodiments of the rotatable LIDAR system, the first prism and the second prism are integrally formed.

In some embodiments of the rotatable LIDAR system, the first prism and the second prism are affixed together.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer-readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A rotatable LIDAR system, comprising:
a rotor having a central rotational axis and a plurality of optical component mounting locations about a peripheral region of the rotor, wherein components mounted at the plurality of optical component mounting locations are configured to rotate around the central rotational axis;
a scanning light deflector mounted at one of the plurality of optical component mounting locations, the scanning light deflector being configured to scan a field of view along a direction parallel to the central rotational axis as the rotor rotates;
a light detector mounted at one of the plurality of optical component mounting locations and configured to receive, while the rotor rotates, reflections of light from objects in the field of view; and
a plurality of optical elements mounted at others of the plurality of optical component mounting locations, the scanning light deflector and the plurality of optical elements defining at least one optical pathway having at least one directional change between the scanning light deflector and the light detector.

2. The rotatable LIDAR system of claim 1, wherein the at least one optical pathway includes at least two directional changes.

3. The rotatable LIDAR system of claim 1, wherein the at least one optical pathway encompasses more than 180 degrees of the rotor.

4. The rotatable LIDAR System of claim 1, wherein a length of the at least one optical pathway is greater than a diameter of the rotor.

5. The rotatable LIDAR system of claim 1, wherein the light deflector is configured to both transmit an outbound light beam and transmit inbound reflections of the outbound light beam.

6. The rotatable LIDAR system of claim 1, wherein the plurality of optical elements are configured such that the at least one optical pathway includes at least three directional changes.

7. (canceled)

8. The rotatable LIDAR system of claim 1, further comprising a first motor configured to rotate the rotor at a speed of at least 3,000 rpm and a second motor configured to pivot the light deflector.

9-19. (canceled)

20. The rotatable LIDAR system of claim 1, further comprising at least one laser emitter.

21. The rotatable LIDAR system of claim 20, wherein the at least one laser emitter comprises at least one multichannel laser emitter.

22-23. (canceled)

24. The rotatable LIDAR system of claim 1, wherein the light detector is configured to receive a plurality of light beams during a single rotation of the rotor.

25-27. (canceled)

28. The rotatable LIDAR system of claim 1, wherein the at least one optical pathway comprises a light reception pathway and a light transmission pathway.

29. (canceled)

30. The rotatable LIDAR system of claim 28, wherein the light reception pathway and the light transmission pathway at least partially overlap.

31. The rotatable LIDAR system of claim 30, wherein the light reception pathway and the light transmission pathway are defined in opposite directions in a region at which the light reception pathway and the light transmission pathway at least partially overlap.

32. The rotatable LIDAR system of claim 28, wherein the light reception pathway is longer than the light transmission pathway.

33. (canceled)

34. The rotatable LIDAR system of claim 28, wherein at least one of the plurality of optical elements is configured to deflect light traveling along the light reception pathway and light traveling along the light transmission pathway.

35. The rotatable LIDAR system of claim 28, wherein the rotatable LIDAR system is configured to receive light at an initial entry angle that is greater than 90 degrees different at a terminal angle at which the light is received by the light detector.

36. (canceled)

37. The rotatable LIDAR system of claim 28, wherein the scanning light deflector and the plurality of optical elements are configured to alter an angle of light transmitted by the rotatable LIDAR system at least three times.

38. The rotatable LIDAR system of claim 28, wherein the scanning light deflector and the plurality of optical elements are configured to alter an angle of light received by the rotatable LIDAR system by a total of more than 180 degrees.

39. (canceled)

40. The rotatable LIDAR system of claim 1, wherein the scanning light deflector includes a prism.

41. The rotatable LIDAR system of claim 1, wherein the scanning light deflector includes a mirror.

42. (canceled)
